(19) United States
(12) Patent Application Publication
(10) Pub. No.: US 2014/0190778 A1
(43) Pub. Date: Jul. 10, 2014

(54) INERTING DAMPER WITH REGRESSIVE CHARACTERISTICS

(71) Applicant: Penske Racing Shocks, Reading, PA (US)

(72) Inventor: Bill J. Gartner, Wyomissing, PA (US)

(21) Appl. No.: 14/151,276

(22) Filed: Jan. 9, 2014

Related U.S. Application Data
(60) Provisional application No. 61/750,503, filed on Jan. 9, 2013.

(51) Int. Cl. F16F 9/504; F16F 9/512; F16F 9/18

(52) U.S. Cl. CPC F16F 9/504; F16F 9/182; F16F 9/512
USPC 188/266.2

(57) ABSTRACT

Apparatus and methods for damping a vehicle suspension. Various embodiments of dampers in hydraulic flowpaths are adapted and configured to provide shock absorber reactive forces resulting more from the pressure drop needed to overcome the inertia of the hydraulic fluid. Further, various embodiments include valving that provides a regressive characteristic to the shock absorber reactive load characteristics.

### CROSS REFERENCE TO RELATED APPLICATION

This application claims the benefit of priority to U.S. Provisional Patent Application Ser. No. 61/750,503, filed Jan. 9, 2013; incorporated herein by reference.

### FIELD OF THE INVENTION

The present invention pertains to shock and vibration dampers and, in particular to a hydraulic shock absorber that reacts with both inertance and regressive characteristics.

### BACKGROUND OF THE INVENTION

Vehicles that traverse a roadway must deal with irregularities in the roadway such as bumps and depressions. Many wheeled vehicles incorporate damped suspensions. The damping force levels are usually a compromise between low speed damping support of the vehicle body movements and high speed damping of bumps and depressions. Too much low speed damping for improved body control can result in a harsh ride at higher speeds with hydraulic dampers, because the hydraulic damping force is a function of the velocity of the piston and this force typically increases as the velocity increases.

Yet another type of vehicle that must deal with irregularity in the roadway is a mountain bike, terrain bike or cyclocross bike, among other types of bicycles. The roadway these bikes are designed for includes pathways over land that is largely or completely unprepared. Such roadways include numerous irregularities such as fallen trees, rocks, roots, cobblestones, potholes, and other types of irregularities. Such vehicles can benefit from damping that significantly softens when the vehicle passes over a large, sudden change in the height of the roadway. However, in a conventional damper, a damping flowpath characteristic that is suitable for large sudden displacements may be too soft when the vehicle traverses mildly or moderately irregular terrain.

What is needed is a damper that provides adequate low speed damping for improved body control, without increasing the harshness of the vehicle ride at higher speeds. The present invention does this in novel and unobvious ways.

### BRIEF DESCRIPTION OF THE DRAWINGS

FIG. 1a is a cutaway view of a prior art shock absorber.

FIG. 1b is a cutaway view of another prior art shock absorber.

FIG. 1c is a cutaway view of a portion of another prior art shock absorber.

FIG. 2 is a cross-sectional perspective view of a portion of a shock absorber according to one embodiment of the present invention.

FIG. 3 is a view of the shock absorber of FIG. 2 operating in a regressive mode.

FIG. 4 is a cross-sectional perspective view of a portion of a shock absorber according to another embodiment of the present invention.

FIG. 5 is a graphical depiction of the characteristics of a shock absorber having regressive characteristics in compression according to another embodiment of the present invention.

FIG. 6 is a perspective cross sectional view of the apparatus of FIG. 8 installed within a damper.

FIG. 7 is a perspective cross sectional view of the apparatus of FIG. 8 installed within a damper during a different mode of operation.

FIG. 8 is a cross sectional view of a portion of a shock absorber according to one embodiment of the present invention.

FIG. 9 is a graphical depiction of the characteristics of a shock absorber according to another embodiment of the present invention.

FIG. 10a is a cross-sectional view of a portion of a shock absorber head valve according to another embodiment of the present invention.

FIG. 10b is a close up of a portion of the apparatus of FIG. 10a.

FIG. 11 is a graphical depiction of the characteristics of a shock absorber having regressive characteristics in rebound according to another embodiment of the present invention.

FIG. 12 is a graphical depiction of the characteristics of a shock absorber having adjustable regressive characteristics in rebound according to another embodiment of the present invention.

FIG. 13 is a graphical depiction of the characteristics of a shock absorber having adjustable regressive characteristics in rebound according to another embodiment of the present invention.

FIG. 14 is a schematic representation of a shock absorber utilizing the apparatus of FIG. 8 according to another embodiment of the present invention.

FIG. 15 is a graphical depiction of the characteristics of a shock absorber having adjustable regressive characteristics in rebound according to another embodiment of the present invention.

FIG. 16 is a cutaway, perspective view of an apparatus according to another embodiment of the present invention.

FIG. 17 is a cross sectional orthogonal view of the apparatus of FIG. 16.

FIG. 18a shows a side elevational view of a rod and piston (bottom) according to another embodiment of the present invention, and a cross-sectional close-up view of a portion of that apparatus (on top).

FIG. 18b shows cross-sectional representations of the apparatus of FIG. 18a, with the piston in both a closed position (left) and a low-speed position (right). The bottom two views are cross-sectional representations of the top two views, as indicated.

FIG. 18c is a cross-sectional view of the apparatus of FIG. 18a in the blow-off configuration.

FIG. 18d is a cross-sectional representation of another embodiment of the present invention.

FIG. 19a shows a side elevational view of a rod and piston (bottom) according to another embodiment of the present invention, and a cross-sectional close-up view of a portion of that apparatus (on top). FIG. 19b shows cross-sectional representations of the apparatus of FIG. 19a, with the piston in both a closed position (left) and a low-speed position (right). The bottom two views are cross-sectional representations of the top two views, as indicated.

FIG. 19c is a cross-sectional view of the apparatus of FIG. 19a in the blow-off configuration.

FIG. 20a is a side elevational view of a piston and rod according to another embodiment of the present invention.

FIG. 20b is a cross-sectional view of a portion of the apparatus of FIG. 20a

FIG. 21 shows cross-sectional views according to another embodiment of the present invention (top), in both the closed and open positions. The bottom of FIG. 21 show cross-sectional views of the figures above them as indicated.

FIG. 22a is a side cross-sectional view of a piston and rod according to another embodiment of the present invention.

FIG. 22b shows cross-sectional views according to another embodiment of the present invention (top), in both the closed and open positions. The bottom of FIG. 22 show cross-sectional views of the figures above them as indicated.

FIG. 23 shows a side elevational view of another embodiment of the present invention.

FIG. 24A shows a side elevational, cross sectional representation of a damper according to another embodiment of the present invention.

FIG. 24B shows a side elevational, cross sectional representation of a damper according to another embodiment of the present invention.

FIG. 24C shows a side elevational, cross sectional representation of a damper according to another embodiment of the present invention.

FIG. 25A shows a side elevational, cross sectional representation of a damper according to another embodiment of the present invention.

FIG. 25B shows a side elevational, cross sectional representation of a damper according to another embodiment of the present invention.

FIG. 25C shows a side elevational, cross sectional representation of a damper according to another embodiment of the present invention.

FIG. 26A shows a side elevational, cross sectional representation of a damper according to another embodiment of the present invention.

FIG. 26B shows a side elevational, cross sectional representation of a damper according to another embodiment of the present invention.

FIG. 26C shows a side elevational, cross sectional representation of a damper according to another embodiment of the present invention.

FIG. 27 is a cross sectional schematic representation of a damper according to another embodiment of the present invention.

FIG. 28 is a schematic representation of a damper.

### ELEMENT NOMENCLATURE

The following is a list of element numbers and at least one word used to describe that element. It is understood that none of the embodiments disclosed herein are limited to these words, and these element numbers can further include other words that would be understood by a person of ordinary skill reading and reviewing this disclosure in its entirety

| | |
|---|---|
| 20 | shock absorber |
| .1 | hydraulic fluid |
| 22 | piston |
| 24 | rod |
| .1 | internal passage |
| .2 | coupling nut |
| .3 | metering needle |
| .4 | refill orifices |
| .5 | slot |
| .6 | thru rod |
| 25 | cylinder (inner) |
| 26 | cylinder (outer) |
| .1 | inner diameter |
| .2 | end cap |
| .25 | end cap face/sealing surface |
| .3 | suspension attachments |
| .4 | compression volume |
| .5 | rebound volume |
| 27 | cylinder, helical flowpath |
| 28 | compression end |
| .1 | compression flowpath |
| 29 | helical path |
| 30 | rebound end |
| .1 | rebound flowpath |
| 35 | regressive flowpath |
| 36 | shims or one-way valve |
| 38 | reservoir piston |
| 39 | connection to nitrogen chamber |
| 40 | nitrogen chamber |
| 42 | check valve |
| 50 | housing |
| 51 | External or head valve |
| .1 | First port |
| .2 | Second port |
| .3 | Internal chamber |
| 52 | first part |
| .1 | threads |
| .2 | spring pocket |
| .3 | threaded coupling to rod |
| .4 | Passageway to spring pocket |
| 54 | second part |
| .1 | threads |
| .2 | circumferential wall |
| .3 | aperture |
| .4 | face sealing surface |
| .5 | Threaded surface |
| .6 | Apertures, second flowpath |
| 56 | External fluid connection |
| 57 | External fluid connection |
| 60 | piston |
| .1 | outer diameter |
| .2 | central main orifice |
| .3 | peripheral secondary orifices |
| .4 | sealing surface |
| .5 | surface area |
| .6 | portion of surface area |
| .7 | peripheral seal |
| .8 | spring pocket |
| .9 | projection |
| .10 | underside |
| .11 | Threaded coupling to rod |
| .12 | stop |
| 70 | spring |
| .1 | bushing |
| 80 | First, low speed flowpath |
| 81 | Bypassing flowpath |
| 82 | Second, high speed flowpath |
| 83 | piston bypass flow rate |
| 90 | Head valve assembly |
| 91 | Orifice adjustment |
| 92 | Spring preload adjustment |
| 93 | Low velocity adjustment |
| 94 | Valve member (rotational) |
| 95 | Valve member (static) |
| 96 | Static member |
| .1 | Conical projection |
| 110 | compression damping curves |
| 111 | first progressive portion |
| 112 | regressive portion |
| 113 | second progressive portion |
| 114 | rebound damping curve |
| 115 | Standard compression curve |
| 116 | Standard rebound curve |

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

The use of an N-series prefix for an element number (NXX) refers to an element that is the same as the non-prefixed element (XX), except as shown and described thereafter. Although various specific quantities (spatial dimensions, temperatures, pressures, times, force, resistance, current, voltage, concentrations, etc.) may be stated herein, such specific quantities are presented as examples only, and are not to be construed as limiting.

One embodiment of the present invention pertains to a damper having regressive characteristics in both rebound and compression. As one example, during compression of the damper at low velocity, the force required to compress the damper progressively increases as the compressive velocity of the damper increases. During operation at moderate compressive velocities, the force required to compress the damper regressively decreases as the velocity increases. At still higher compressive velocities, the damping force progressively increases with increased compressive velocity.

One embodiment of the present invention pertains to a damper having regressive characteristics. During extension of the damper at low velocity, the force required to extend the damper progressively increases as the extensive velocity of the damper increases. During operation at moderate extensive velocities, the force required to extend the damper regressively decreases as the velocity increases. At still higher extensive velocities, the damping force progressively increases with increased extensive velocity.

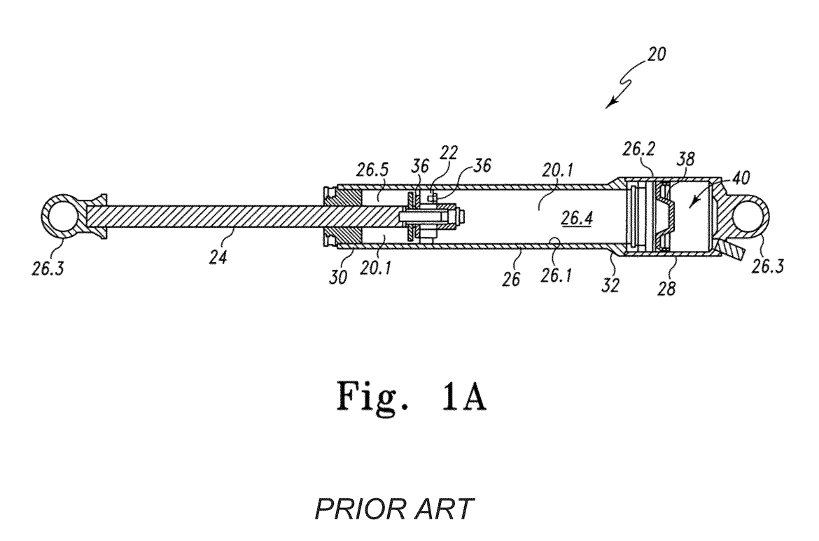

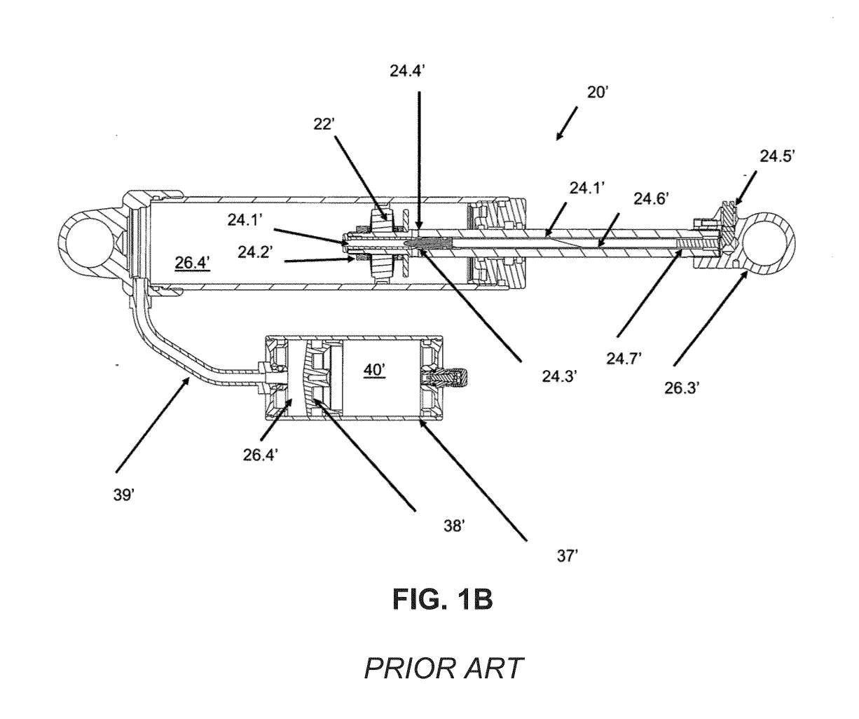

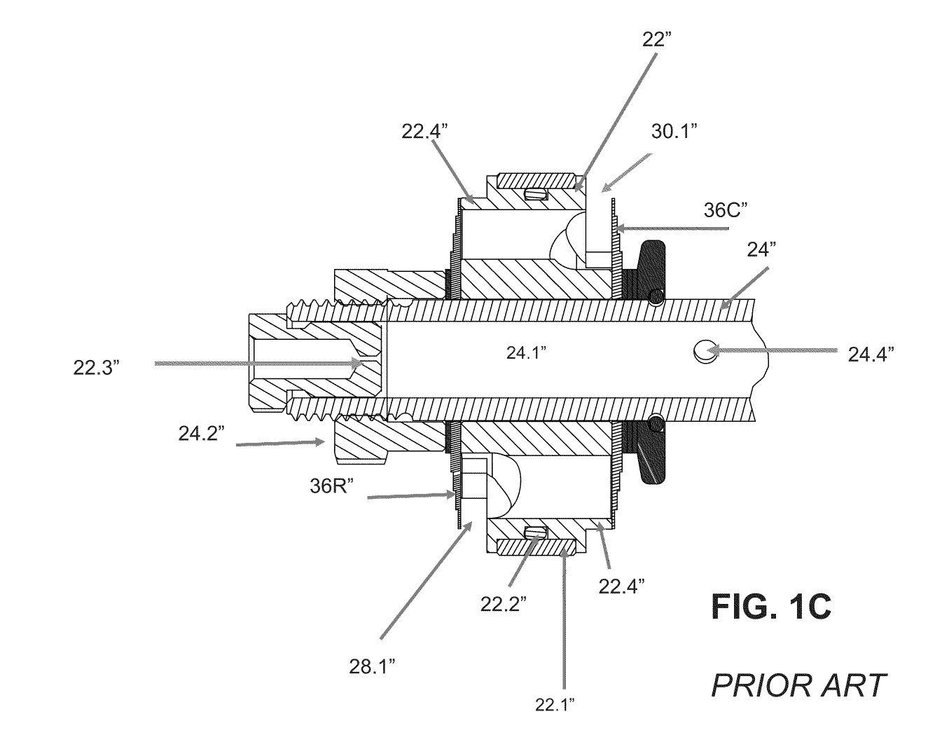

FIG. 1a shows a cross-sectional view of a prior art shock absorber 20. A main piston 22 is coupled to a moveable rod 24, piston 22 being slidably received within the inner diameter 26.1 of a main cylinder 26. Piston 22 is retained on the end of rod 24 by a coupling nut 24.2. Main piston 22 generally subdivides the internal volume of cylinder 26 into a compression volume or compartment 26.4 located between piston 22 and the compression end 28 of shock 20, and a second rebound volume or compartment 26.5 located between piston 22 and the rebound end 30 of shock 20. The movement of piston 22 and rod 24 toward rebound end 32 results in a reduction in the size of compression volume 26.1, and the subsequent flow of hydraulic fluid 20.1 through a compression flowpath 32 in piston 22 and into the simultaneously enlarging rebound volume 26.5. Likewise, movement of piston 22 toward rebound end 30 of shock 20 results in the pumping of a flow of hydraulic fluid 20.1 through a rebound flowpath 34 in piston 22 and into the simultaneously enlarging compression volume 26.4.

In order to compensate for changes in the density of hydraulic fluid 20.1 and shaft-displaced fluid, shock absorber 20 includes a nitrogen chamber separated by a reservoir piston 38 from the fluid-wetted volume of cylinder 26.

Shock absorber 20 is typically used with the suspension of a vehicle. Rod 24 includes a first suspension attachment 26.3, and end cap 26.2 of cylinder 26 includes a second suspension attachment 26.3. These suspension attachments 26.3 permit the pivotal connection of shock absorber 20 to a portion of the vehicle suspension on one end, and on the other end to a portion of the vehicle frame. It is well known to use shock absorbers on many types of vehicles, including motorcycles, buses, trucks, automobiles, and airplanes. Further, although shock absorber 20 has been referred to for being used on a vehicle, shock absorbers are also known to be used in other applications where it is beneficial to dampen the movement of one object relative to another object, such as dampers for doors.

Compression flowpath 32 includes a fluid passageway interconnecting volumes 26.4 and 26.5 with a one-way valve in the flowpath 32. This one-way valve can be one or more annular shims which are prevented from flexing in one direction (and thus substantially restricting flow), but able to flex in a different direction (and thus allow flow in this opposite direction). Likewise, rebound flowpath 34 provides fluid communication between volumes 26.4 and 26.5 through a one-way valve. Often, the one-way valve of the compression flowpath 32 has different characteristics than the one-way valve of rebound flowpath 34.

FIG. 1 b shows a cross-sectional view of a second prior art shock absorber 20′. Shock absorber 20′ includes a second, separate cylinder 37′ which includes gas reservoir 40′. A piston 38′ slidably received within cylinder 37′ separates gas volume 40′ from compression volume 26.4′. An external fluid connection 39′ interconnects the hydraulic fluid end of piston 37′ with the compression end of shock absorber 20′. Cylinder 37′ includes a gas port in one end of cylinder 37′ for entry or removal of nitrogen.

Shock absorber 20′ includes means for varying the fluid resistance of a flowpath interconnecting compression volume 26.4′ and rebound volume 26.5′. Rod 24′ includes an internal passage 24.1′ that extends out one end of shaft 24′, and extends in the opposite direction towards attachment 26.3′. The open end of internal passage 24.1′ is in fluid communication with one or more orifices 24.4′ that extend from internal passage 24.1′ to rebound volume 26.5′. The flow of fluid through this internal passageway between the compression and rebound volumes is restricted by a metering needle 24.3′ received within internal passage 24.1′. The position of metering needle 24.3′ can be altered by a pushrod 24.6′ also extending within internal passage 24.1′. Push rod 24.6′ includes an end 24.7′ that is adapted and configured to mate with an internal adjustment screw 24.5′. The inward adjustment of screw 24.5′ acts on the angled interface to push rod 24.6′ and adjustment needle 24.3′ toward a position of increased resistance in the internal flowpath.

FIG. 1c is a cross sectional view of a portion of another prior art shock absorber. The apparatus in FIG. 1c shows a piston 22″ coupled to a shaft 24″ by a coupling nut 24.2″. Shaft 24″ includes an internal flowpath from orifice 22.3″ through internal passage 24.1″ and into shaft orifice 24.4″. This internal flowpath bypasses piston 22″.

Piston 22″ includes a pair of shim sets 36″, each shim set shown including 4 individual washers. During operation in compression (i.e., movement in FIG. 1c toward the left) fluid is able to freely enter compression flowpath 28.1″. However, fluid is unable to exit through flowpath 28.1″ and into the rebound side of the shock absorber unless fluid pressure is sufficiently great to bend the periphery shim stack 360″ away from the shim edge support 29.4″ of piston 22″. During operation in rebound, (i.e., movement in FIG. 1c toward the right) fluid is able to freely enter compression flowpath 30.1″. However, fluid is unable to exit through flowpath 30.1″ and into the compression side of the shock absorber unless fluid pressure is sufficiently great to bend the periphery shim stack 36R″ away from the shim edge support 29.4″ of piston 22″.

A resilient seal 22.1″ substantially seals the compressive side of piston 22″ from the rebound side of piston 22″. An energizing backup seal 22.2″ urges seal 22.1″ outwardly into contact with the inner wall of the cylinder.

Although what has been shown described is a shock absorber 20 that is linear in operation, the prior art of shock absorbers further includes rotary dampers, such as the toroidal damper disclosed in U.S. Pat. No. 7,048,098, incorporated herein by reference. In addition, although FIGS. 1a, 1b, and 1c depict particular types of prior art shock absorbers, the various embodiments of the present invention are not so constrained. For example, the regressive valve assemblies and methods described and shown herein are further applicable with shock absorbers as disclosed in U.S. patent application Ser. No. 11/261,777, filed Oct. 31, 2005 for inventors Nygren and Loow.

As used herein, the word compression refers to the action and direction of the shock absorber during compression of the wheel suspension, this term being synonymous with the term jounce. Therefore, the end of the shock absorber referred to as a compression end is the end which has a reduction in internal volume (due to movement of the piston relative to the cylinder) during compression of the vehicle suspension. The rebound end of the shock absorber is the end that is opposite of the compression end.

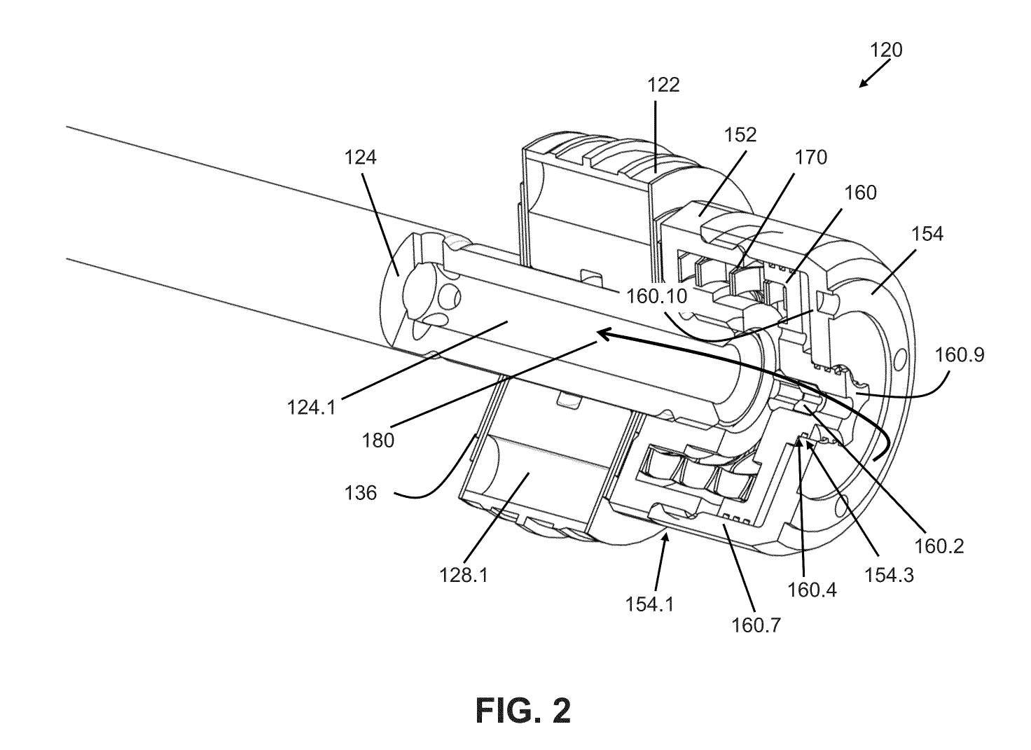

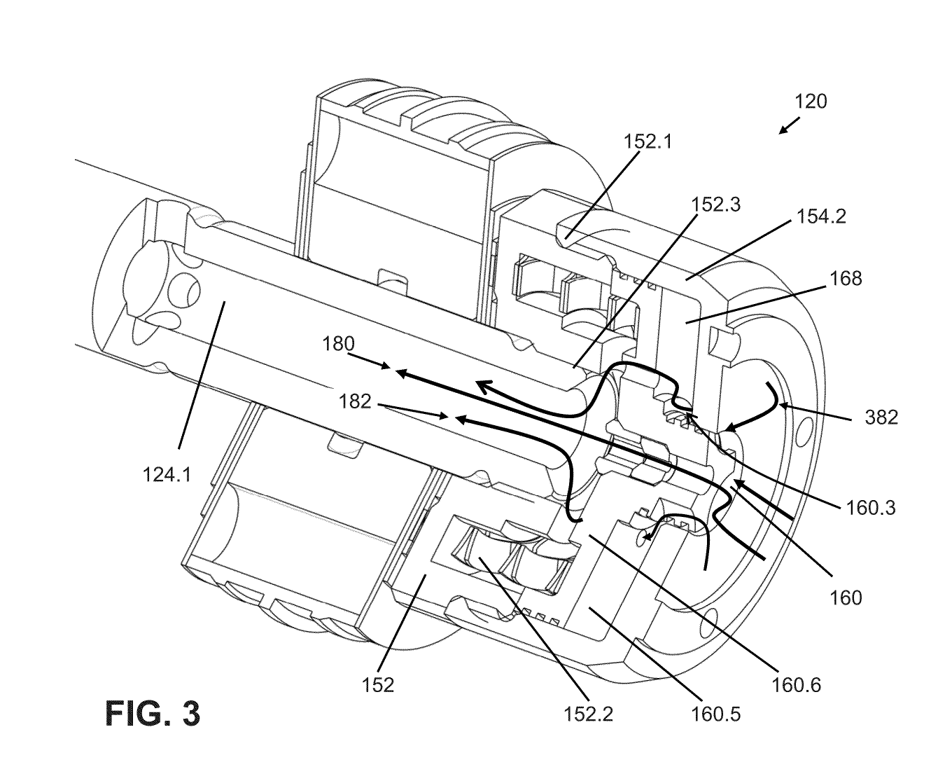

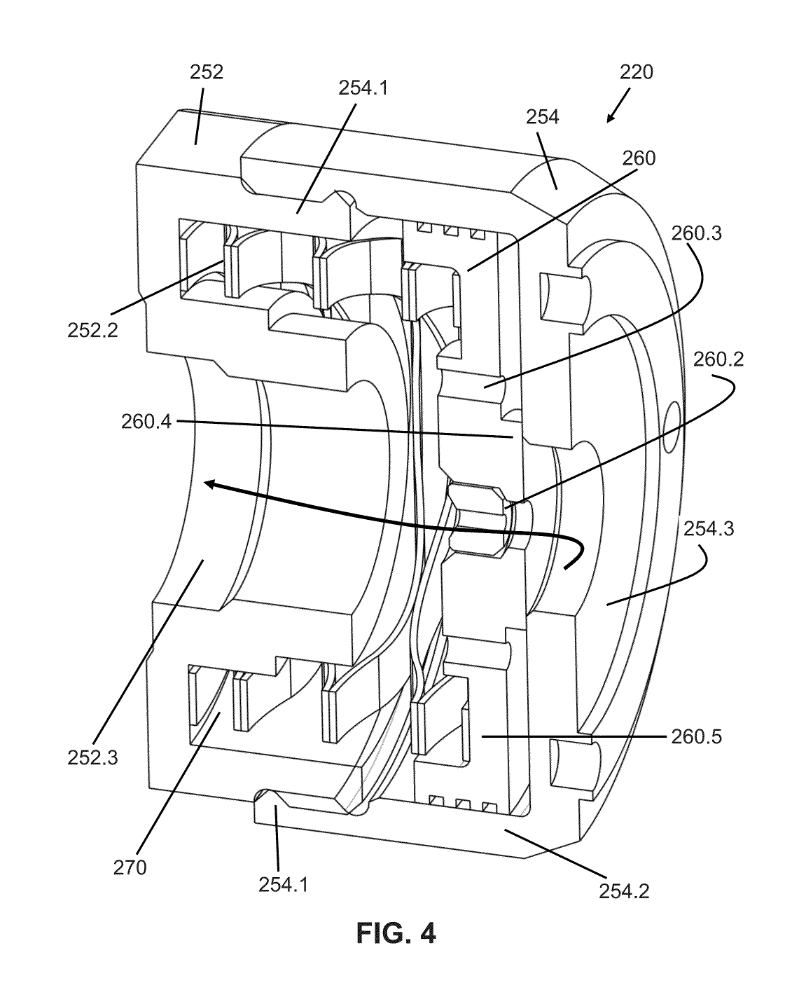

FIGS. 2 and 3 are prospective, cutaway views of a portion of a shock absorber 120 according to one embodiment of the present invention. For the sake of clarity, only certain portions of shock absorber 120 are shown. Shock absorber 120 includes a housing assembly 150 according to one embodiment of the present invention. In one embodiment, valve housing assembly 150 comprises a first part 152 and second part 154 that are threadably coupled by threads 152.1 and 154.1 to form housing 150. Valve housing assembly 150 includes a piston 160 which is slidable within an internal chamber formed by the coupling of first part 152 to second part 154.

A spring 170 biases piston 160 toward one end of the internal chamber. Spring 170 is received within a spring pocket defined at one end by a pocket 152.2 in the first part 152 of housing 150, and defined at the other end by a spring receiving pocket or spring-receiving surface 160.8 of piston 160. When first part 152 and second part 154 of housing 150 are threadably coupled together, spring 170 is adapted and configured to place a predetermined force on the underside surface 160.8, such that piston 160 is preloaded toward one end of its range of travel.

Preferably, housing assembly 150 is threadably coupled to the end of rod 124 in place of, or proximate to, a coupling nut (not shown). In one embodiment, housing 150 is threadably coupled to rod 124 proximate to main piston 122. However, the present invention also contemplates those embodiments in which housing 150 is further integrated with piston 122, including those embodiments in which secondary piston 160 and spring 170 are incorporated within the main piston.

Referring to FIG. 2, piston 160 is slidable within an internal chamber formed by the coupling of housing first part 152 to housing second part 154. In FIG. 2 piston 160 is shown in the first position, as would be experienced during rebound operation of shock absorber 120, and also during lower velocity compression operation. A projection 160.9 of piston 160 projects from a substantially planar face and further extends within an aperture 154.3 of second housing part 154.

In some embodiments of the present invention, piston 160 includes a central orifice 160.2 that provides fluid communication between compression volume 126.4 and rebound volume 126.5 by way of internal passage 124.1 of rod 124 during all operation of the damper. However, the present invention also contemplates those embodiments in which a similar flowpath is established through main piston 122, and also those embodiments in which there is no fixed restriction between the compression volume and rebound volume that is operable during all operation of the damper.

Housing assembly 150 is generally exposed to hydraulic pressure within the compression volume 126.4 of shock 120. Therefore, this hydraulic pressure is communicated to a portion 160.6 of piston 160 that is in fluid communication with aperture 154.3. Hydraulic pressure within compression volume 126.4 coacts with the portion 160.6 of the surface area of piston 160 to apply a force to piston 160 that tends to push piston 160 away from second housing part 154.

The pressure force on piston 160 described above is opposed by a spring force. Spring 170 is adapted and configured to be preloaded when installed within housing 150. Spring 170, located within a pocket 152.2 of first housing part 152, applies a biasing force to push piston 160 toward the first position. There is hydraulic pressure applied to the underside 160.10 of piston 160. This underside pressure is communicated from orifices 124.4 in rod 124 into internal passage 124.1. The hydraulic pressure within internal passage 124.1 is also influenced by hydraulic fluid that flows between compression volume 126.4 and rebound volume 126.5 by way of main orifice 160.2. This pressure is communicated to the volume of the internal chamber generally bounded by spring pocket 152.2 and the underside 160.10 of piston 160.

This pressure within passage 124.1 is further communicated through a plurality of peripheral orifices 160.3 in the body of piston 160. These orifices communicate this underside hydraulic pressure to the front side of piston 160 (i.e., the volume between the opposing planar surfaces of piston 160 and housing part 154). Because of communication through orifices 160.3, the pressure force on piston 160 in the first position results from the coaction of the difference in pressures between compression volume 126.4 and the pressure within internal passage 124.1, acting on the portion of surface area of piston 160 that projects from aperture 154.3.

Piston 160 is slidably received within the inner cylindrical circumferential wall 154.2 of housing part 154. In some embodiments, the outer diameter 160.1 of piston 160 discourages leakage flow within the internal chamber by way of a close fit between the outer diameter 160.1 of piston 160 and the walls 154.2 of housing 154. However, in some embodiments piston 160.6 includes a seal to discourage leakage flow, such as a Teflon® seal backed up by a spring.

Leakage flow of hydraulic fluid from compression volume 126.4 into the third internal volume of internal chamber 156 is discouraged by a close fit between a portion of the outer diameter of projection 160.9 and the side walls of aperture 154.3. In one embodiment, projection 160.9 includes a generally cylindrical portion for sealing purposes, and also a scalloped portion which maintains guidance of the projection within the aperture, the scalloped portions also permitting flow of hydraulic fluid after the sealing portion of projection 160.9 moves out of aperture 154.3. This flow past the scalloped portion occurs when piston 160 moves toward its second position.

FIG. 3 shows piston 160 in its second position during regressive operation of shock absorber 120. Piston 160 moves toward this position when the pressure differential between the pressure in compression volume 126.4 and the pressure within passage 124.1 coact with the surface area of projection 160.9 sufficiently to overcome the biasing force of spring 170. As piston moves away from the first position, the sealing portion of projection 160.9 no longer discourages flow into the chamber of housing 150. Further, the scalloped sections of the projection permit flow from compression volume 126.4 into chamber 156. As hydraulic fluid enters internal chamber 156, it flows into internal passage 124.1 of rod 124 by way of one or more secondary flow orifices 160.3 located within piston 160. Flow orifices 160.3 are laterally displaced from central orifice 160.2.

The operation of a valve assembly 150 having a slidable, sealed piston preloaded by a spring 170 within threadably coupled members 154 and 152 can be adapted to provide regressive forcing characteristics for both compression and extension (or rebound) of a shock absorber. Further, the general operation of a regressive valve assembly as previously described can be adapted in various other configurations of apparatus as will now be shown and described.

FIG. 4 is a perspective, cutaway view of a portion of a shock absorber 220 according to one embodiment of the present invention. For the sake of clarity, only certain portions of shock absorber 220 are shown. Shock absorber 220 includes a valve housing assembly 250 according to one embodiment of the present invention. In one embodiment, valve housing assembly 250 comprises a first part 252 and second part 254 that are threadably coupled by threads 252.1 and 254.1 to form housing 250. Housing assembly 250 includes a piston 260 which is slidable within an internal chamber formed by the coupling of first part 252 to second part 254.

A spring 270 biases piston 260 toward one end of the internal chamber. Spring 270 is received within a spring pocket defined at one end by a pocket 252.2 in the first part 252 of housing 250, and defined at the other end by a spring receiving pocket or surface 260.8 of piston 260. When first part 252 and second part 254 of housing 250 are threadably coupled, spring 270 is adapted and configured to place a predetermined force on the underside surface 260.8, such that piston 260 is preloaded toward one end of its range of travel.

Preferably, housing assembly 250 is threadably coupled to the end of rod 224 in place of, or proximate to, a coupling nut (not shown). In one embodiment, housing 250 is threadably coupled to rod 224 proximate to main piston 222. However, the present invention also contemplates those embodiments in which housing 250 is further integrated with piston 222, including those embodiments in which secondary piston 260 and spring 270 are incorporated within the main piston.

Piston 260 is slidable within an internal chamber formed by the coupling of housing first part 252 to housing second part 254. Piston 260 is shown in the first position, as would be experienced during rebound operation of shock absorber 220 and also during low velocity compression operation. A projection 260.9 of piston 260 projects as a plateau from a substantially planar face of piston 260, and further extends into contact with the face and edge of an aperture 254.3 of second housing part 254.

In some embodiments of the present invention, piston 260 includes a central orifice 260.2 that provides fluid communication between compression volume 226.4 and rebound volume 226.5 by way of internal passage 224.1 of rod 224 during all operation of the damper. However, the present invention also contemplates those embodiments in which a similar flowpath is established through main piston 222, and also those embodiments in which there is no fixed restriction between the compression volume and rebound volume that is operable during all operation of the damper.

Housing assembly 250 is generally exposed to hydraulic pressure within the compression volume 226.4 of shock 220. Therefore, this hydraulic pressure is communicated to a portion 260.6 within plateau 260.9 of piston 260 that is in fluid communication with aperture 254.3. Hydraulic pressure within compression volume 226.4 coacts with the surface of portion 260.6 to apply a force to piston 260 that tends to push piston 260 away from second housing part 254.

The force on piston 260 described above is opposed by a pressure and spring force. Spring 270, located within a pocket 252.2 of first housing part 252, applies a biasing force to push piston 260 toward the first position. There is hydraulic pressure is applied to the underside 260.10 of piston 260. This underside pressure is communicated from orifices 224.4 in rod 224 into internal passage 224.1. The hydraulic pressure within internal passage 224.1 is also influenced by hydraulic fluid that flows between compression volume 226.4 and rebound volume 226.5 by way of a main orifice 260.2. This pressure is communicated to the volume of the internal chamber generally bounded by spring pocket 252.2 and the underside 260.10 of piston 260.

This pressure within passage 124.1 is further communicated through a plurality of peripheral orifices 260.3 in the body of piston 260. These orifices communicate this underside hydraulic pressure to the front side of piston 260 (i.e., the volume between the opposing planer surface of piston 260 and housing part 254. Because of communication through orifices 260.3, the pressure force on piston 260 in the first position results from the coaction of the difference in pressures between compression volume 226.4 and the pressure within internal passage 224.1, acting on the surface area of piston 160 that projects from aperture 254.3.

Piston 260 is slidably received within the cylindrical circumferential wall 254.2 of housing part 254. In some embodiments, the outer diameter 260.1 of piston 260 discourages leakage flow within the internal chamber by way of a close fit between the outer diameter 260.1 of piston 260 and the walls 254.2 of housing 254. However, in some embodiments piston 260.6 includes a slidable seal to discourage leakage flow, such as a Teflon® seal backed up by a spring.

Leakage flow of hydraulic fluid from compression volume 226.4 into the third internal volume of internal chamber 256 is discouraged by a face seal between a portion of the outer diameter of projection 260.9 and the edge of aperture 254.3. In one embodiment, projection 260.9 includes a generally cylindrical plateau for sealing purposes. The abutting faces of plateau 260.9 and the edge of aperture 254.3 are smooth and coplanar to form the face seal. In yet other embodiments, one or both of these abutting surfaces can include a resilient face seal, such as an elastomeric seal molded or placed within a groove on plateau 260.9.

During regressive operation of shock absorber 220, Piston 260 moves toward the second position. When the pressure differential between the pressure in compression volume 226.4 and the pressure within passage 224.1 coact with the surface area of projection 260.9, is sufficient to overcome the biasing force of spring 270, piston 260 moves away from the first position, and the face seal between projection 260.9 and the edge of aperture 254.3 no longer discourages flow into the internal chamber of housing 250. Movement of piston 260 toward the second position creates a gap between the formerly abutting surfaces into which hydraulic fluid flows from compression volume 226.4. As hydraulic fluid enters internal chamber 256, it flows into internal passage 224.1 of rod 224 by way of one or more secondary flow orifices 260.3 located within piston 260. Flow orifices 260.3 are preferably laterally displaced from central orifice 260.2.

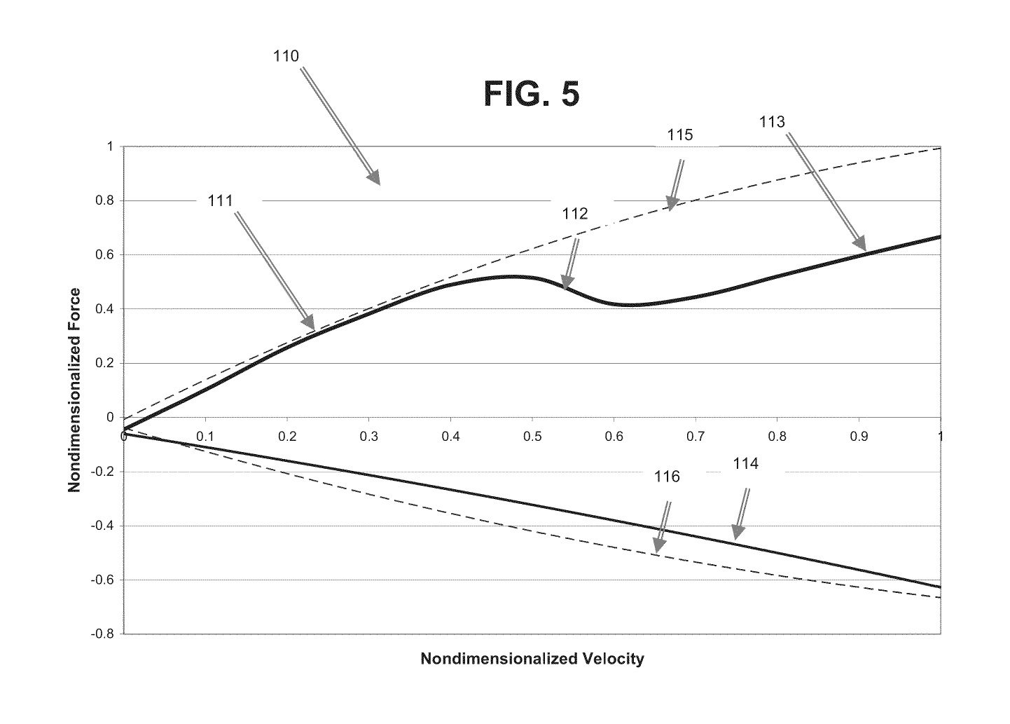

FIG. 5 graphically depicts the damping force characteristics 110 of a shock absorber according to one embodiment of the present invention. Damping curves 110 include graphical depictions 111, 112, and 113 of compressive operation, and graphical depiction 114 of rebound operation. In addition, FIG. 5 includes graphical depictions 115 and 116 of the compressive and rebound characteristics, respectively, of a known shock absorber. Explanation of damping curves 110 will now be made in reference to shock absorber 220, and it is understood that this explanation is generally applicable to shock absorber 120 as well.

During lower velocity compression of shock absorber 220, hydraulic fluid flows from compression volume 226.4 into rebound volume 226.5 through central orifice 260.2 of piston 260, and also through a one way valve 236 of main piston 222. Referring to FIG. 5, the relationship between the damping force and shock absorber relative velocity is indicated by a first progressive portion 111 of composite damping curves 110.

At moderate compressive velocities the pressure force acting on piston 260 causes it to move from a first, sealing position toward a second, open position. This movement of piston 260 results in the ability of hydraulic fluid from compression volume 226.4 to flow through secondary orifice 260.3 of piston 260, as well as through central orifice 260.2. This additional flow area results in a reduction in pressure within compression volume 226.4, such that the pressure drop across main piston 222 is reduced and the damping force is reduced. Operation in this regime is depicted by the regressive portion 112 of damping curves 110.

However, this reduction in pressure does not result in piston 260 moving back to the first position, since the pressure of compression volume 226.4 is communicated to a larger surface area in the second position. Therefore, the coaction of a reduced pressure differential with an increased surface area results in a pressure force capable of maintaining piston 260 in the second position.

At still higher relative higher compressive velocities (as depicted by the second progression portion 113 of damping curve 110), the regressive contribution of housing assembly 250 remains relatively constant, and the overall damping characteristics of the shock absorber are dictated primarily by the one way valves 236 of piston 222, as well as any metering needles 224.3, or other flow components of piston 220. The resultant combined characteristic in compressive flow is thus that of a higher pressure drop fixed restriction in parallel with a one way valve at low velocities, and a lower pressure drop fixed restriction in parallel with a one way valve the same one way valve at higher flow velocities. There is an initial progressive characteristic, followed by a regressive characteristic, which is followed by a second progressive characteristic that is substantially parallel to an extension of the first progressive characteristic. This second progressive characteristic provides a damping characteristic at higher rod velocities.

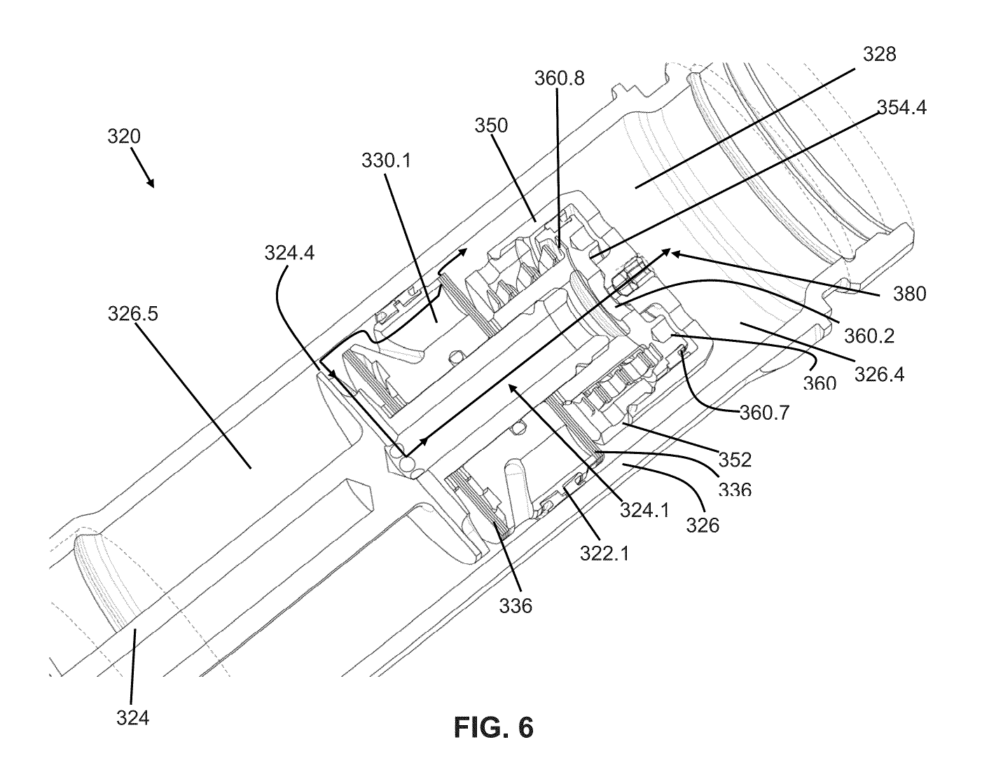

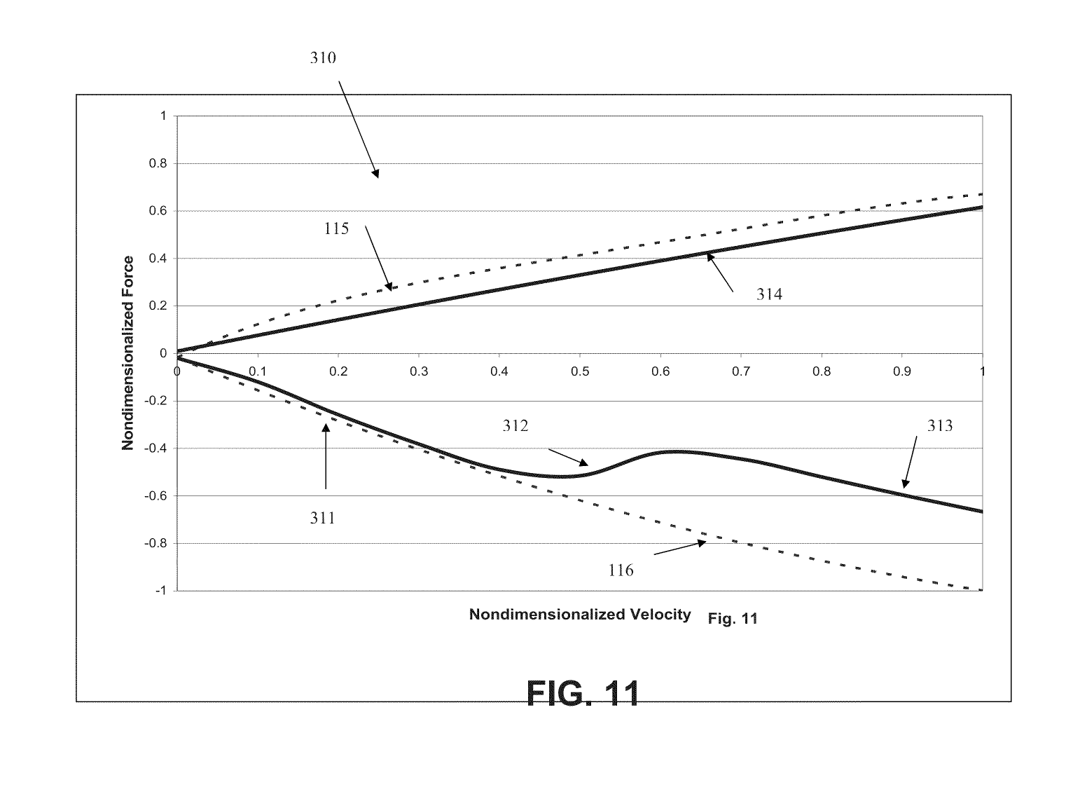

In one illustrative embodiment, the initial progressive characteristic extends up to about 4 inches/second. The regressive characteristic extends from about 5 to 6 inches/second. The second progressive characteristic extends from about 7 inches/second. In one illustrative embodiment, the second progressive characteristic is about 75 lbf lower than a substantially parallel extension of the first progressive characteristic. FIGS. 6, 7, and 8 represent a shock absorber 320 according to another embodiment of the present invention. Shock absorber 320 includes a regressive valve assembly 350 that provides a regressive forcing characteristic during extension of the shock absorber. These regressive extension characteristics are shown graphically in FIG. 11.

Valve housing assembly 350 is similar to valve housing 150 and 250 as previously described, except for the changes discussed and shown herein.

Valve housing 350 includes a piston or poppet 360 that is slidably movable relative to first members 352 and 354. Piston 360 includes an internally threaded bore that is threadably received on the end of rod 324. Piston 360 thus moves with rod 324. A spring 370 is captured between a spring pocket 352.2 of member 352 and spring pocket 360.8 of piston 360. Spring 370 biases piston 360 relative to threadably couple the members 352 and 354 such that surface 360.4 of piston 360 is in sealing contact with face sealing surface 354.4 of member 354.

During extension of damper 320 at lower stroking velocities, rod 324 moves downward and to the left as viewed in FIG. 6. Hydraulic fluid within rebound volume 326.5 is displaced and moves toward piston 322. If the pressure in the rebound volume 326.5 is sufficiently great, then this pressure acts on the stack of shims 336 that act as a one way valve, deflect the shims, and hydraulic fluid flows through a passageway within piston 322 and into compression volume 326.4.

In addition to this flowpath, the fluid within rebound volume 326.5 being displaced by movement of rod 324 is also able to flow through a plurality of feed apertures 324.4 into a central internal passage 324.1. This fluid can flow through the restriction provided by orifice 354.3 that is provided within member 354. As shown in FIG. 6, hydraulic fluid in this flow-path flows with little or no restriction through a central orifice 360.2 within piston 360. Thus, in comparing valve assemblies 350 and 150, it can be seen that the location of the most restrictive portion of this flow-path is preferably located in first member 354 in valve assembly 350, and in piston 260 of valve assembly 250. However, the present invention also contemplates those embodiments in which this most restrictive portion of the flow-path can be placed in either of the members X54 (154, 254, 354, etc.) or piston X60.

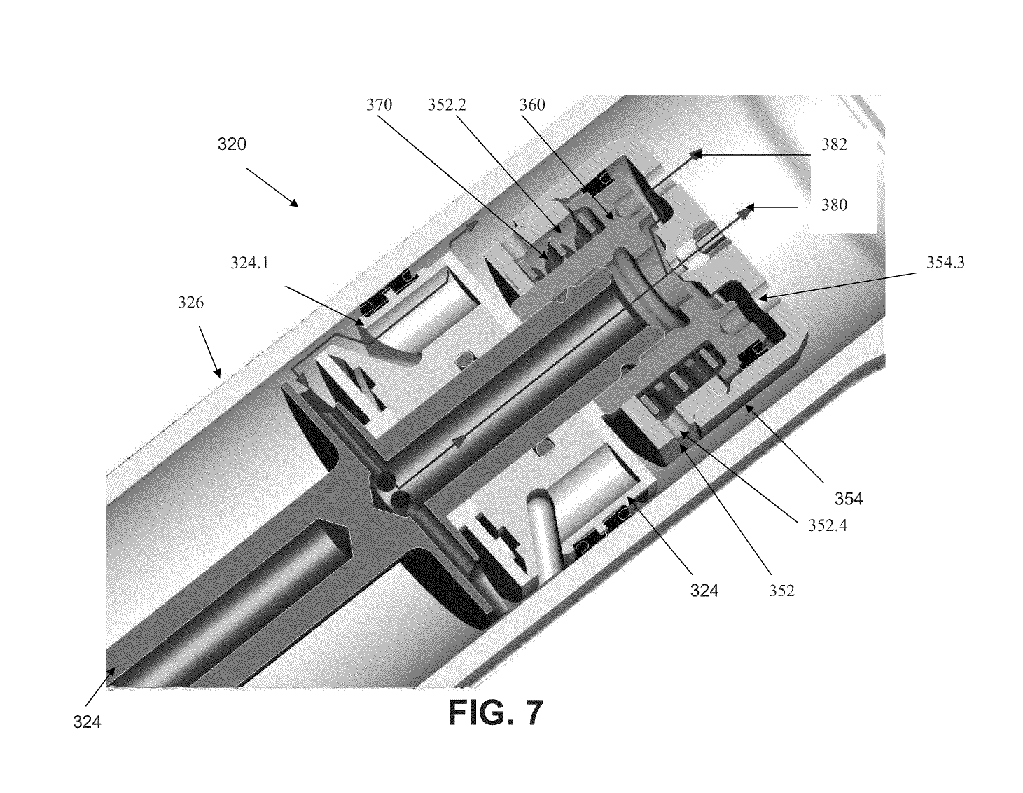

FIG. 7 depicts valve assembly 350 of shock absorber 320 at higher stroking velocities. Hydraulic fluid from within compression volume 326.4 is free to flow within the spring pocket of housing 350 by way of a plurality of apertures 352.4 within member 352. These apertures permit pressure of the compression volume 326.4 to be communicated to the underside of piston 360, up to and including a peripheral resilient seal 360.7. Fluid from compression volume 326.4 is also free to flow to the topside of piston 360 by way of a plurality of apertures 354.3. Thus, as shown in FIG. 6, pressures on both sides of piston 360 are the same, although there is a larger surface area on the side of piston 360 that faces compression end 328. Therefore, there is a net pressure force that pushes piston 360 (as viewed in FIG. 6) toward the left. However, this pressure force is counter-balanced by a preload from spring 370 located within its spring pocket.

Referring to FIG. 7, as pressure in the compression volume 326.4 increases (as a result of a higher extension velocity) the difference in area on either side of the piston, co-acting with the higher fluid pressure is sufficient to overcome the preload of the spring and move housing 350 toward the right (as viewed in FIG. 7.) This relative movement between housing 350 and piston 360 opens a second flow-path from central passage 324.1 of rod 324 to the plurality of orifices 354.3 of member 354. This second, high extension velocity flow-path 382 has a higher flow number, and therefore permits a higher flow of fluid for a given pressure differential, in comparison to low speed flow-path 380.

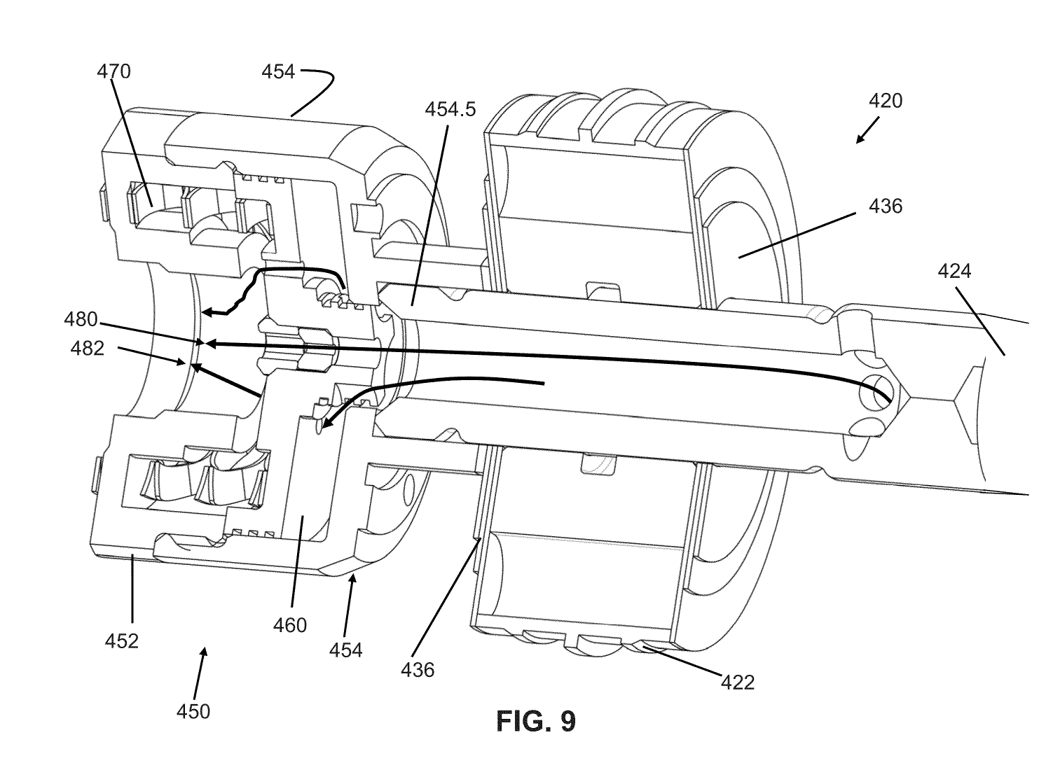

FIG. 9 depicts a portion of a shock absorber 420 having regressive characteristics in extension. Shock absorber 420 includes a rod 420 having a threaded end that is threadably coupled to a member 454 of a valve assembly 450. Valve assembly 450 is similar to valve 150 as shown in FIGS. 2 and 3 except as shown and described hereafter.

In comparing FIGS. 2 and 9, it can be seen that rod 124 is threadably received by housing member 152 of valve assembly 150, whereas valve assembly 450 is threadably received on the other end of the assembly by threads 454.5 of member 454. Note that the relative direction of flow within valves 150 and 450 is the same: fluid flows in the direction from the first member X54 through piston X60 and finally through the second member X52. However, since the valve 450 is oriented as shown in FIG. 9, valve 450 provides regressive flow characteristics in the direction of extension.

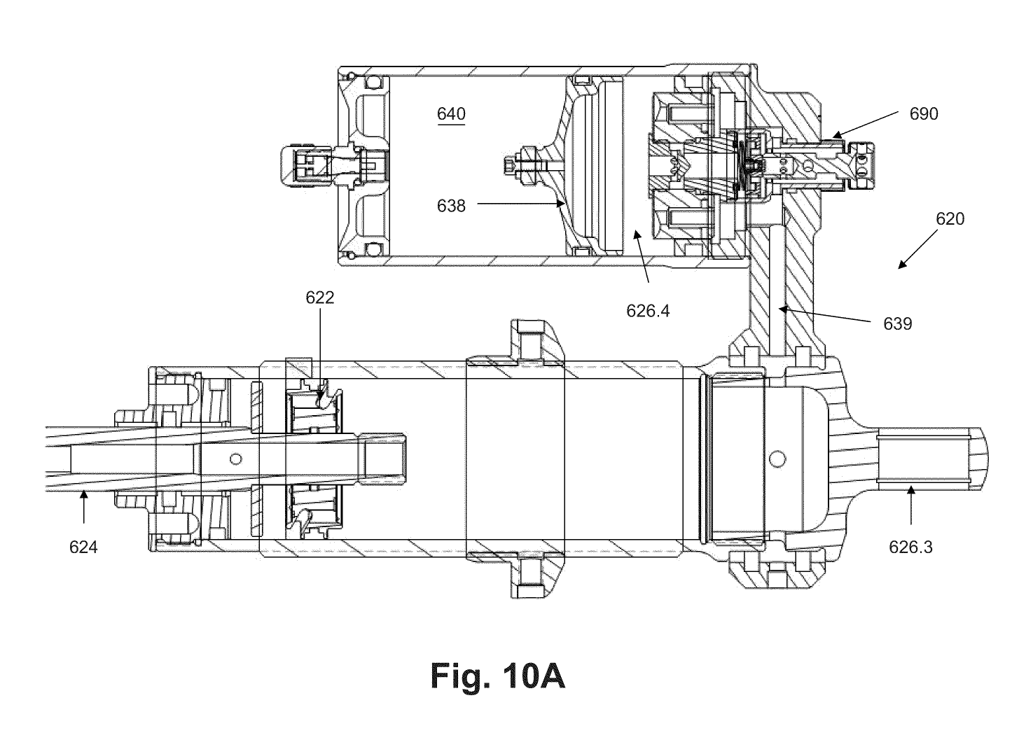

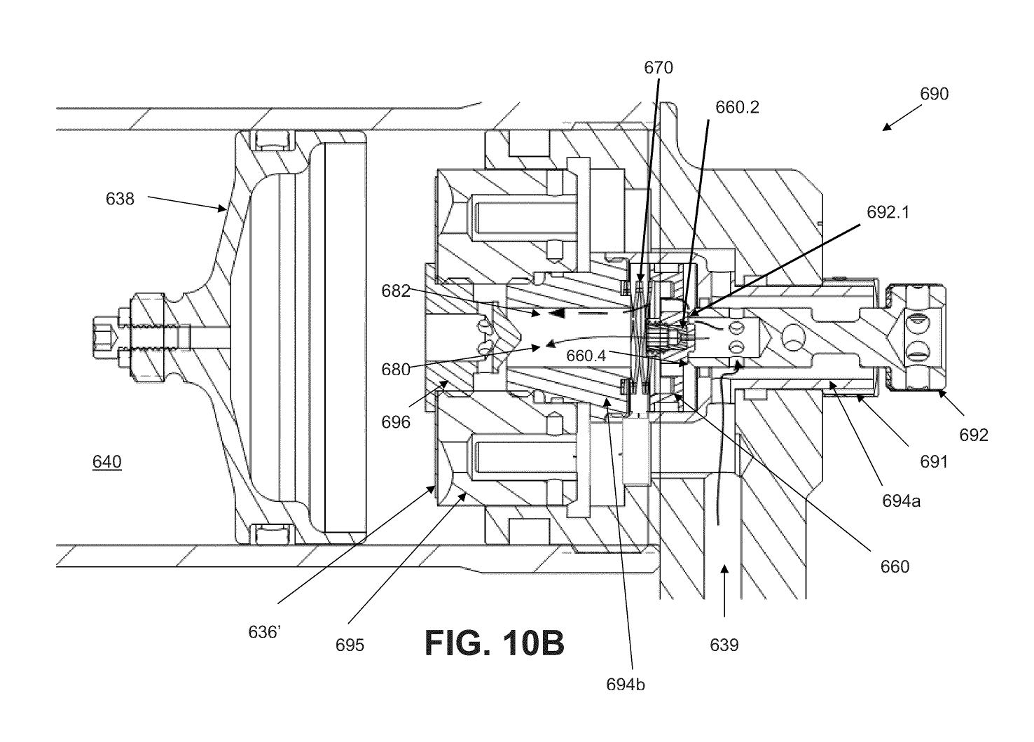

FIGS. 10a and 10b show cross sectional views of an apparatus 620 according to another embodiment of the present invention. FIG. 10a shows a shock absorber 620 having on one end a head valve and reservoir assembly 690 that is in fluid communication by passageway 639 with the compression volume of a shock absorber. Assembly 690 includes an adjustable regressive valve that provides a regressive flowpath into a fluid volume 626.4. That fluid volume is separated by a floating piston 638 from a gas reservoir 640 which preferably contains nitrogen gas under pressure.

FIG. 10b is an enlargement of a portion of the drawing of FIG. 10a. Fluid flowing in through passageway 639 is received within a plurality of circumferential orifices in a first valve member 694a. This flow continues to flow toward the central axis of the regressive valve assembly through a second series of circumferential holes within an inner adjustment member 692. In some embodiments, both adjustment members 694a and 692 can be externally adjusted, as shown in FIG. 10b. Member 692 has on one end (to the rightmost of FIG. 10b) a knob that can be turned by the user. Valve assembly member 694a is coupled to member 691, and provides a gripping means such as a knurled surface for the user to grab and thereby turn valve 694a.

After fluid has flowed through the circumferential apertures of member 694a and adjustment member 692, it is received within an inner flow area where it acts on the center of a slidable piston 660. Piston 660 is slidable within and sealed to the inner diameter of a chamber defined by valve member 694a. A spring 670 is received within a pocket formed on the underside of piston 660. Spring 670 is further biased against a second member 694b that is threadably received by member 694a. Spring 670 is thereby captured within a housing defined by attached members 694a and 694b, and biases piston 660 away from member 694b.

The other, downstream end of member 694b is threadably received within a static member 695. Static member 695 is threadably coupled to the holding structure of head valve assembly 690, and further locates by threads a static flow member 696. One end of flow member 696 includes a conically shaped portion 696.1 that extends into a downstream portion of valve member 694b. As flow from flowpaths 680 and 682 exits member 694, they pass through an annular restriction formed by the conical nose of member 696 and the end of the inner passage of member 694b.

The restriction between the conical portion of member 696 and the exit of member 694b coact to form an adjustable high velocity restriction for the high velocity flowpath 682. As external adjustment member 691 is rotated, valve assembly 694a/694b, which is threadably received within static member 695, moves axially either closer or further from the conical seat of static member 696. With this action, an annular restriction is formed which provides a pressure drop for flowpaths 680 and 682. However, since the magnitude of the high speed flow 682 is generally greater than the flow along path 680, adjustment of the restriction formed by the conical member tends to be more restrictive under high stroking velocity operation.

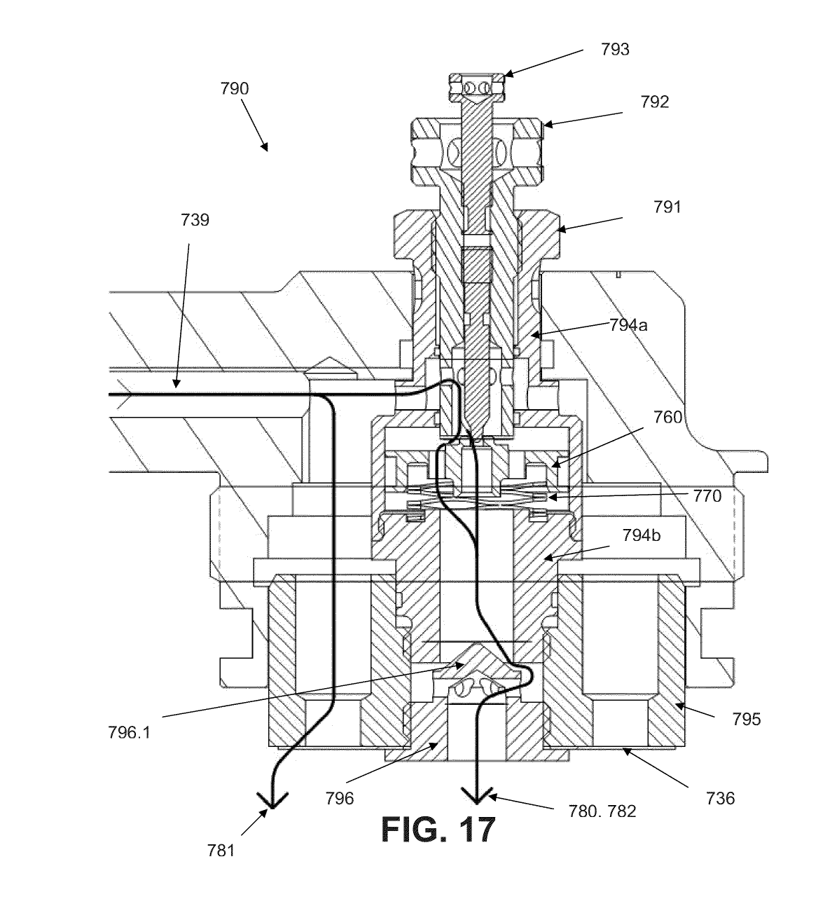

Head valve 690 further includes means for adjusting the preload on the spring, and in this way provides an adjustment that modifies the force at which the low speed portion of the regressive curve ends and the intermediate velocity portion (the portion transitioning to the high velocity regime) begins. Referring to FIG. 10b, adjustment member 692a is threadably received within housing 694a (details of which can be seen in FIG. 17, which is a more detailed view of the apparatus of 10b with regards to this aspect). Rotation of adjustment member 692 thereby moves member 692 axially left and right, as viewed on FIG. 10b. Adjustment member 692 on its interior-most end 692.1 abuts against a face sealing surface 660.4 of piston 660. By moving member 692 left, the preload on spring 670 is increased. By moving member 692 to the right, the preload member on spring 670 is decreased.

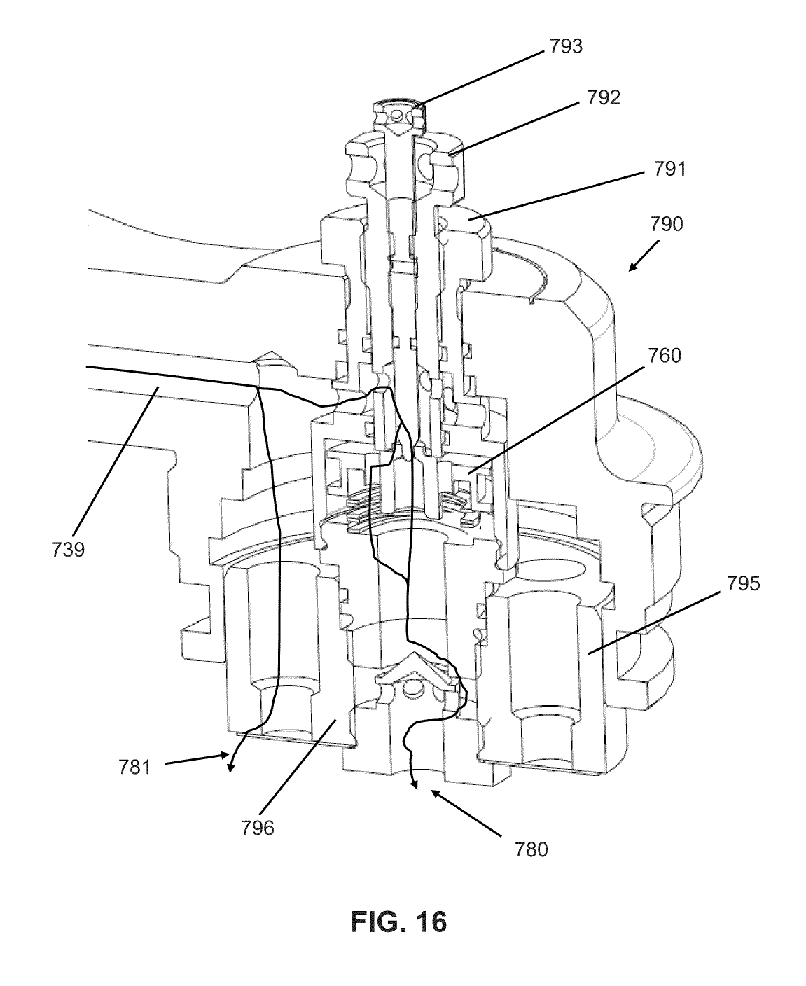

Piston 660 includes a central orifice 660.2 that provides most of the low velocity restriction of head valve 690. The low speed flowpath 680 (through central orifice 660.2) and the high velocity flowpath 682 (around the face seal formed by surfaces 660.4 and 692.1 during high velocity operation) are both provided fluid from pathway 639. However, fluid from passage 639 is further in communication with an annular passage within static valve 695 (and further evident in FIG. 16). Fluid within this annular passage, once it reaches sufficiently high pressure, can blow off past the shim 636, and therefore forms a flowpath parallel with flowpaths 682 and 680 into volume 626.4.

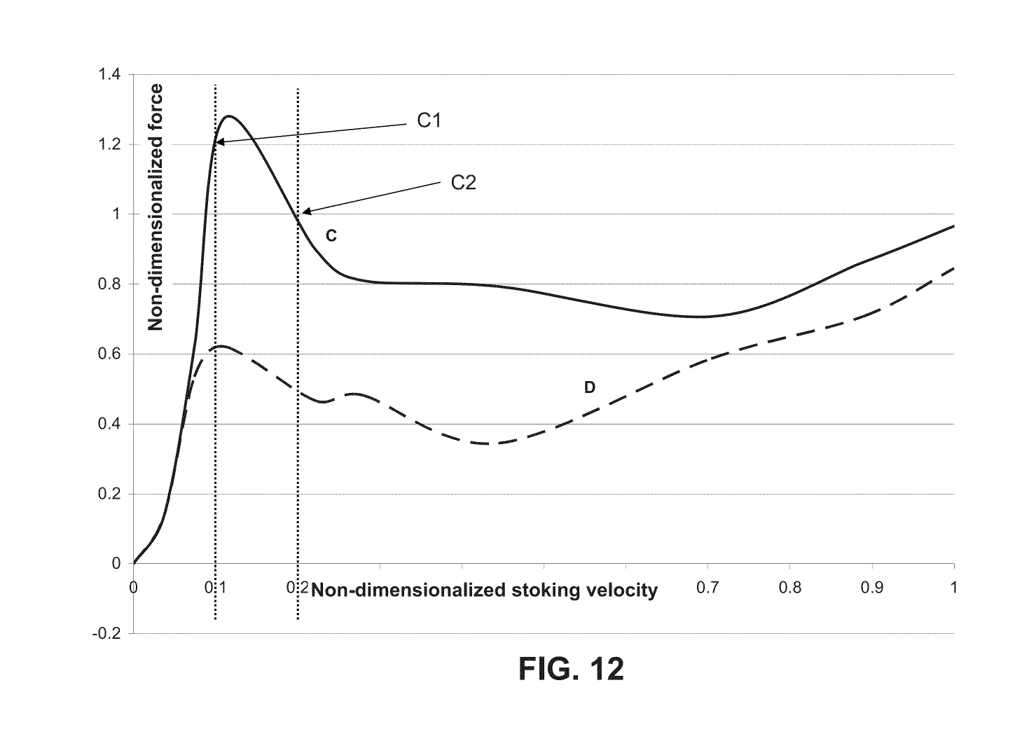

FIGS. 12, 13, and 15 are graphical representations of the adjustments that can be made to a shock absorber having regressive characteristics according to various embodiments of the present invention. Although FIGS. 12, 13, and 15, show regressive characteristics in compression, it is understood that the various adjustments and their subsequent modifications to the regressive characteristic can also be adapted to a shock absorber having regressive characteristics in the extension direction.

FIG. 12 shows the effect of altering the preload of the spring X70 (i.e., 170, 270, 370, 470, 570, and 670). Plot C shows a regressive characteristic with a relatively high spring preload. Graph D shows a regressive characteristic with a relatively low spring preload. The effect of changing the spring preload has little or no effect at low stroking velocities (such as below 0.06). Further, there is relatively little effect at higher stroking velocities, such as from 0.7 to 1.0. The most notable effect on spring load of varying spring preload is in the poppet force that establishes the end of the low speed regime. For both characteristics C and D, the poppet force occurs at a velocity of approximately 0.1. From this low poppet velocity to the high speed characteristic at about 0.7, the piston X60 is moving from its first, spring-preloaded position to its second position. In this intermediate speed regime the low speed flowpath X80 is open, but the second, high speed flowpath X82 is at a position between fully closed and fully open.

FIG. 12 identifies points C1 and C2 along curve C. Taking into account the discussion herein regarding regressive characteristics, the following can be understood: Point C1 shows operation of a shock absorber at a first, lower stroking velocity of 0.1. A shock absorber operating at this stroking velocity would apply a reactive load to the suspension and vehicle at a vehicle of about 1.2. To produce this force, there should be a corresponding pressure differential across the piston. Operation at point C1 is slightly to the left of the apex of curve C. At the apex, the stroking velocity results in a shock absorber reactive load, and further a corresponding piston pressure differential that would actuate any of the regressive valves shown and discussed herein from a first, more viscously restrictive flow characteristic to a second, less viscously restrictive flow characteristic to the right of the apex. Operational point C2 is shown to the right of the curve C apex. Even though the piston stroking velocity is greater than the velocity for point C1, a shock absorber operating at point C2 would provide a reactive load of only about 1.0, less than the reactive load at point C1. It also follows that as a result of point C2 having a higher stroking velocity, that the flow rate of hydraulic fluid being pumped by the piston (which is proportional to the stroking velocity) would be greater than for point C1. As a further consequence, the regressive valve in its second actuated position should be less viscously restrictive to flow, since curve C indicates that there is a lower pressure across the piston even though the flow rate of hydraulic fluid being pumped by the piston is higher. This higher flow rate at point C2 results in a lower pressure drop because of the more open flow characteristic of the second actuated position of the regressive valves shown and described herein.

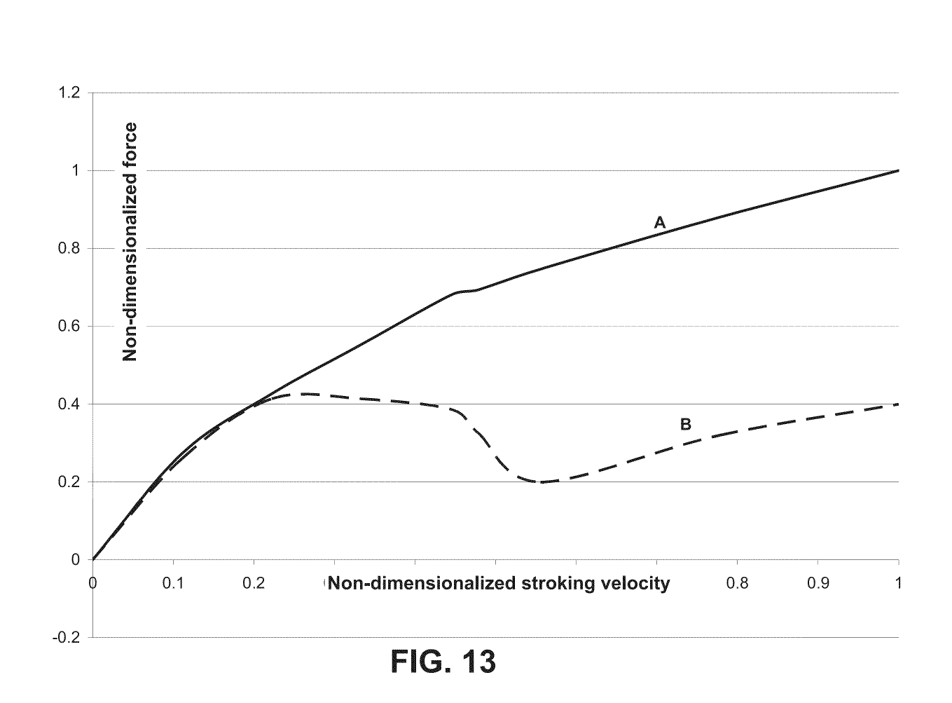

FIG. 13 graphically shows the effect of altering the high velocity flow characteristics of the valve assembly. Both graphs A and B have the same spring preload, and each lifts of at a velocity of about 0.2. Referring to graph B, the second, high speed flowpath X82 moves from its first, fully closed position to a fully open position in an intermediate velocity range from about 0.2 to about 0.50. From a velocity of about 0.55 to 1, the second, high speed flowpath is fully open. Likewise for graph A, the high speed flowpath is fully open from a velocity of about 0.50 to about 1. However, in the case of a valve assembly adjusted to the schedule of graph A, the high speed forcing characteristic at a velocity of 1 is more than doubled relative to graph B. Indeed, the high speed adjustment of graph A results in a high speed flowpath that is so restrictive that the low and intermediate velocity regimes are dominated by the low speed flowpath X80.

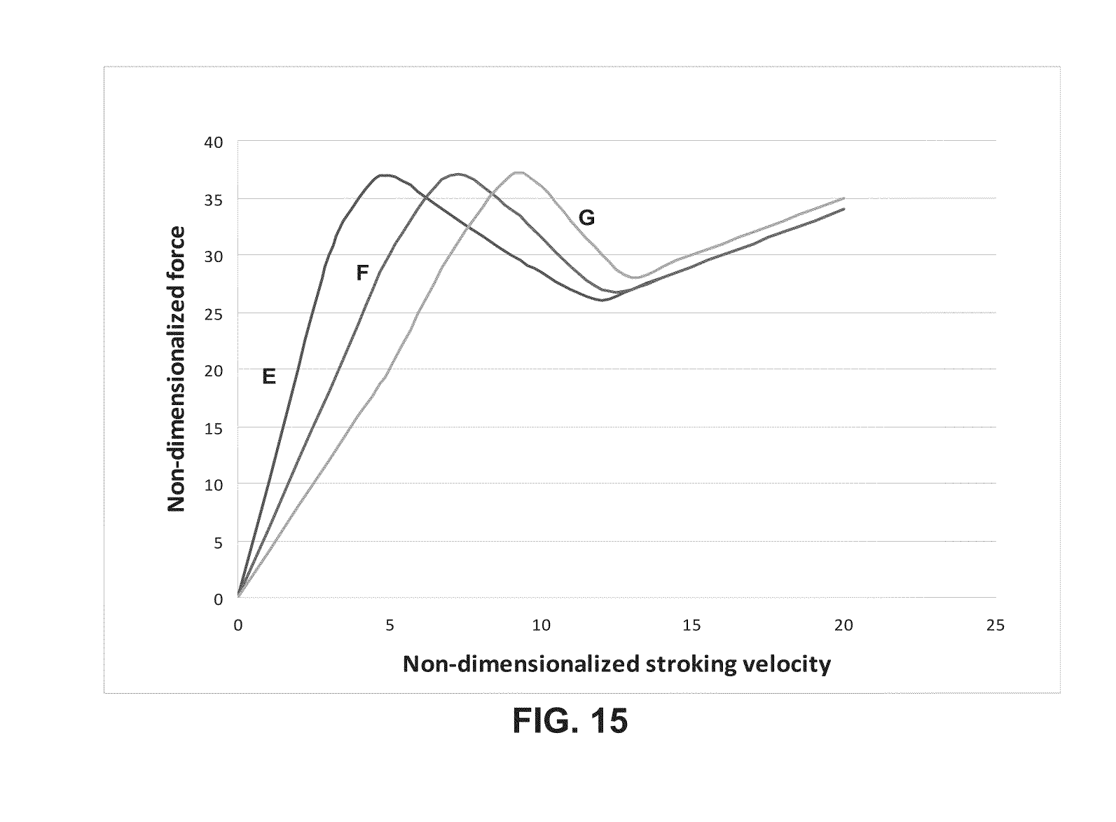

FIG. 15 shows the effect of adjusting the characteristics of the low speed region. In each of graphs E, F, and G, there is the same high speed flow characteristic (beginning at a velocity of about 13) as well as the same spring preload. It can be seen that adjusting the flow characteristics of the most restrictive orifice of the low speed flowpath (whether the orifice is located in the inner piston or a housing member) moves the velocity at which the poppet moves off of its preloaded face sealing contact from a velocity of about 5 (for graph E) to about 10 (for graph G). However, the force at blow off remains at about 37 in. each of these three examples. It can also be seen that each of the three graphs show substantially similar high speed characteristics.

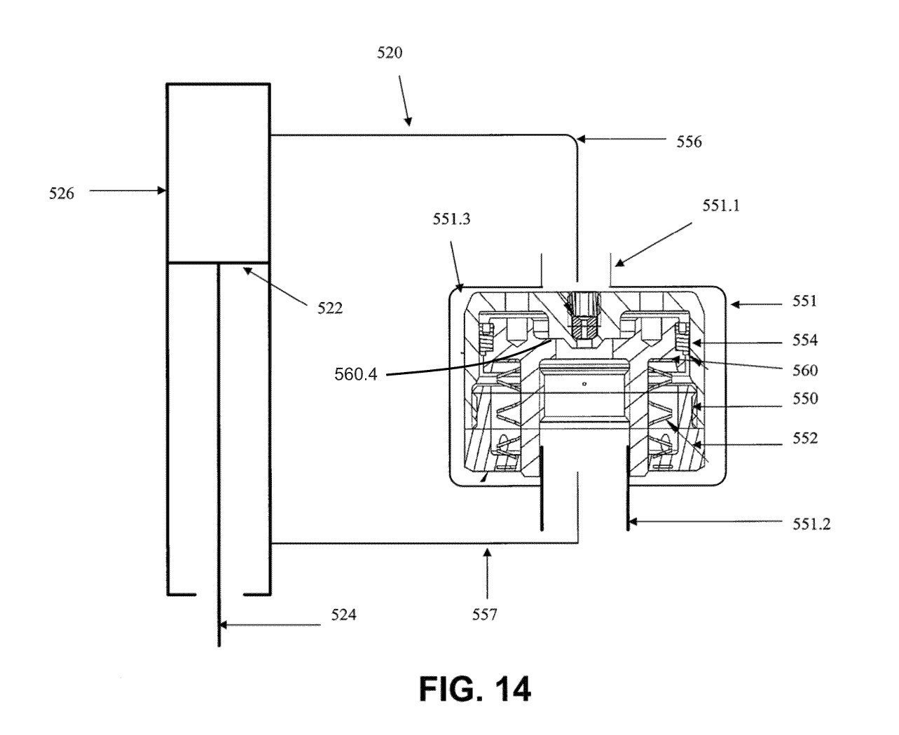

FIG. 14 is a schematic and cross sectional representation of an apparatus according to another embodiment of the present invention. FIG. 14 shows a shock absorber 520 including an external valve assembly that provides a regressive forcing function. Shock absorber 520 includes an external valve assembly 551 that has a first fluid inlet port 551.1 in fluid communication through passageway 556 with the compression volume 526.4 of a cylinder 526. The other end of housing 551 has a fluid port 551.2 in fluid connection via passage 557 with the rebound volume 526.5 of cylinder 526. A piston 522 divides the compression and rebound volumes.

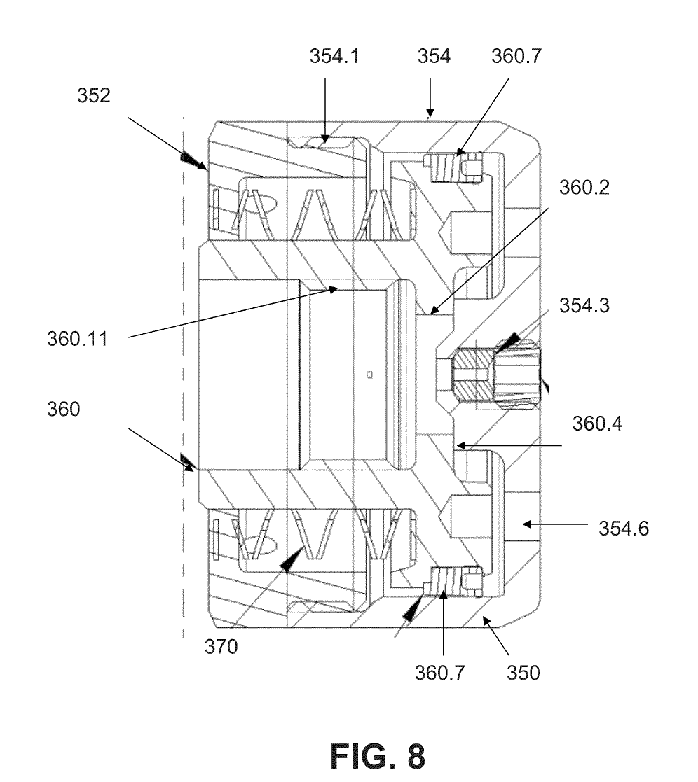

Located within external housing 551 is a valve assembly 550 that is substantially the same as valve assembly 350 of FIG. 8, except as shown and described hereafter. Valve assembly 550 is threadably coupled at one end to outlet port 551.2, thus fixing the position of valve assembly 550 within the interior volume 551.3 of housing 551. Fluid received within port 551.1 is presented to one side of piston 560 by a plurality of apertures 554.6, as is also the case in valve 350. Further, fluid from port 551.1 is further in communication with the central orifice 554.3, and is able to flow through that orifice into the outlet 551.2.

As is the case with valve assembly 350, when pressure on piston 550 is sufficiently high to overcome the preload force exerted by spring 570, fluid is free to flow through flowpath 582 around the face seal between piston 560 and member 554. This second flowpath 582 is in parallel with the first flowpath 580, which is also the case in valve assembly 350.

As can be understood from the drawings and description given herein, shock absorber 520 can have either regressive characteristics in compression or extension based on the orientation of head valve 551. In the orientation as shown in FIG. 14, shock absorber 520 has a regressive forcing characteristic in a compression direction. However, by reorienting external valve assembly 551 such that port 551.1 is in fluid communication with pathway 557 and port 551.2 is in fluid communication with pathway 556, shock absorber 520 has a regressive characteristic in extension. Further, the current invention contemplates those embodiments having first and second external valve assemblies 551, each with an orientation opposite the other such that the resulting shock absorber characteristics are regressive in both extension and compression.

FIGS. 16 and 17 depict an apparatus 790 according to another embodiment of the present invention. Head valve assembly 790 is similar to head valve 690, except as shown and discussed hereafter. Head valve 790 includes a third means for adjusting the regressive flow characteristics of valve assembly 790. Head valve 790 includes a third means 793 for adjusting the low velocity regressive characteristics of a shock absorber. A shaft 793 includes an external feature (at the top of page 17) by which a user can grip and turn shaft 793. Shaft 790 is threadably received within the inner diameter of adjustment collar 792. Further, shaft 793 includes a sealing groove and seal (not shown) for discouraging leakage flow between shaft 793 and collar 792.

At the innermost end of shaft 793 there is a bull nose projection that is received within a central aperture of piston 760. An annular restriction is formed between the bull nose projection and the central aperture. Fluid from passageway 739 flows through this annular restriction as the low velocity flowpath 780. By rotating shaft 793 relative to collar 792, the bull nose projection is moved axially within the central aperture of piston 760. Since the outer surface of the bull nose projection is contoured, moving the projection upward (referring to FIG. 17) increases the area of the annular flowpath and thereby decreases the restrictiveness of flowpath 780.

In one embodiment, the high velocity regressive adjustment of member 794b relative to conical projection 796.1 includes positive means for establishing the relative rotational positions of member 794b and the static structure of head valve 790, such as a detent mechanism. As shown in FIG. 17, outer adjustment member 791 is integral with member 794a.

Preferably, there is a detent mechanism or other method of positively establishing the relative rotational positions of adjustment collar 792 and member 794a, such as a detent mechanism. Further, in some embodiments, there is a detent mechanism establishing positively the relative rotational positions of shaft 793 and collar 792.

Although what has been shown and described in FIGS. 16 and 17 are three adjustments features 791, 792, and 793 that act on a head valve 790, the invention is not so limited. Other embodiments of the present invention contemplate adjustments of the regressive characteristics that can be made for valve assemblies X50 located on either rod X24 or piston X22. As one example, and referring to FIGS. 2 and 3, the present invention contemplates those embodiments in which one, two or three adjustments are located within the rod and extend through the main piston to the regressive valve assembly.

Further, although some embodiments such as valve assembly 150 are shown attached to the end of rod 124, the present invention also contemplates those embodiments in which the valve assembly X50 is attached to piston X22.

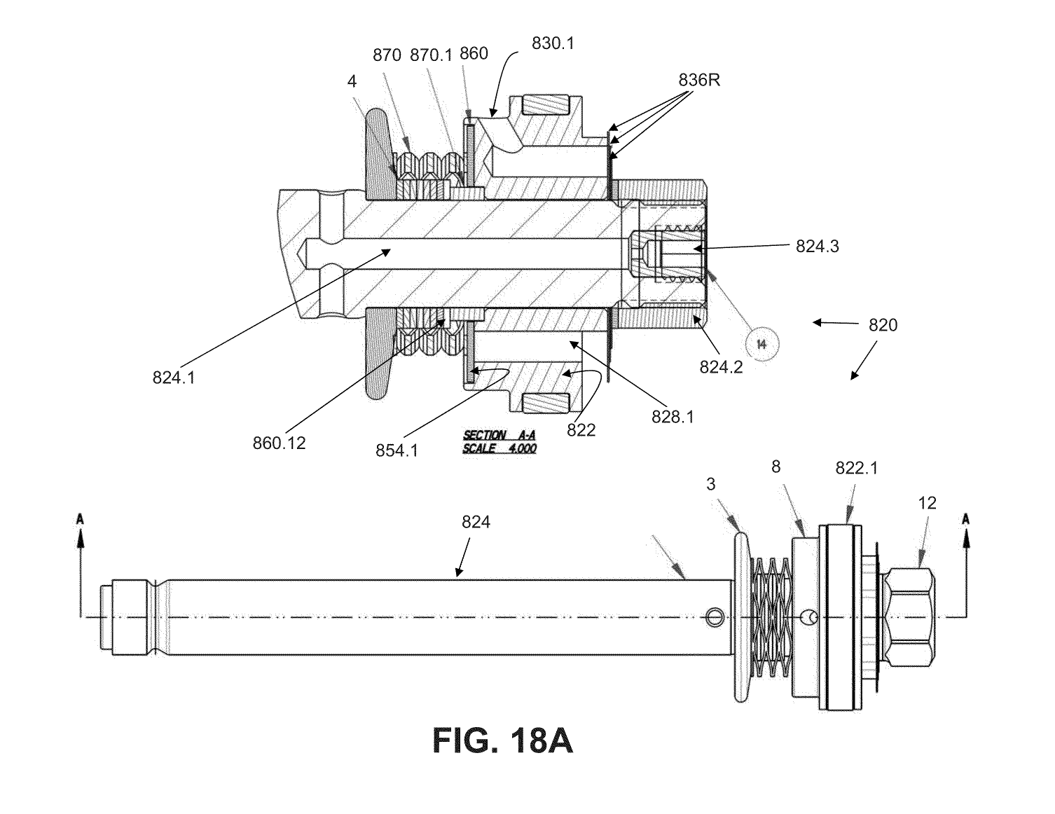

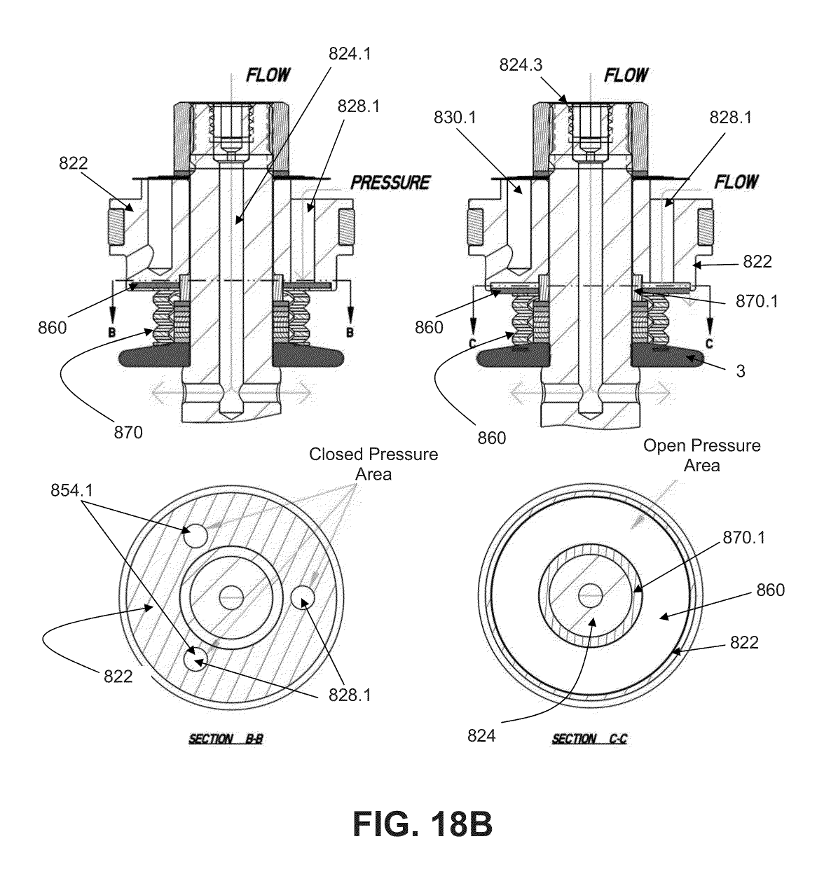

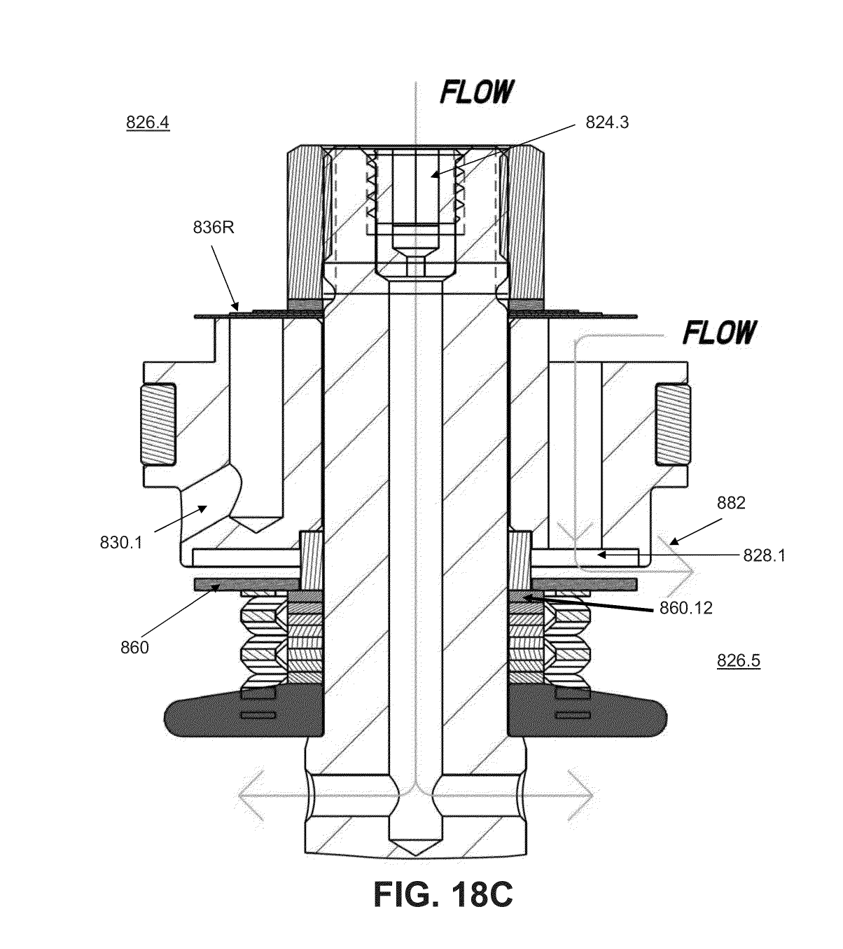

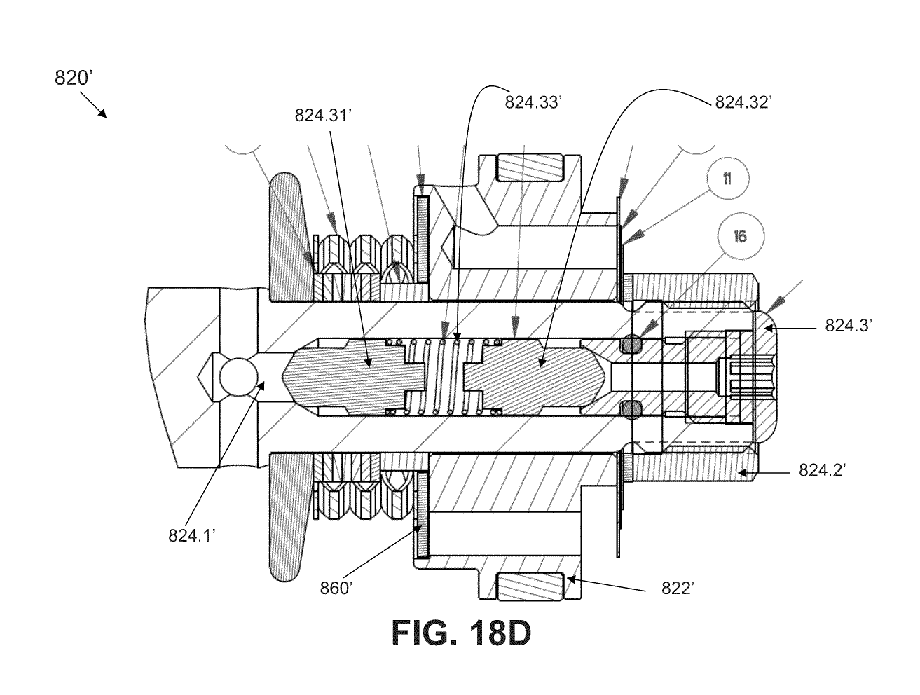

FIGS. 18a, 18b, and 18c show portions of a shock absorber 820 according to another embodiment of the present invention. FIG. 18a shows portions of the shock absorber, including a shaft 824 which has attached to it at the other end a piston 822. For purposes of clarity, the nitrogen chamber, reservoir piston, cylinder, head valve assembly (if any) and other components are not shown.

FIG. 18a at the bottom shows a rod 824 having located at one end a piston 822 which includes a seal 822.1 in sealing contact with the inner wall of a cylinder (not shown). A coupling nut 824.2 retains the piston 822 and associated springs between one face of the nut and a topout plate (identified in this drawing as element 3).

The top of FIG. 18a shows one end of the piston and rod assembly in a cross-sectional view. A piston 822 includes within it a first flowpath 830.1 that is open at one end, and closed at the other end by shims 836R. Flowpath 830.1 is normally closed, but if the pressure within flowpath 830.1 becomes sufficiently great, shims 836R will deform out of their planar shape and allow flow from one side of seal 822.1 to the other side (i.e., from rebound volume 826.5 to compression volume 826.4, with reference to similar notation shown in FIGS. 1a and 1 b).

Shock absorber 820 includes features that provide a regressive characteristic to damping forces during compression of the shock absorber. Piston 820 includes a compression flowpath 828.1 that provides hydraulic fluid to the face of a second piston 860. In FIG. 18a at the top, piston 860 is shown nested and received within a counter bore of piston 822. In this fully nested position, piston 860 substantially seals any flow through flowpath 828.1. The interface between piston 860 and piston 822 is adapted and configured to substantially discourage flow in the fully nested position. Piston 860 in one embodiment is a substantially circular plate with an inner diameter that is guided by the outer diameter of a bushing 870.1.

Piston 860 is urged against piston 822 by a spring 870 that biases apart from each other piston 860 and topout plate 3. In some embodiments, the inner diameter of spring 870 is guided by the outer diameter of a piston travel stop 860.12. As shown in FIG. 18a, the guide 860.12 comprises a plurality of substantially flat washers stacked together. It can be seen that these washers have an outer diameter that is greater than the outer diameter of bushing 870.1. Therefore, any movement of piston 860 toward top out plate 3 is limited when contact occurs between a face of stop 860.12 and an opposing face of piston 860, as will be shown later.

Flow can also pass from the compression volume 826.4 toward the rebound volume 826.5 of piston 820 through a check valve or metering valve 824.3 in rod internal passage 824.1. Some embodiments include a flowpath through rod internal passage 824.1 that is in parallel with either the rebound or compression (or both) flowpaths through the piston. However, some embodiments of the present invention (such as some of those embodiments intended for mountain bikes) do not have this internal passage.

It is understood that in some embodiments of the present invention there is no internal flowpath 824.1 within rod 824. Further, in those embodiments in which there is such a flowpath, it is understood that the flowpath can include one or more valves 824.3. These valves can be of any type, including on/off check valves, spring loaded check valves that pop off at predetermined pressures, or other types. Further, the location of the valve can be at the end of the rod 824, as seen in FIG. 18a, or in the rod flowpath outlets on the other side of topout plate 3. Further, as seen in FIG. 1 b, the flowpath 824.1 can also include an externally adjustable metering valve. FIG. 18b show both closed operation and low-speed operation of the flowpaths of shock 820, on the left and right of the diagram, respectively. Referring to the closed configuration on the left side, it can be seen that piston 860 is fully nested within the counter bore of piston 822. Spring 870 is fully extended and biasing apart piston 860 from the topout plate. Pressure from hydraulic fluid within flowpaths 828.1 act on preferably one or more discrete and separate pressure areas as best seen on the bottom left side of FIG. 18b. In these three discrete areas, flowpath 828.1 is substantially closed and sealed by sealing face 854.1 of piston 860.

The right side of FIG. 18b shows a state of shock absorber 820 during compression at relatively low stroking velocity. As best seen in the top right side of the page, pressure within flowpath 828.1 becomes sufficiently great to push piston 860 toward topout plate 3. Piston 860 is guided toward topout plate 3 by bushing 870.1. As indicated by a flow arrow, some flow of hydraulic fluid passes through flowpath 828.1 and between the largest diameter of the counter bore of piston 822 and the edge at the outer diameter of piston 860.

FIG. 18c shows a portion of shock absorber 820 in the fully blown-off position. Pressure within the compression volume 826.4 of the cylinder is sufficiently great that it acts on piston 860 as to move it fully out of the counter bore of piston 822. Preferably, there is a gap between piston 822 and piston 860 through which hydraulic fluid flows into rebound volume 826.5. FIG. 18c shows piston 860 in contact with piston stop 860.12. The position of piston stop 860.12 establishes how much high speed flow can pass through the regressive flowpath when it is fully open. Flow through this compression flowpath 828.1 is augmented by flow through valve 824.3 into rod internal flowpath 824.1.

FIG. 18d shows a portion of a shock absorber 820′ according to another embodiment of the present invention. Shock absorber 820′ is similar to shock 820, except for a pair of opposing spring-loaded check valves 824.3′ located within rod passageway 824.1′. Valve 824.3′ includes a pair of check valves 824.31′ and 824.32′ that are biased apart within an internal cavity of rod 824′ by a spring 824.33′. Valve 824.3′ thus allows flow through passage 824.1′ in either direction, once the upstream pressure is sufficiently great to push open the check valve that the upstream pressure impinges upon. Once one of the check valves has become unseated and moves toward the opposite check valve, a flow passage is open permitting flow from the high pressure side of piston 822′ to the low pressure side of piston 822′.

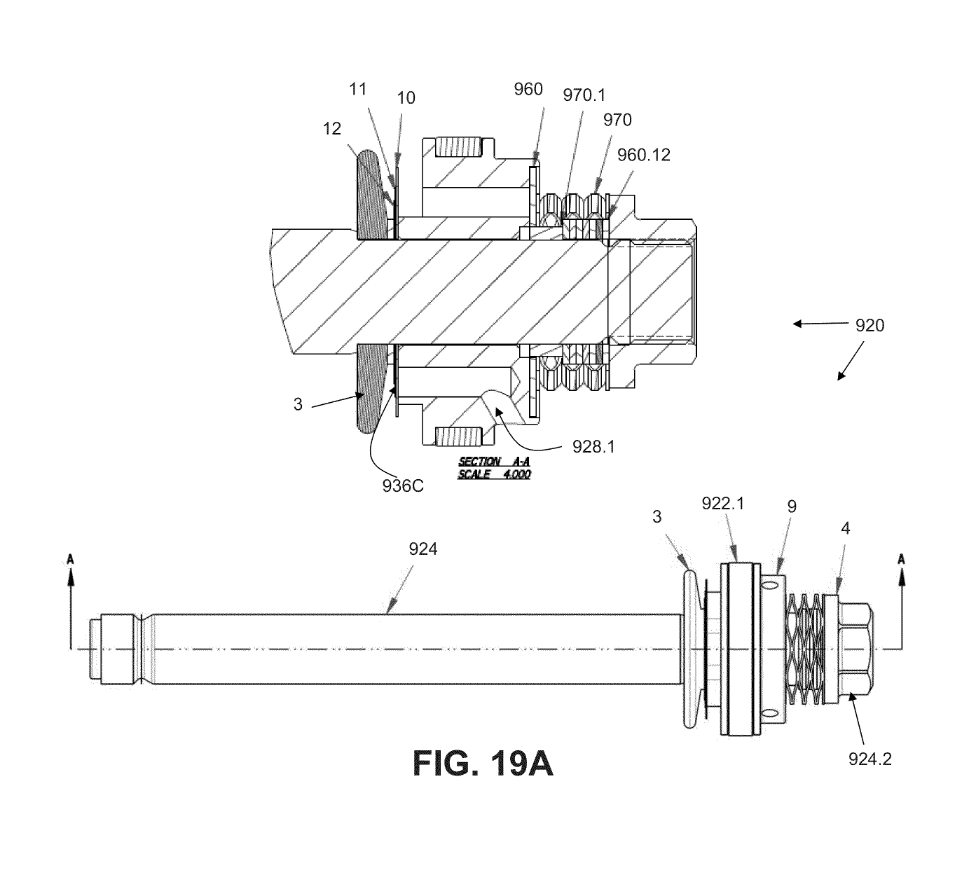

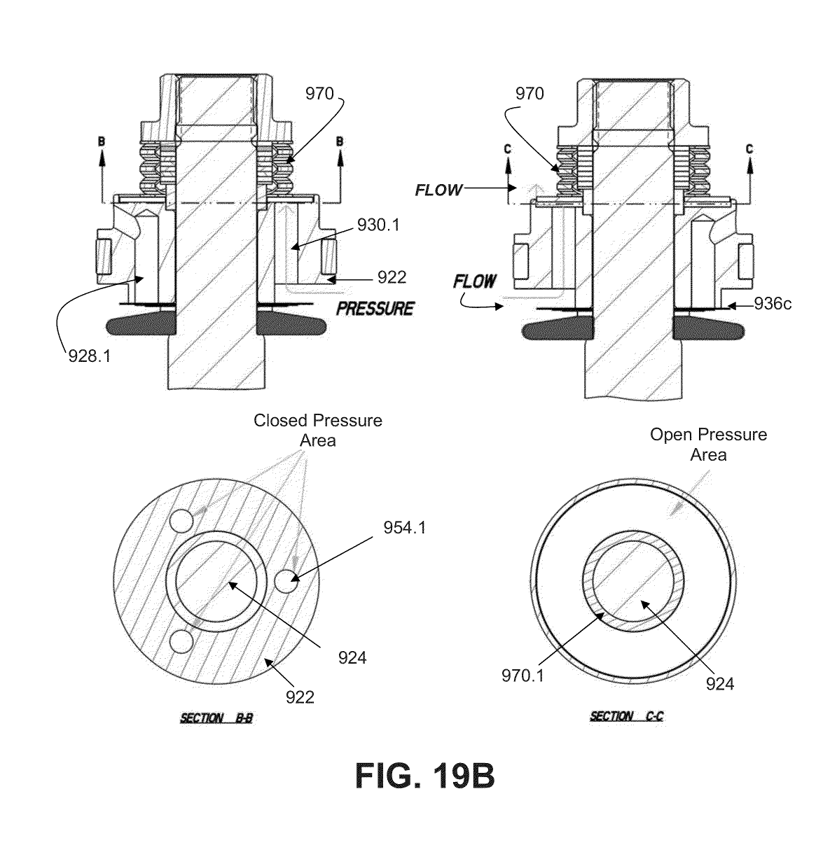

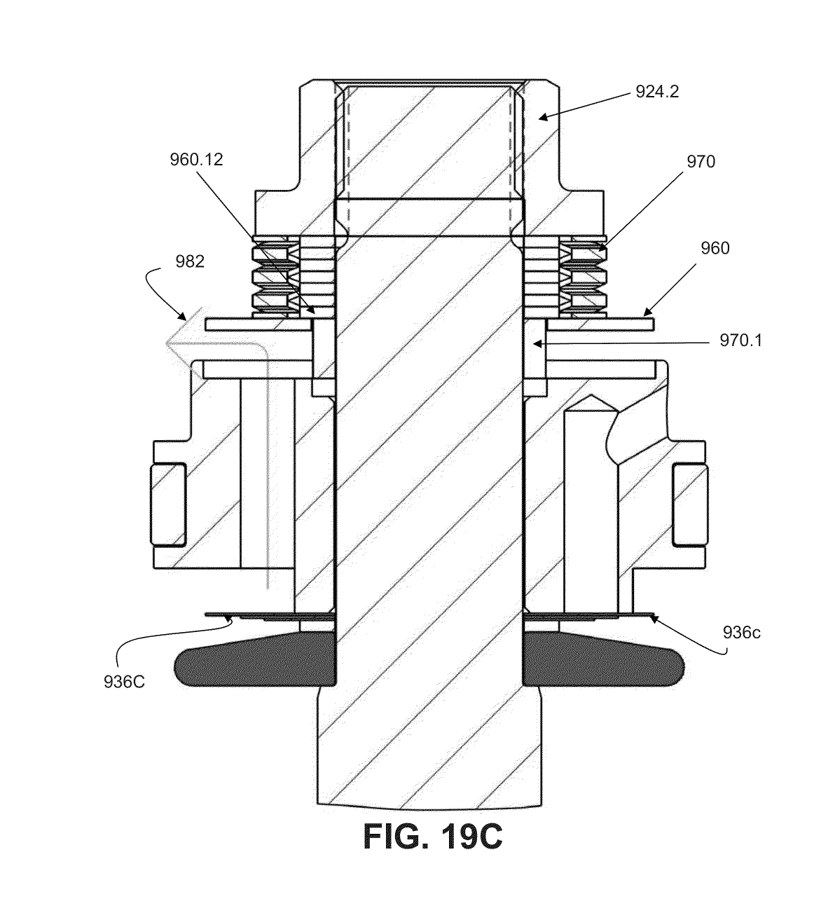

FIGS. 19a, 19b, and 19c show portions of a shock absorber 920 according to another embodiment of the present invention. FIG. 19a shows portions of the shock absorber, including a shaft 924 which has attached to it at the other end a piston 922. For purposes of clarity, the nitrogen chamber, reservoir piston, cylinder, head valve assembly (if any) and other components are not shown.

FIG. 19a at the bottom shows a rod 924 having located at one end a piston 922 which includes a seal 922.1 in sealing contact with the inner wall of a cylinder (not shown). A coupling nut 924.2 retains the piston 922 and associated springs between one face of the nut and a topout plate (identified in this drawing as element 3).

The top of FIG. 19a shows one end of the piston and rod assembly in a cross-sectional view. A piston 922 includes within it a first flowpath 928.1 that is open at one end, and closed at the other end by shims 936C. Flowpath 928.1 is normally closed, but if the pressure within flowpath 928.1 becomes sufficiently great, shims 936C will deform out of their planar shape and allow flow from one side of seal 922.1 to the other side (i.e., from compression volume 926.4 to rebound volume 926.5, with reference to similar notation shown in FIGS. 1a and 1 b).

Shock absorber 920 includes features that provide a regressive characteristic to damping forces during rebound of the shock absorber. Piston 920 includes a rebound flowpath 930.1 that provides hydraulic fluid to the face of a second piston 960. In FIG. 19a at the top, piston 960 is shown nested and received within a counter bore of piston 922. In this fully nested position, piston 960 substantially seals any flow through flowpath 930.1. The interface between piston 960 and piston 922 is adapted and configured to substantially discourage flow in the fully nested position. Piston 960 in one embodiment is a substantially circular plate with an inner diameter that is guided by the outer diameter of a bushing 970.1.

Piston 960 is urged against piston 922 by a spring 970 that biases apart from each other piston 960 and retaining nut 924.2. In some embodiments, the inner diameter of spring 970 is guided by the outer diameter of a piston travel stop 960.12. As shown in FIG. 19a, the guide 960.12 comprises a plurality of substantially flat washers stacked together. It can be seen that these washers have an outer diameter that is greater than the outer diameter of bushing 970.1. Therefore, any movement of piston 960 toward top out plate 3 is limited when contact occurs between a face of stop 960.12 and an opposing face of piston 960, as will be shown later.

Flow can also pass from the rebound volume 926.5 toward the compression volume 926.4 of piston 920 through a check valve or metering valve (not shown) in rod internal passage 924.1. Some embodiments include a flowpath through rod internal passage 924.1 that is in parallel with either the rebound or compression (or both) flowpaths through the piston. However, some embodiments of the present invention (such as some of those embodiments intended for mountain bikes) do not have this internal passage.

It is understood that in some embodiments of the present invention there is no internal flowpath 924.1 within rod 924. Further, in those embodiments in which there is such a flowpath, it is understood that the flowpath can include one or more valves 924.3. These valves can be of any type, including on/off check valves, spring loaded check valves that pop off at predetermined pressures, or other types. Further, the location of the valve can be at the end of the rod 924, or in other parts of the rod internal flowpath nut 924.2. Further, as seen in FIG. 1 b, the flowpath 924.1 can also include an externally adjustable metering valve. FIG. 19b show both closed operation and low-speed operation of the flowpaths of shock 920, on the left and right of the diagram, respectively. Referring to the closed configuration on the left side, it can be seen that piston 960 is fully nested within the counter bore of piston 922. Spring 970 is fully extended and biasing apart piston 960 from the retaining nut. Pressure from hydraulic fluid within flowpaths 930.1 act on preferably one or more discrete and separate pressure areas as best seen on the bottom left side of FIG. 19b. In these three discrete areas, flowpath 930.1 is substantially closed and sealed by sealing face 954.1 of piston 960.

The right side of FIG. 19b shows a state of shock absorber 920 during rebound at relatively low stroking velocity. As best seen in the top right side of the page, pressure within flowpath 930.1 becomes sufficiently great to push piston 960 toward retaining nut 924.2. Piston 960 is guided toward retaining nut 924.2 by bushing 970.1. As indicated by a flow arrow, some flow of hydraulic fluid passes through flowpath 930.1 and between the largest diameter of the counter bore of piston 922 and the edge at the outer diameter of piston 960.

FIG. 19c shows a portion of shock absorber 920 in the fully blown-off position. Pressure within the rebound volume 926.5 of the cylinder is sufficiently great that it acts on piston 960 as to move it fully out of the counterbore of piston 922. Preferably, there is a gap between piston 922 and piston 960 through which hydraulic fluid flows into rebound volume 926.5. FIG. 19c shows piston 960 in contact with piston stop 960.12.

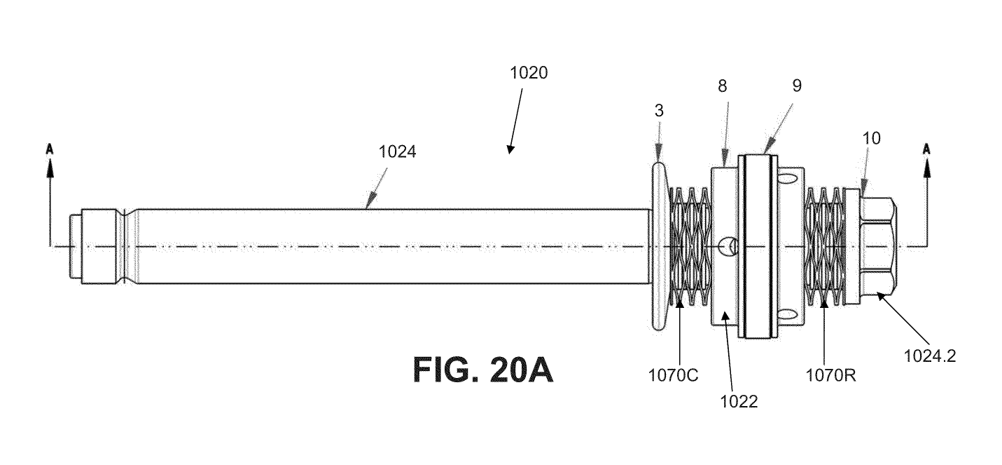

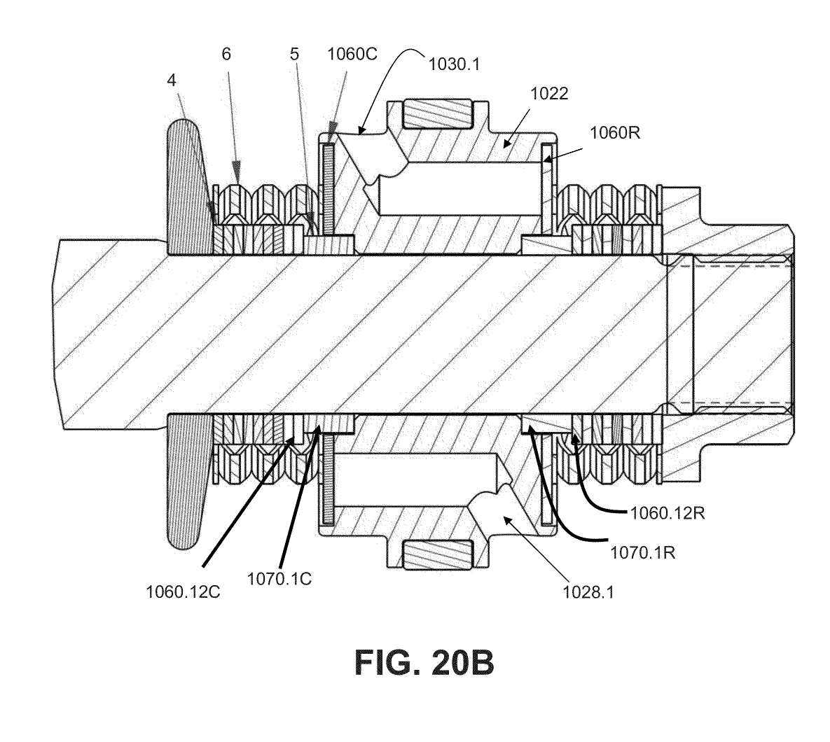

FIGS. 20a and 20b depict portions of a damper 1020 that combines the regressive features of shocks 820 and 920. As best seen in FIG. 20b, each of the flowpaths through piston 1022 are initially closed by a piston 1060. Specifically, rebound flowpath 1030.1 is initially closed by piston 1060R within a counter bore of piston 1022. Likewise, compression flowpath 1028.1 is initially closed by a piston 1060C that is nested within another counter bore of piston 1022. Various embodiments of the present invention include one or more bypassing flowpaths that provide a damping force even if pistons 1060C and 1060R are closed or in positions that substantially discourage flow (such as leakage prior to lift off of the regressive piston).

Similar to the configurations noted with shock absorbers 820 and 920, each piston 1060C and 1060R is biased to a closed position by a corresponding spring 1070C or 1070R, respectively. The pistons 1060C and 1060R are guided by bushings 1070.1C and 1070.1R, respectively, and can travel in the opened direction until bottomed out against their respective travel stops 1060.12C or 1060.12R, respectively.

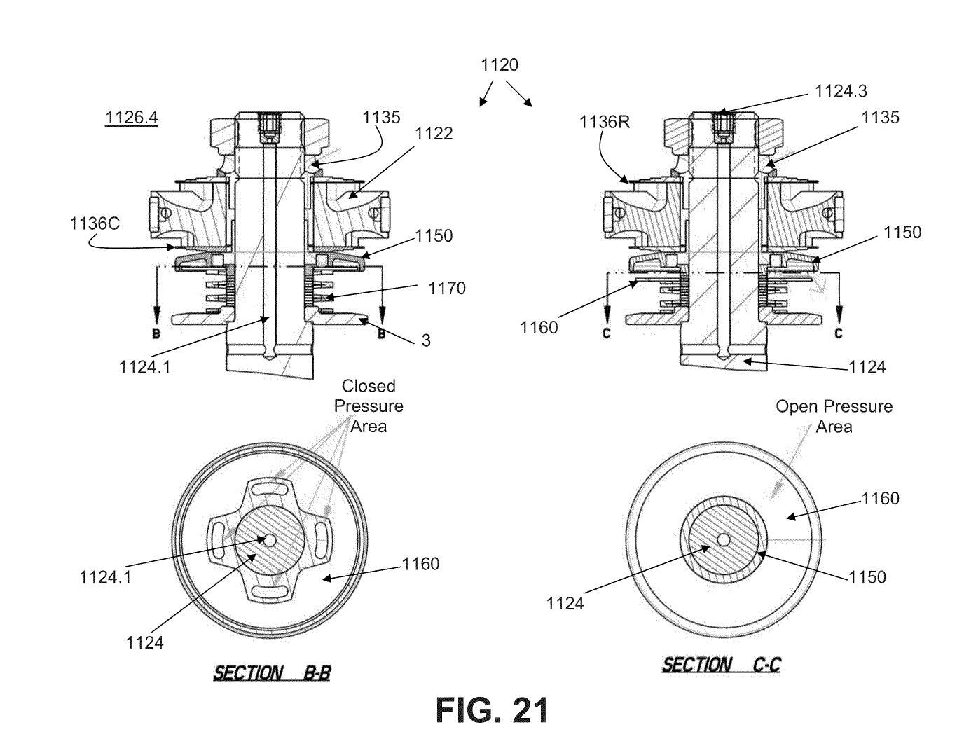

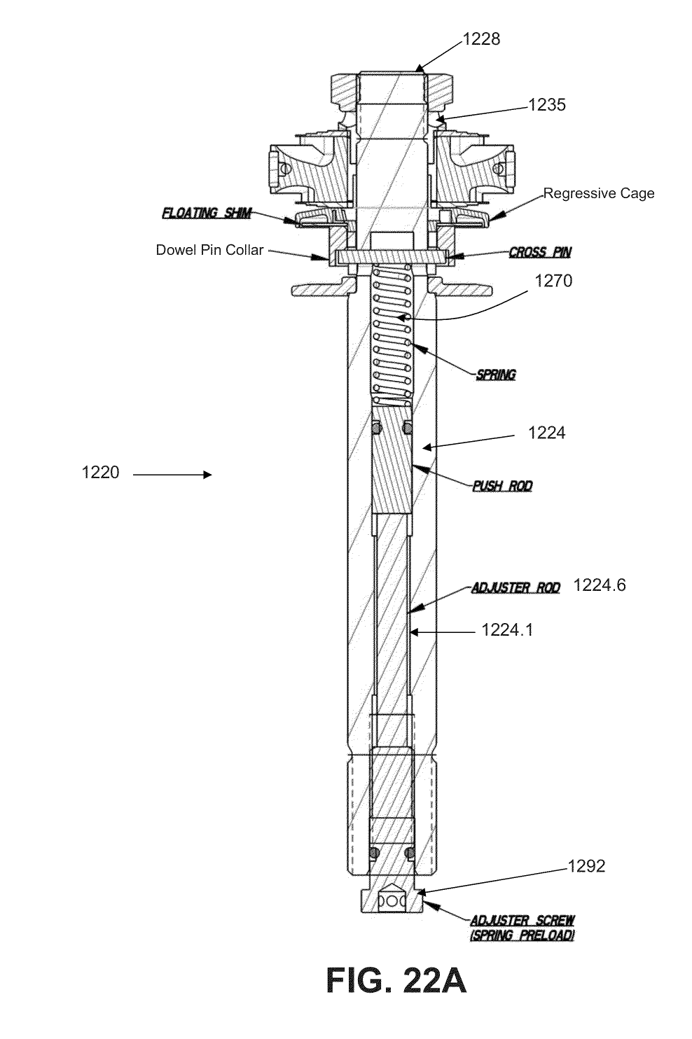

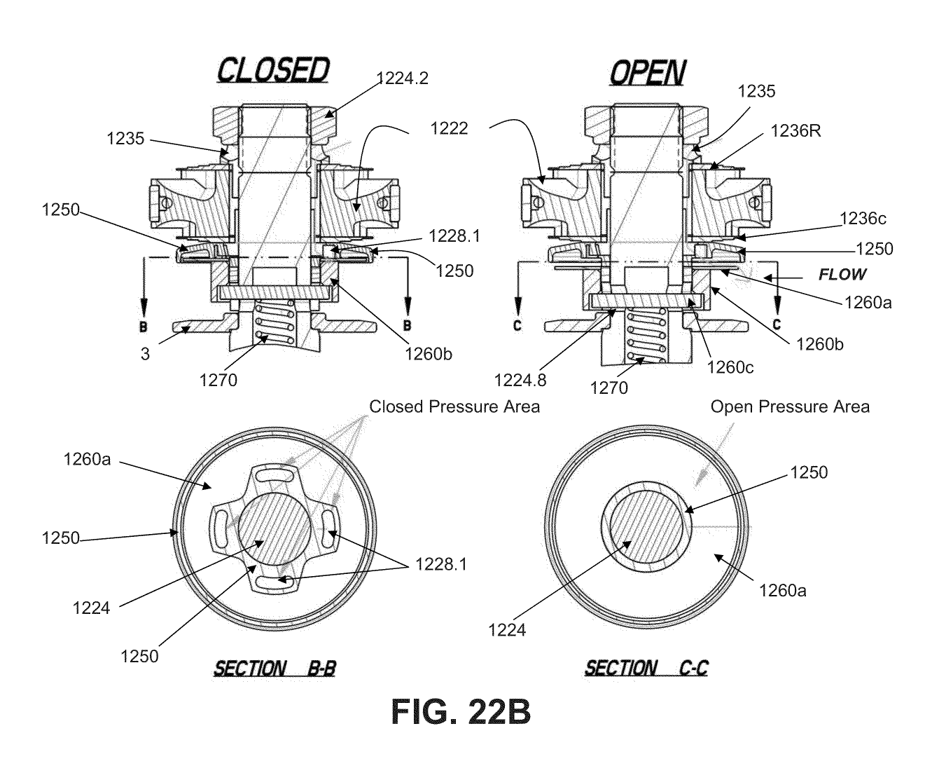

FIGS. 21 and 22 present embodiments to the present invention in which the regressive valve is substantially separate from the main piston 22. In some embodiments, the piston 22 includes a second, regressive flowpath that is in parallel with either the compression flowpath or the rebound flowpath.

FIG. 21 shows a portion of a shock absorber 1120 having a regressive damping function during compression of the shock, similar to shock 820. However, it is understood that just as the features of shock 820 can be converted to regression in rebound or regression in both directions, such as in shocks 920 and 1020, respectively, the regressive features shown for shock 1120 can likewise be applied for regressive characteristics in the rebound direction or in both directions.

Piston 1122 includes a rebound flowpath 1130.1 (not shown) that is normally closed by one or more shims 1136R. Further, piston 1122 includes a compression flowpath 1128.1 (not shown) that is normally closed by one or more shims 1136C. These rebound and compression flowpaths operate in some embodiments as the shimmed one-way valves described earlier in this document.

Shock 1120 further includes a regressive flowpath 1135 that permits flow of fluid from the compression volume 1126.4 within cylinder 1126 between the inner diameter of piston 1122 and the outer diameter of rod 1124. Regressive flowpath 1135 provides hydraulic fluid to a chamber defined between rod 1122 and static housing 1150. This flow chamber is normally closed by the action of a spring 1170 that biases piston 1160 apart from a topout plate 3. As shown on the left side of FIG. 21, regressive flowpath 1135 is closed, since pressure in volume 1126.4 is insufficient to overcome the pressure differential across piston 1160, and further insufficient to overcome the spring force provided by spring 1170.

The right side of FIG. 21 shows a state of shock 1120 in which the pressure differential across piston 1160 is sufficient to compress spring 1170. In this case, hydraulic fluid can flow within regressive flowpath 1135 between the ID of piston 1122 and OD of shaft 1124, into a chamber of member 1150, and out past the outer diameter of piston 1160. As previously described, the travel of piston 1160 is restrained to a maximum when the piston encounters a travel stop. Further, piston 1160 is guided by the outer diameter by a bushing. As shown in FIG. 21, this bushing is integral with member 1150. It is also appreciated that the flowpath 1135 can further be defined in part or in whole by a third separable member that has a portion that fits in between piston 1122 and rod 1124.

FIGS. 22a and 22b illustrate a portion of a shock absorber 1220 according to another embodiment of the present invention. Shock absorber 1220 is similar to apparatus 1120, except for the inclusion of apparatus and methods that permit adjustability of the regressive damping force function.

Referring to FIG. 22a, rod 1224 includes within it one or more adjustment rods 1224.6. On one end of the assembly of adjustment rods is an adjustment screw 1224.5 that threadably couples to a bore of rod 1224. On the other end of the rod assembly is a spring 1270. In one embodiment, spring 1270 is captured in compression between an internal end of the rod and a cross pin 1260c.

It is understood that spring 1270 (or any of the other springs shown herein) are adapted and configured to exert a preload spring force when the regressive piston is fully seated and closed. In some embodiments this preload establishes a pressure or force at which the piston begins to open a regressive flowpath. Once the flowpath is open the shape of the regressive force curve depends upon interaction between the piston and the lip of the seating counterbore, the size of the ports within the regressive flowpath, and the spring rate, as examples.

The ends of the cross pin 1260c extend through respective slots 1224.8 on opposite sides of the outer diameter of rod 1224. The cross pin 1260c is thus movable vertically (with reference to the orientation of FIG. 22a) in the slots 1224.5. Spring 1270 biases the cross pin 1260c toward the upper surface of the slot. The downward travel of the cross pin 1260c is constrained by the bottom surface of the slot.

The edges of the cross pin 1260 are located within a slotted bore of a collar 1260b. The collar 1260b includes an upward-facings surface that presses against an inner annulus of piston 1260. Similar to the arrangement of apparatus 1120, piston 1260 is biased to a position that normally closes a regressive flowpath 1235 that is in parallel with a compression flowpath 1228.1 (not shown) of piston 1222.

FIG. 22b shows the apparatus of FIG. 22a in operation. On the left side of FIG. 22b, piston 1260 is shown biased to a closed position. Pressure differential across piston 1260 is insufficient to overcome the force exerted by spring 1270 through the cross pin 1260c and collar 1260b against piston 1260. The right side of FIG. 22b shows an opened state of apparatus 1220 in which there is a higher pressure differential across piston 1260a. The pressure differential acting upon piston 1260 forces downward the combination of piston 1260, the collar 1260b, and the cross pin. The cross pin 1260c moves downward within the slots 1224.8 of shaft 1224. This downward movement continues until either there is a force balance between the spring and the pressure differential across piston 1260, or until the cross pin 1260c bottoms out in the slot of the rod 1224.

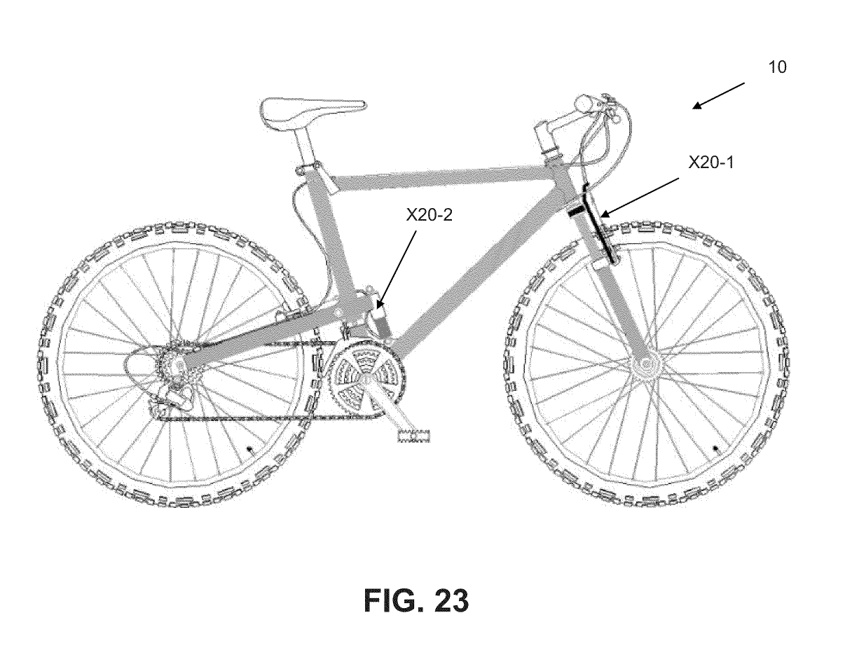

FIG. 23 shows another embodiment of the present invention. Bicycle 10 includes one or more shock absorbers as described herein to provide a regressive damping function. A first shock absorber X20-1 provides damping between the motion of the front wheel and the frame. A second shock absorber X20-2 provides damping between portions of the frame that engage in relative movement. Each shock X20 corresponds to any of the inventive shock absorbers shown herein.

Shock absorbers X20 can provide regressive damping in compression, rebound, or both directions. Further, shocks X20-1 and X20-2 can be of different configurations. For example, in one embodiment front shock X20-1 provides regressive damping in compression only, and includes a different damping function in rebound.

It has been found that the peddling and climbing characteristics of bicycle 10 are improved with the action of at least one regressive damper. The regressive damper reduces the harshness of the ride of the bicycle as it traverses large bumps, rocks, roots, and similar irregularities. Further, it has been found that the low speed characteristics of a rear regressive shock absorber improve the cornering stability of bicycle 10 without the loss of grip that can occur with the use of typical shock absorbers. It is believed that a front mounted regressive shock absorber, especially having regressive characteristics in rebound, could likewise increase the climbing stability and mid-cornering stability of bicycle 10.

Further, although the use of a regressive damper on a mountain or terrain bike is shown and described, various embodiments of the present invention are not limited to such types of bikes. The various dampers disclosed herein are applicable to all types of bicycles, including street bikes, recumbent, and peddled vehicles having more than two wheels.

As one example, regressive dampers can improve the peddling efficiency of a bicycle frame having a non-regressive damper. It has been found that a non-regressive damper having characteristics that accommodate large irregularities in the roadway also result in inefficient conversion of the rider's peddling energy into kinetic energy of the bicycle. Instead, some of the rider's peddling energy is dissipated with low speed damping by the non-regressive damper. In contrast, a regressive damper (such as, for one example, dampers having the characteristics shown in FIG. 12 or 13) can provide increased deficiency over smoother roadways (a result of the tighter damping characteristics at low stroking velocities as shown in FIGS. 12 and 13), yet provide protection to the rider from the jarring effects of large irregularities (as shown in the flatter damping characteristics of FIGS. 12 and 13 after blow-off of the regressive piston).

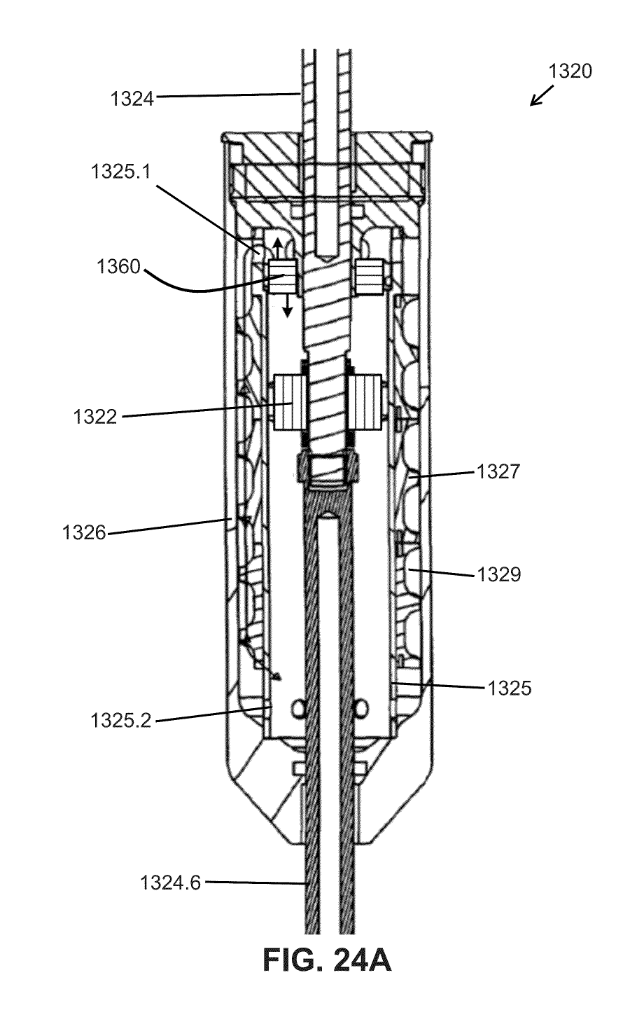

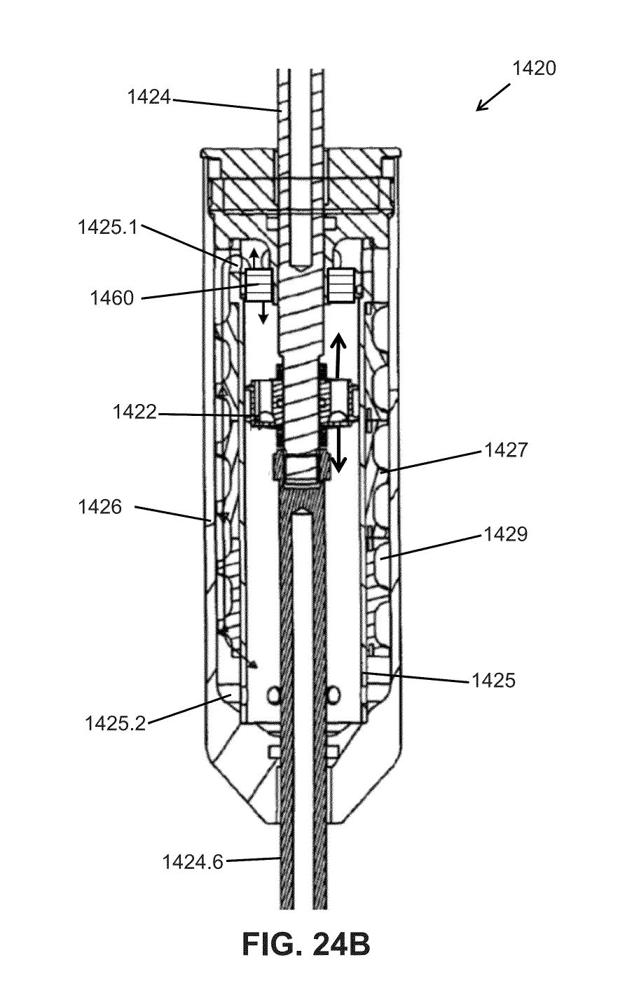

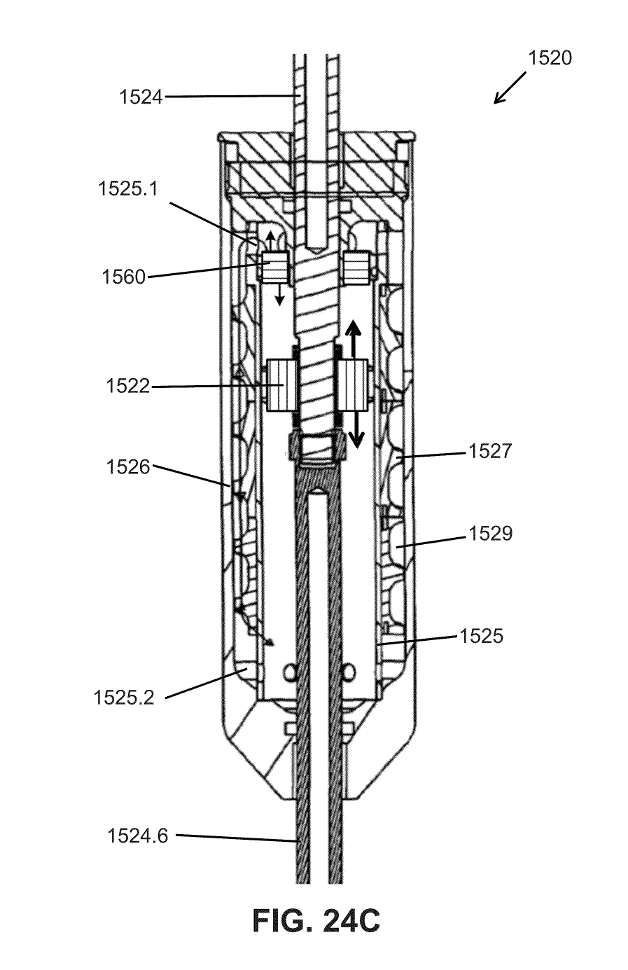

FIGS. 24-27 show and describe dampers that include a combination of inertance and regressive force characteristics, and in some embodiments, further include additional viscous damping force characteristics. A more complete discussion of inertance force characteristics can be found in PCT application PCT/GB2011/000160, filed 7 Feb. 2011, and titled DAMPING AND INERTIAL HYDRAULIC DEVICE, the complete disclosure of which is incorporated herein by reference. Some of the text that follows is from that document.

Various dampers shown herein include one or more flowpaths that are adapted and configured to provide a resistance to flow proportional to the pressure drop or force required to overcome the inertia of accelerating the hydraulic fluid through the flowpath. This inertial flowpath is adapted and configured to have substantially less pressure drop due to viscous effects (i.e., proportional to velocity).

As one example of a damper including an inertial flowpath, consider a force-controlling hydraulic device that includes a cylinder for containing a liquid, the cylinder being attached to one terminal; and a piston attached to another terminal and movable within the cylinder such that the movement of the piston causes the liquid flow along a flowpath, such as a helical path. The moving liquid acts as storage for kinetic energy and generates an inertial force due to the mass of the liquid that controls the mechanical forces at the terminals such that they are substantially proportional to the relative acceleration between the terminals.

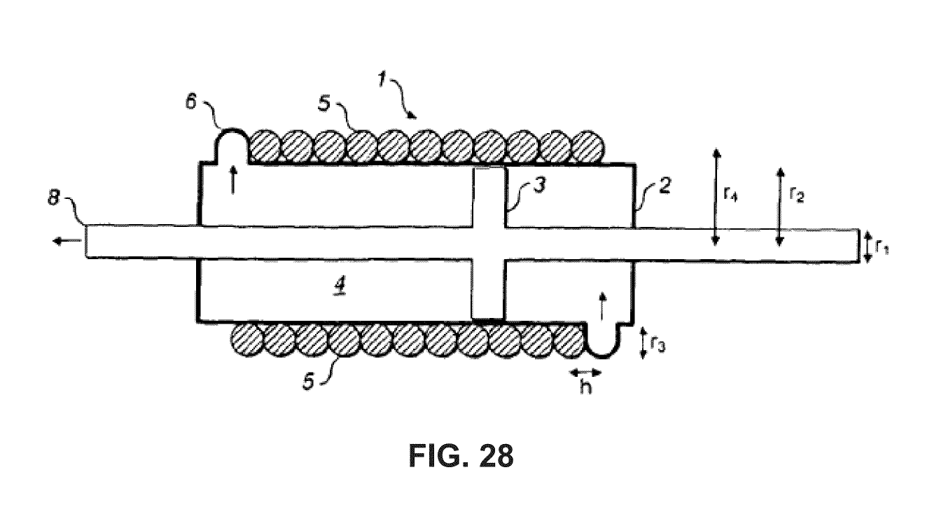

FIG. 28 illustrates an example of a force-controlling hydraulic device 1. The element numbers used in FIG. 28 are not part of the element numbering scheme used in the other figures. The device 1 comprises hydraulic means including independently movable terminals, which in this example, may be respectively included in a cylinder 2 and a piston 3 movable within the cylinder. A liquid 4 is contained within the cylinder 2. The device further comprises a helical tube 5 located outside the cylinder 2 creating a sealed path for the liquid to flow out and back into the cylinder 2 via two orifices (6, 7). The hydraulic means are configured to produce, upon relative movement of its terminals a liquid flow.

Movement of the piston 3 causes liquid 4 to flow through helical tube 5 which generates an inertial force due to the moving mass of the liquid 4. The cylinder 2 may include one terminal, and the piston 3 may include another terminal. As will be explained below, the inertial force due to a moving mass of liquid caused by relative movement between the terminals controls the mechanical forces at the terminals such that they are substantially proportional to the relative acceleration between the terminals. The motion of the piston 3 may be restricted by devices such as spring buffers (not shown). Such means may provide a useful safety feature to protect the device if large forces or velocities were generated at the limits of travel of the piston.

The device of FIG. 28 is implemented using a through-rod 8. Alternatives using a single rod with a floating piston or a double tube or other similar arrangements are equally feasible. It will be appreciated that alternative configurations for the hydraulic means are equally feasible with more specific embodiments being described below. Means to pressurize the fluid (not shown) are envisaged.

In the example shown in FIG. 28, the characteristic parameters of device 1, namely the constant of proportionality with which the applied force at the terminals is related to the relative acceleration between the terminals, can be varied by altering values such as the radii of the piston, cylinder, and helical tube, the length of the cylinder, and liquid density. The effect of such parameters will be detailed below.

Consider the arrangement shown in FIG. 28, where n is the radius of the piston, r₂ is the inner radius of the cylinder, r₃ is the inner radius of the helical tube, r₄ is the radius of the helix, h is the pitch of the helix, n is the number of turns in the helix, L is the inner length of the cylinder, and p is the liquid density. Further,
A₁=π(r₂²−r₁²) is the cross-sectional area of the cylinder, and
A₂=πr₃² is the cross-sectional area of the tube.
   The total mass of liquid in the helical tube is approximately equal to:

ρnπr₃²\sqrt{h²+(2πr₄)²}=:mₕₑₗ (1)

The total mass of liquid in the cylinder is approximately equal to:

ρπ(r₂²−r₁²)L=:m_{cyl} (2)

If the piston is subject to a linear displacement equal to x, then a fluid element in the helical tube may expect an angular displacement Θ rads) approximately equal to:

$$\frac{2 π x ( {r}_{2}^{2} - {r}_{1}^{2} )}{r {3}^{2} \sqrt{{h}^{2} + {( 2 π {r}_{4} )}^{2}}} \qquad ( 3 )$$

The moment of inertia of the total liquid mass in the helical tube about the axis of the piston is approximately equal to mₕₑₗr₄²=:J. Now suppose that device 1 has an ideal behavior with b representing the proportionality constant wherein the generated inertial force between the terminals is proportional to the relative acceleration between the terminals. Then we would expect:

½b\dot{x}²=½J\dot{θ}² (4)

which gives

$$b = \frac{{m}_{hel}}{1 + {( h / ( 2 π {r}_{4} ) )}^{2}} \frac{{( {r}_{2}^{2} - {r}_{1}^{2} )}^{2}}{{r}_{3}^{4}} = \frac{{m}_{hel}}{1 + {( h / ( 2 π {r}_{4} ) )}^{2}} {( \frac{{A}_{1}}{{A}_{2}} )}^{2} \qquad ( 5 )$$

Let mₜₒₜ=mₕₑₗ+m_{cyl} for the total liquid mass. Exemplary values are tabulated and presented in PCT/GB2011/000160 (previously incorporated by reference) for two different liquids used in the embodiment shown in FIG. 28. In the examples presented in PCT/GB2011/000160, we assume r₄=r₂+r₃, h=2r₃ and L=nh. We also take the outside diameter (OD) of the device equal to 2(r₄+r₃).

Various embodiments of the present invention further include viscously restrictive flowpaths for hydraulic fluid, such flowpaths often having pressure drops associated with the velocity of the fluid. The following discusses the effects of such viscous damping. Let u be the mean velocity of fluid in the helical tube, Δπ the pressure drop across the piston, μ the liquid viscosity, and l the length of the helical tube, where

l=n\sqrt{h²+(2πr₄)²} (6)

We will now calculate the pressure drop Δp across the main piston required to maintain a flow in the tube of mean velocity u. This will allow the steady force required to maintain a piston relative velocity z to be calculated, and hence a damping coefficient. Given A₁\dot{x}=A₂u, the Reynolds Number (Re) for the tube is equal to

$$( Re ) = \frac{2 ρ {r}_{3}}{μ } u = \frac{2 ρ {r}_{3} {A}_{l}}{μ {A}_{2}} \dot{x} \qquad ( 7 )$$

with transition from laminar to turbulent flow occurring around (Re)=2×10³. Assuming that u is small enough so that laminar flow holds, and using the Hagen-Poiseuille formula for a straight tube gives:

$$u = \frac{{r}_{3}^{2}}{8 μ} \frac{Δ ρ}{l} \qquad ( 8 )$$

The force on the piston required to maintain a steady relative velocity \dot{x} is equal to ΔρAₗ. This suggests a linear damping rate coefficient equal to:

$$c = \frac{Δ ρ {A}_{l}}{\dot{x}} = \frac{Δ ρ {A}_{l}^{2}}{{A}_{2} u} = {( \frac{{A}_{1}}{{A}_{2}} )}^{2} 8 π μ l . \qquad ( 9 )$$

The pressure drop needed to maintain a turbulent flow, according to Darcy's formula is:

$$Δ ρ = \frac{1}{{r}_{3}} f ρ {u}^{2} , \qquad ( 10 )$$

where f is a dimensionless friction factor. For a smooth pipe the empirical formula of Blasius is:

f=0.079(re)^{-1/4} (11)

This gives the following expression for the constant force on the piston required to maintain a steady velocity:

$$\begin{matrix}F = Δ ρ {A}_{1} \\ = 0.0664 {μ}^{0.25} {ρ}^{0.75} \frac{l {A}_{1}}{{( {r}_{3} )}^{1.25}} {u}^{1.75} \\ = 0.664 {μ}^{0.25} {ρ}^{0.75} \frac{l {A}_{1}}{{r}_{3}^{1.25}} {( \frac{{A}_{1}}{{A}_{2}} )}^{1.75} {( \dot{x} )}^{1.75} \text{=:} {{c}_{1} ( \dot{x} )}^{1.75}\end{matrix} \qquad ( 12 )$$

Let the fluid be water with ρ=100 kg m⁻³, μ=10⁻³ Pa s. Take l=7 m, r₁=8 mm, r₂=20 mm, r₃=4 mm, L=300 mm. This results in a device with:
mₕₑₗ=0.352 kg,
m_{cyl}=0.317 kg, and
b=155 kg.
   The transition to turbulent flow occurs in this example at a piston velocity of \dot{x}=0.0119 m s⁻¹ and at velocities consistent with laminar flow, the damper rate is c=77.6 N s m⁻¹.

FIG. 24A shows a hydraulic damper 1320 that provides an inertial force response that is modified to have regressive characteristics. Therefore, at lower stroking velocities, damper 1320 will move hydraulic fluid in a long tortuous path, such that the effort required to change the inertia of the damping fluid is a significant portion of the reactive loads provided by the damper against the attachment points of the damper within the vehicle suspension system. However, at higher stroking velocities the magnitude of this inertial component is reduced by the action of a regressive valve assembly as previously discussed herein.

FIG. 24A is a cross sectional representation of a damper for a vehicle according to one embodiment of the present invention. Damper 1320 includes a piston 1322 coupled to a rod 1324 that extends from one end of the damper. Rod 1324 includes an extension 1324.6 that extends from the opposite end of the damper and compensates for the change in fluid volume on opposite sides of piston 1322 without the need for a nitrogen-filled accumulator.

Piston 1322 includes a sliding seal on its diameter that divides the interior of an inner piston sleeve 1325. Sliding piston 1322 (represented schematically by vertical cross sectional lines) is preferably a solid piston without any interior flowpath, such that movement of piston 1322 within cylinder 1325 results in displacement of hydraulic fluid in a single direction (i.e., the direction of movement).

As piston 1322 moves within cylinder 1325 hydraulic fluid displaced from cylinder 1325 is provided through a plurality of orifices 1325.2 into a tortuous flowpath 1329, through which it flows to another set of orifices 1325.1 at the other end of damper 1320. Fluid path 1329 is formed between an outermost cylindrical body 1326 and a sleeve 1327. Preferably, sleeve 1327 includes a helical pathway that wraps around the inner diameter of cylinder 1326, and extends generally from one end of damper 1320 to the other end of damper 1320. However, it is appreciated that a helical flowpath is provided as an example, and various embodiments of the present invention include other tortuous flowpaths, especially those flowpaths adapted and configured to provide a fluid path in which viscous flow losses are of lesser importance than inertial effects as the fluid is transferred.

As can be seen toward the top end of damper 1320, a flow valve 1360 (represented by a series of horizontal cross sectional lines) is provided in the flowpath between the helical chamber 1329 and the chamber defined within inner sleeve 1325 between piston 1322 and valve 1360. Valve 1360 provides a regressive nature to the overall forcing characteristic provided by damper 1320. Valve 1360 provides a first hydraulic flowpath and flow characteristic within a first, lower range of pressure difference across valve 1360, and a second flow characteristic at a higher pressure drop across valve 1360. The low delta-p flow characteristics are generally more restrictive than the higher delta-p flow characteristics, as described previously herein. It is appreciated that valve 1360 can be any of the various configurations shown herein that provide regressive flow characteristics.

FIG. 24B shows a hydraulic damper 1420 that provides an inertial force response that is modified to have regressive characteristics. Therefore, at lower stroking velocities, damper 1420 will move hydraulic fluid in a long tortuous path, such that the effort required to change the inertia of the damping fluid is a significant portion of the reactive loads provided by the damper against the attachment points of the damper within the vehicle suspension system. However, at higher stroking velocities the magnitude of this inertial component is reduced by the action of a regressive valve assembly as previously discussed herein.

FIG. 24B is a cross sectional representation of a damper for a vehicle according to one embodiment of the present invention. Damper 1420 includes a piston 1422 coupled to a rod 1424 that extends from one end of the damper. Rod 1424 includes an extension 1424.6 that extends from the opposite end of the damper and compensates for the change in fluid volume on opposite sides of piston 1422 without the need for a nitrogen-filled accumulator.

Piston 1422 includes a sliding seal on its diameter that divides the interior of an inner piston sleeve 1425. Sliding piston 1422 (represented schematically by vertical cross sectional lines) includes one or more interior flowpaths, such that as piston 1422 moves within cylinder 1425, the higher pressure hydraulic fluid in contact with a face of the piston can move either through the piston internal flowpath, or back through the regressive and inertia flowpaths. The flow valve within piston 1422 can be of any type, including one or more shims that bend and allow flow as result of the bending, check valves, or any other type of valving, especially those providing viscous force characteristics. It is further understood that the internal flowpath within the sliding piston can be unidirectional or bidirectional.

As piston 1422 moves within cylinder 1425 hydraulic fluid displaced from cylinder 1425 is provided through a plurality of orifices 1425.2 into a tortuous flowpath 1429, through which it flows to another set of orifices 1425.1 at the other end of damper 1420. Fluid path 1429 is formed between an outermost cylindrical body 1426 and a sleeve 1427. Preferably, sleeve 1427 includes a helical pathway that wraps around the inner diameter of cylinder 1426, and extends generally from one end of damper 1420 to the other end of damper 1420. However, it is appreciated that a helical flowpath is provided as an example, and various embodiments of the present invention include other tortuous flowpaths, especially those flowpaths adapted and configured to provide a fluid path in which viscous flow losses are of lesser importance than inertial effects as the fluid is transferred.

As can be seen toward the top end of damper 1420, a flow valve 1460 (represented by a series of horizontal cross sectional lines) is provided in the flowpath between the helical chamber 1429 and the chamber defined within inner sleeve 1425 between piston 1422 and valve 1460. Valve 1460 provides a regressive nature to the overall forcing characteristic provided by damper 1420. Valve 1460 provides a first hydraulic flowpath and flow characteristic within a first, lower range of pressure difference across valve 1460, and a second flow characteristic at a higher pressure drop across valve 1460. The low delta-p flow characteristics are generally more restrictive than the higher delta-p flow characteristics, as described previously herein. It is appreciated that valve 1460 can be any of the various configurations shown herein that provide regressive flow characteristics.

FIG. 24C shows a hydraulic damper 1520 that provides an inertial force response that is modified to have regressive characteristics. Therefore, at lower stroking velocities, damper 1520 will move hydraulic fluid in a long tortuous path, such that the effort required to change the inertia of the damping fluid is a significant portion of the reactive loads provided by the damper against the attachment points of the damper within the vehicle suspension system. However, at higher stroking velocities the magnitude of this inertial component is reduced by the action of a regressive valve assembly as previously discussed herein.

FIG. 24C is a cross sectional representation of a damper for a vehicle according to one embodiment of the present invention. Damper 1520 includes a piston 1522 coupled to a rod 1524 that extends from one end of the damper. Rod 1524 includes an extension 1524.6 that extends from the opposite end of the damper and compensates for the change in fluid volume on opposite sides of piston 1522 without the need for a nitrogen-filled accumulator.

Piston 1522 includes a sliding seal on its diameter that divides the interior of an inner piston sleeve 1525. Sliding piston 1522 (represented schematically by vertical cross sectional lines) preferably includes an internal flowpath having a regressive flow characteristic. This internal flowpath can be accomplished with any of the regressive valve designs shown herein as examples. Various embodiments contemplate regressive characteristics in which the transition from the more restrictive, low delta-p flowpath to the less restrictive, high delta-p flowpath can be established in any range of stroking velocities as compared to the regressive transitional portion of valve 1560. For example, the regressive characteristics of sliding piston 1522 can transition at a lower range of stroking velocities than valve 1560, at about the same stroking velocities as valve 1560, or at higher stroking velocities than valve 1560. Further, the present invention contemplates those embodiments in which the structure of the regressive internal flowpath of piston 1522 is different than the structure of valve 1560, and further those embodiments in which the structures are generally the same. For example, one of the regressive valves within piston 1522 or valve assembly 1560 can be unidirectional, and the other can be bidirectional.

As piston 1522 moves within cylinder 1525 hydraulic fluid displaced from cylinder 1525 is provided through a plurality of orifices 1525.2 into a tortuous flowpath 1529, through which it flows to another set of orifices 1525.1 at the other end of damper 1520. Fluid path 1529 is formed between an outermost cylindrical body 1526 and a sleeve 1527. Preferably, sleeve 1527 includes a helical pathway that wraps around the inner diameter of cylinder 1526, and extends generally from one end of damper 1520 to the other end of damper 1520. However, it is appreciated that a helical flowpath is provided as an example, and various embodiments of the present invention include other tortuous flowpaths, especially those flowpaths adapted and configured to provide a fluid path in which viscous flow losses are of lesser importance than inertial effects as the fluid is transferred.

As can be seen toward the top end of damper 1520, a flow valve 1560 (represented by a series of horizontal cross sectional lines) is provided in the flowpath between the helical chamber 1529 and the chamber defined within inner sleeve 1525 between piston 1522 and valve 1560. Valve 1560 provides a regressive nature to the overall forcing characteristic provided by damper 1520. Valve 1560 provides a first hydraulic flowpath and flow characteristic within a first, lower range of pressure difference across valve 1560, and a second flow characteristic at a higher pressure drop across valve 1560. The low delta-p flow characteristics are generally more restrictive than the higher delta-p flow characteristics, as described previously herein. It is appreciated that valve 1560 can be any of the various configurations shown herein that provide regressive flow characteristics.

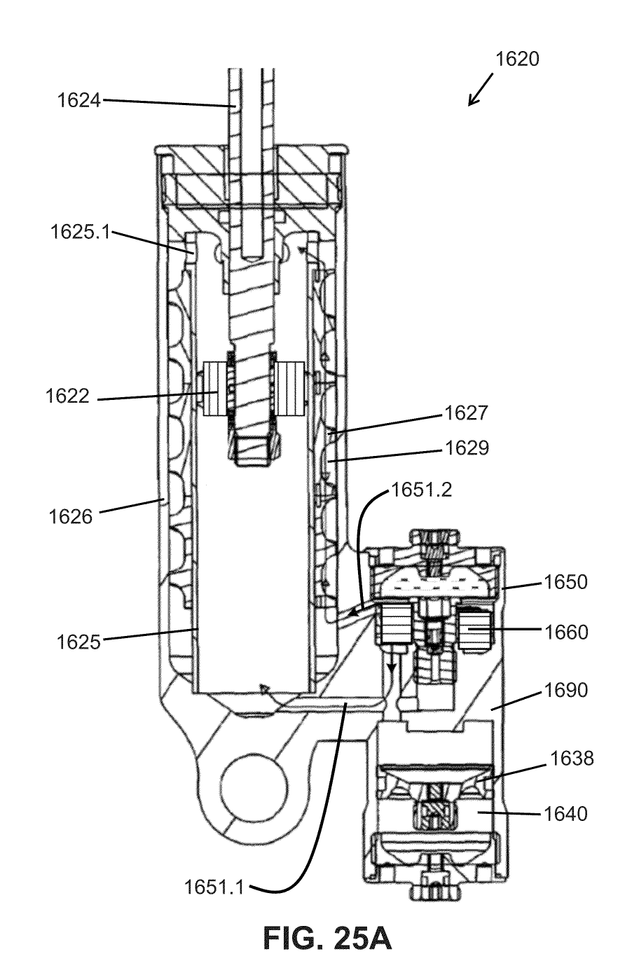

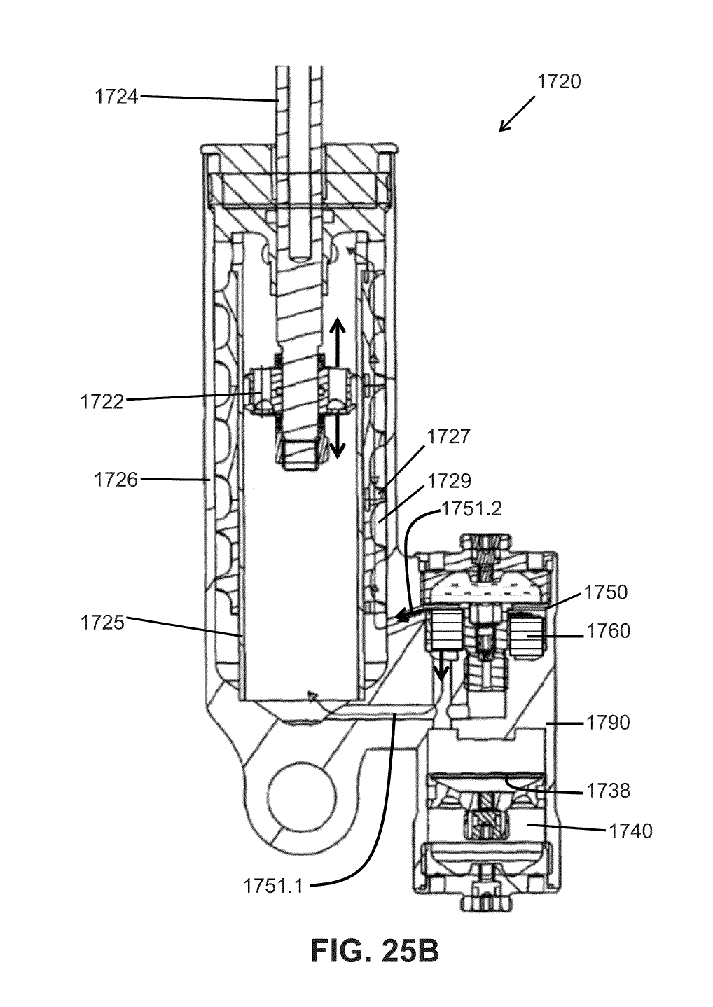

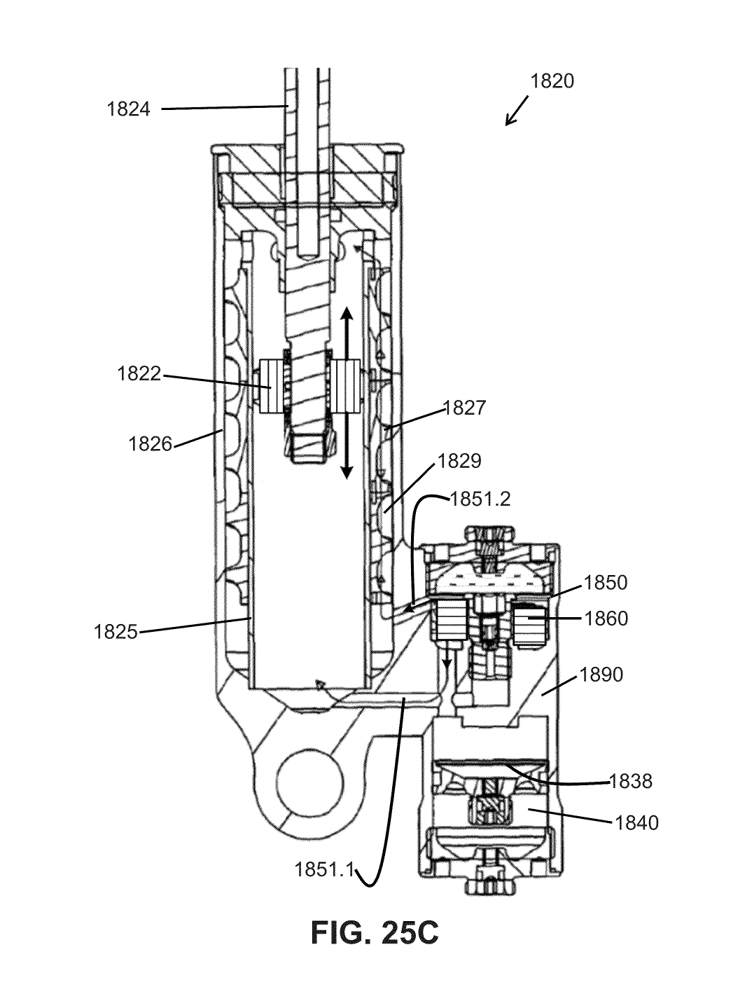

FIG. 25A shows a hydraulic damper 1620 that provides an inertial force response that is modified to have regressive characteristics. Therefore, at lower stroking velocities, damper 1620 will move hydraulic fluid in a long tortuous path, such that the effort required to change the inertia of the damping fluid is a significant portion of the reactive loads provided by the damper against the attachment points of the damper within the vehicle suspension system. However, at higher stroking velocities the magnitude of this inertial component is reduced by the action of a regressive valve assembly as previously discussed herein.

FIG. 25A is a cross sectional representation of a damper for a vehicle according to one embodiment of the present invention. Damper 1620 includes a piston 1622 coupled to a rod 1624 that extends from one end of the damper.

Piston 1622 includes a sliding seal on its diameter that divides the interior of an inner piston sleeve 1625 into compartments. Sliding piston 1622 (represented schematically by vertical cross sectional lines) is preferably a solid piston without any interior flowpath, such that movement of piston 1622 within cylinder 1625 results in displacement of hydraulic fluid in a single direction (i.e., the direction of movement).

As piston 1622 moves within cylinder 1625 hydraulic fluid displaced from cylinder 1625 is provided through a plurality of orifices 1625.2 into a tortuous flowpath 1629, through which it flows to another set of orifices 1651.2. Fluid path 1629 is formed between an outermost cylindrical body 1626 and a sleeve 1627. Preferably, sleeve 1627 includes a helical pathway that wraps around the inner diameter of cylinder 1626, and extends generally from one end of damper 1620 to the other end of damper 1620. However, it is appreciated that a helical flowpath is provided as an example, and various embodiments of the present invention include other tortuous flowpaths, especially those flowpaths adapted and configured to provide a fluid path in which viscous flow losses are of lesser importance than inertial effects as the fluid is transferred.

Damper 1620 includes a pair of internal fluid pathways 1651.1 and 1651.2 that provide damper hydraulic fluid into a flow valve 1660 having regressive flow characteristics. Fluid pathway 1651.2 provides hydraulic fluid between helical flowpath 1629 and a fluid port of valve 1660. Fluid pathway 1651.1 provides hydraulic fluid between an internal chamber of cylinder 1625 and the other port of valve 1660. Valve 1660 is contained within an external housing 1650. Housing 1650 further includes an accumulator that includes a piston 1638 that separates a reservoir of hydraulic fluid from a nitrogen chamber 1640.

Flow valve 1660 (represented by a series of horizontal cross sectional lines) is provided in the flowpath between the helical chamber 1629 and the chamber defined within inner sleeve 1625 between piston 1622 and valve 1660. Valve 1660 provides a regressive nature to the overall forcing characteristic provided by damper 1620. Valve 1660 provides a first hydraulic flowpath and flow characteristic within a first, lower range of pressure difference across valve 1660, and a second flow characteristic at a higher pressure drop across valve 1660. The low delta-p flow characteristics are generally more restrictive than the higher delta-p flow characteristics, as described previously herein. It is appreciated that valve 1660 can be any of the various configurations shown herein that provide regressive flow characteristics.

FIG. 25B shows a hydraulic damper 1720 that provides an inertial force response that is modified to have regressive characteristics. Therefore, at lower stroking velocities, damper 1720 will move hydraulic fluid in a long tortuous path, such that the effort required to change the inertia of the damping fluid is a significant portion of the reactive loads provided by the damper against the attachment points of the damper within the vehicle suspension system. However, at higher stroking velocities the magnitude of this inertial component is reduced by the action of a regressive valve assembly as previously discussed herein.

FIG. 25B is a cross sectional representation of a damper for a vehicle according to one embodiment of the present invention. Damper 1720 includes a piston 1722 coupled to a rod 1724 that extends from one end of the damper.

Piston 1722 includes a sliding seal on its diameter that divides the interior of an inner piston sleeve 1725. Sliding piston 1722 (represented schematically by vertical cross sectional lines) includes one or more interior flowpaths, such that as piston 1722 moves within cylinder 1725, the higher pressure hydraulic fluid in contact with a face of the piston can move either through the piston internal flowpath, or back through the regressive and inertia flowpaths. The flow valve within piston 1722 can be of any type, including one or more shims that bend and allow flow as result of the bending, check valves, or any other type of valving, especially those providing viscous force characteristics. It is further understood that the internal flowpath within the sliding piston can be unidirectional or bidirectional.

As piston 1722 moves within cylinder 1725 hydraulic fluid displaced from cylinder 1725 is provided through a plurality of orifices 1725.2 into a tortuous flowpath 1729, through which it flows to another set of orifices 1725.1 at the other end of damper 1720. Fluid path 1729 is formed between an outermost cylindrical body 1726 and a sleeve 1727. Preferably, sleeve 1727 includes a helical pathway that wraps around the inner diameter of cylinder 1726, and extends generally from one end of damper 1720 to the other end of damper 1720. However, it is appreciated that a helical flowpath is provided as an example, and various embodiments of the present invention include other tortuous flowpaths, especially those flowpaths adapted and configured to provide a fluid path in which viscous flow losses are of lesser importance than inertial effects as the fluid is transferred.

Damper 1720 includes a pair of internal fluid pathways 1751.1 and 1751.2 that provide damper hydraulic fluid into a flow valve 1760 having regressive flow characteristics. Fluid pathway 1751.2 provides hydraulic fluid between helical flowpath 1729 and a fluid port of valve 1760. Fluid pathway 1751.1 provides hydraulic fluid between an internal chamber of cylinder 1725 and the other port of valve 1760. Valve 1760 is contained within an external housing 1750. Housing 1750 further includes an accumulator that includes a piston 1738 that separates a reservoir of hydraulic fluid from a nitrogen chamber 1740.

Flow valve 1760 (represented by a series of horizontal cross sectional lines) is provided in the flowpath between the helical chamber 1729 and the chamber defined within inner sleeve 1725 between piston 1722 and valve 1760. Valve 1760 provides a regressive nature to the overall forcing characteristic provided by damper 1720. Valve 1760 provides a first hydraulic flowpath and flow characteristic within a first, lower range of pressure difference across valve 1760, and a second flow characteristic at a higher pressure drop across valve 1760. The low delta-p flow characteristics are generally more restrictive than the higher delta-p flow characteristics, as described previously herein. It is appreciated that valve 1760 can be any of the various configurations shown herein that provide regressive flow characteristics.

FIG. 25C shows a hydraulic damper 1820 that provides an inertial force response that is modified to have regressive characteristics. Therefore, at lower stroking velocities, damper 1820 will move hydraulic fluid in a long tortuous path, such that the effort required to change the inertia of the damping fluid is a significant portion of the reactive loads provided by the damper against the attachment points of the damper within the vehicle suspension system. However, at higher stroking velocities the magnitude of this inertial component is reduced by the action of a regressive valve assembly as previously discussed herein.

FIG. 25C is a cross sectional representation of a damper for a vehicle according to one embodiment of the present invention. Damper 1820 includes a piston 1822 coupled to a rod 1824 that extends from one end of the damper.

Piston 1822 includes a sliding seal on its diameter that divides the interior of an inner piston sleeve 1825. Sliding piston 1822 (represented schematically by vertical cross sectional lines) preferably includes an internal flowpath having a regressive flow characteristic. This internal flowpath can be accomplished with any of the regressive valve designs shown herein as examples. Various embodiments contemplate regressive characteristics in which the transition from the more restrictive, low delta-p flowpath to the less restrictive, high delta-p flowpath can be established in any range of stroking velocities as compared to the regressive transitional portion of valve 1860. For example, the regressive characteristics of sliding piston 1822 can transition at a lower range of stroking velocities than valve 1860, at about the same stroking velocities as valve 1860, or at higher stroking velocities than valve 1860. Further, the present invention contemplates those embodiments in which the structure of the regressive internal flowpath of piston 1822 is different than the structure of valve 1860, and further those embodiments in which the structures are generally the same. For example, one of the regressive valves within piston 1822 or valve assembly 1860 can be unidirectional, and the other can be bidirectional.

As piston 1822 moves within cylinder 1825 hydraulic fluid displaced from cylinder 1825 is provided through a plurality of orifices 1825.2 into a tortuous flowpath 1829, through which it flows to another set of orifices 1825.1 at the other end of damper 1820. Fluid path 1829 is formed between an outermost cylindrical body 1826 and a sleeve 1827. Preferably, sleeve 1827 includes a helical pathway that wraps around the inner diameter of cylinder 1826, and extends generally from one end of damper 1820 to the other end of damper 1820. However, it is appreciated that a helical flowpath is provided as an example, and various embodiments of the present invention include other tortuous flowpaths, especially those flowpaths adapted and configured to provide a fluid path in which viscous flow losses are of lesser importance than inertial effects as the fluid is transferred.

Damper 1820 includes a pair of internal fluid pathways 1851.1 and 1851.2 that provide damper hydraulic fluid into a flow valve 1860 having regressive flow characteristics. Fluid pathway 1851.2 provides hydraulic fluid between helical flowpath 1829 and a fluid port of valve 1860. Fluid pathway 1851.1 provides hydraulic fluid between an internal chamber of cylinder 1825 and the other port of valve 1860. Valve 1860 is contained within an external housing 1850. Housing 1850 further includes an accumulator that includes a piston 1838 that separates a reservoir of hydraulic fluid from a nitrogen chamber 1840.

Flow valve 1860 (represented by a series of horizontal cross sectional lines) is provided in the flowpath between the helical chamber 1829 and the chamber defined within inner sleeve 1825 between piston 1822 and valve 1860. Valve 1860 provides a regressive nature to the overall forcing characteristic provided by damper 1820. Valve 1860 provides a first hydraulic flowpath and flow characteristic within a first, lower range of pressure difference across valve 1860, and a second flow characteristic at a higher pressure drop across valve 1860. The low delta-p flow characteristics are generally more restrictive than the higher delta-p flow characteristics, as described previously herein. It is appreciated that valve 1860 can be any of the various configurations shown herein that provide regressive flow characteristics.

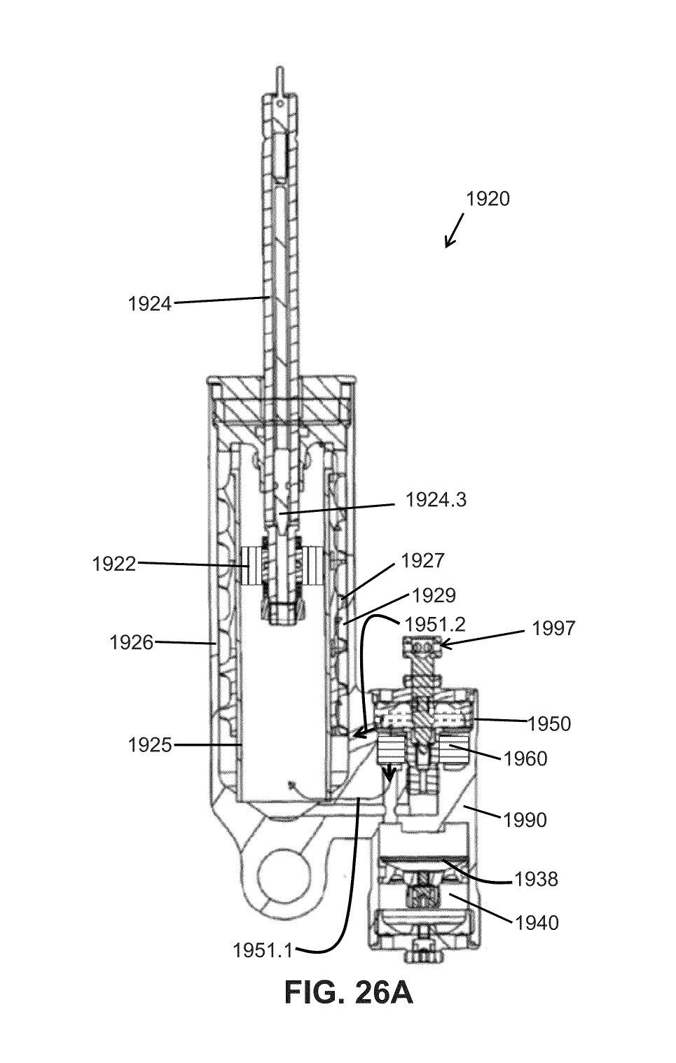

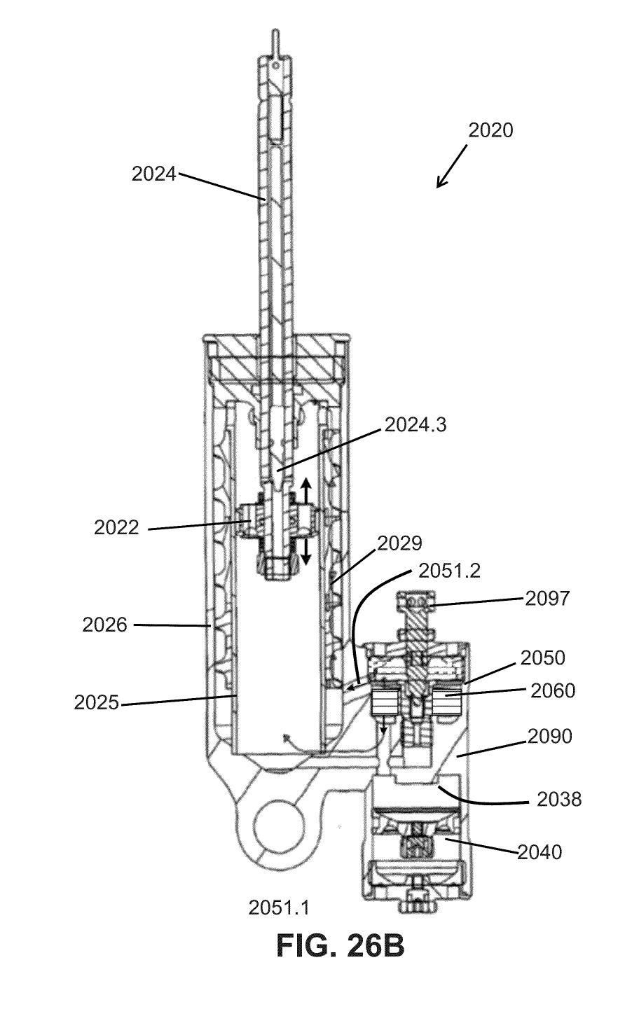

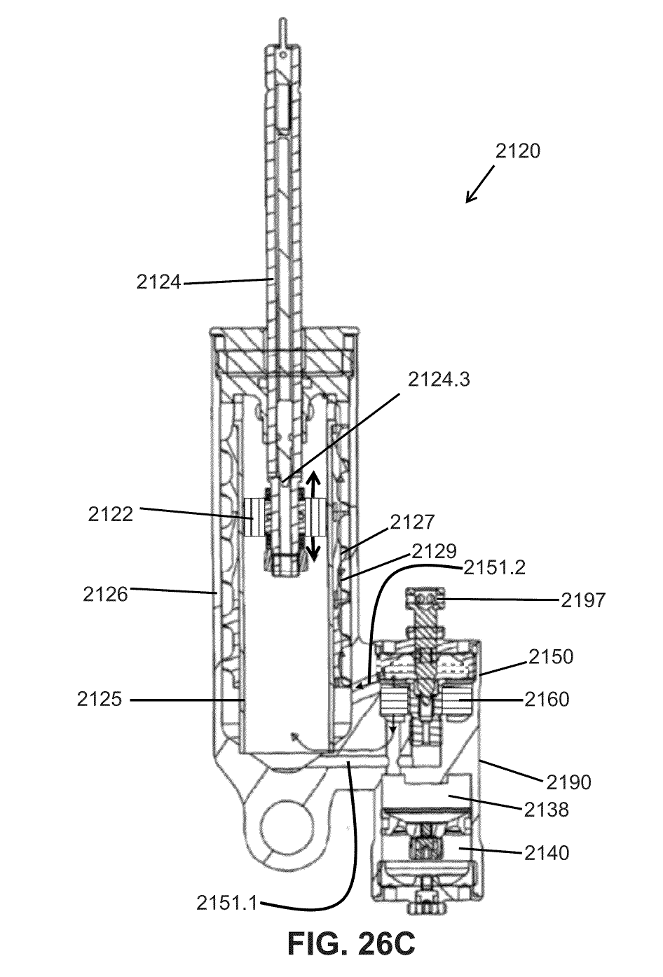

FIG. 26A shows a hydraulic damper 1920 that provides an inertial force response that is modified to have regressive characteristics. Therefore, at lower stroking velocities, damper 1920 will move hydraulic fluid in a long tortuous path, such that the effort required to change the inertia of the damping fluid is a significant portion of the reactive loads provided by the damper against the attachment points of the damper within the vehicle suspension system. However, at higher stroking velocities the magnitude of this inertial component is reduced by the action of a regressive valve assembly as previously discussed herein.

FIG. 26A is a cross sectional representation of a damper for a vehicle according to one embodiment of the present invention. Damper 1920 includes a piston 1922 coupled to a rod 1924 that extends from one end of the damper.

Piston 1922 includes a sliding seal on its diameter that divides the interior of an inner piston sleeve 1925. Sliding piston 1922 (represented schematically by vertical cross sectional lines) is preferably a solid piston without any interior flowpath, such that movement of piston 1922 within cylinder 1925 results in displacement of hydraulic fluid in a single direction (i.e., the direction of movement).

As piston 1922 moves within cylinder 1925 hydraulic fluid displaced from cylinder 1925 is provided through a plurality of orifices 1925.2 into a tortuous flowpath 1929, through which it flows to another set of orifices 1925.1 at the other end of damper 1920. Fluid path 1929 is formed between an outermost cylindrical body 1926 and a sleeve 1927. Preferably, sleeve 1927 includes a helical pathway that wraps around the inner diameter of cylinder 1926, and extends generally from one end of damper 1920 to the other end of damper 1920. However, it is appreciated that a helical flowpath is provided as an example, and various embodiments of the present invention include other tortuous flowpaths, especially those flowpaths adapted and configured to provide a fluid path in which viscous flow losses are of lesser importance than inertial effects as the fluid is transferred.

Damper 1920 includes a pair of internal fluid pathways 1951.1 and 1951.2 that provide damper hydraulic fluid into a flow valve 1960 having regressive flow characteristics. Fluid pathway 1951.2 provides hydraulic fluid between helical flowpath 1929 and a fluid port of valve 1960. Fluid pathway 1951.1 provides hydraulic fluid between an internal chamber of cylinder 1925 and the other port of valve 1960. Valve 1960 is contained within an external housing 1950. Housing 1950 further includes an accumulator that includes a piston 1938 that separates a reservoir of hydraulic fluid from a nitrogen chamber 1940.

Flow valve 1960 (represented by a series of horizontal cross sectional lines) is provided in the flowpath between the helical chamber 1929 and the chamber defined within inner sleeve 1925 between piston 1922 and valve 1960. Valve 1960 provides a regressive nature to the overall forcing characteristic provided by damper 1920. Valve 1960 provides a first hydraulic flowpath and flow characteristic within a first, lower range of pressure difference across valve 1960, and a second flow characteristic at a higher pressure drop across valve 1960. The low delta-p flow characteristics are generally more restrictive than the higher delta-p flow characteristics, as described previously herein. It is appreciated that valve 1960 can be any of the various configurations shown herein that provide regressive flow characteristics.

Damper 1920 includes an external adjustment 1997 that modifies the regressive characteristics of flow valve 1960. In one embodiment, and as shown, external adjustment 1997 varies the viscous loss characteristics of either the low delta-p flow characteristics or the high delta-p flow characteristics. Adjustment 1997 moves a tapered needle within an orifice to provide a flow area based on the position of adjuster 1997. However, in yet other embodiments, adjuster 1997 is used to apply an adjustable load onto one of the spring sets within flow valve 1960, so as to move the transition point from the low delta-p characteristic to the high delta-p flow characteristic.

FIG. 26B shows a hydraulic damper 2020 that provides an inertial force response that is modified to have regressive characteristics. Therefore, at lower stroking velocities, damper 2020 will move hydraulic fluid in a long tortuous path, such that the effort required to change the inertia of the damping fluid is a significant portion of the reactive loads provided by the damper against the attachment points of the damper within the vehicle suspension system. However, at higher stroking velocities the magnitude of this inertial component is reduced by the action of a regressive valve assembly as previously discussed herein.

FIG. 26B is a cross sectional representation of a damper for a vehicle according to one embodiment of the present invention. Damper 2020 includes a piston 2022 coupled to a rod 2024 that extends from one end of the damper.

Piston 2022 includes a sliding seal on its diameter that divides the interior of an inner piston sleeve 2025. Sliding piston 2022 (represented schematically by vertical cross sectional lines) includes one or more interior flowpaths, such that as piston 2022 moves within cylinder 2025, the higher pressure hydraulic fluid in contact with a face of the piston can move either through the piston internal flowpath, or back through the regressive and inertia flowpaths. The flow valve within piston 2022 can be of any type, including one or more shims that bend and allow flow as result of the bending, check valves, or any other type of valving, especially those providing viscous force characteristics. It is further understood that the internal flowpath within the sliding piston can be unidirectional or bidirectional.

As piston 2022 moves within cylinder 2025 hydraulic fluid displaced from cylinder 2025 is provided through a plurality of orifices 2025.2 into a tortuous flowpath 2029, through which it flows to another set of orifices 2025.1 at the other end of damper 2020. Fluid path 2029 is formed between an outermost cylindrical body 2026 and a sleeve 2027. Preferably, sleeve 2027 includes a helical pathway that wraps around the inner diameter of cylinder 2026, and extends generally from one end of damper 2020 to the other end of damper 2020. However, it is appreciated that a helical flowpath is provided as an example, and various embodiments of the present invention include other tortuous flowpaths, especially those flowpaths adapted and configured to provide a fluid path in which viscous flow losses are of lesser importance than inertial effects as the fluid is transferred.

Damper 2020 includes a pair of internal fluid pathways 2051.1 and 2051.2 that provide damper hydraulic fluid into a flow valve 2060 having regressive flow characteristics. Fluid pathway 2051.2 provides hydraulic fluid between helical flowpath 2029 and a fluid port of valve 2060. Fluid pathway 2051.1 provides hydraulic fluid between an internal chamber of cylinder 2025 and the other port of valve 2060. Valve 2060 is contained within an external housing 2050. Housing 2050 further includes an accumulator that includes a piston 2038 that separates a reservoir of hydraulic fluid from a nitrogen chamber 2040.

Flow valve 2060 (represented by a series of horizontal cross sectional lines) is provided in the flowpath between the helical chamber 2029 and the chamber defined within inner sleeve 2025 between piston 2022 and valve 2060. Valve 2060 provides a regressive nature to the overall forcing characteristic provided by damper 2020. Valve 2060 provides a first hydraulic flowpath and flow characteristic within a first, lower range of pressure difference across valve 2060, and a second flow characteristic at a higher pressure drop across valve 2060. The low delta-p flow characteristics are generally more restrictive than the higher delta-p flow characteristics, as described previously herein. It is appreciated that valve 2060 can be any of the various configurations shown herein that provide regressive flow characteristics.

Damper 2020 includes an external adjustment 2097 that modifies the regressive characteristics of flow valve 2060. In one embodiment, and as shown, external adjustment 2097 varies the viscous loss characteristics of either the low delta-p flow characteristics or the high delta-p flow characteristics. Adjustment 2097 moves a tapered needle within an orifice to provide a flow area based on the position of adjuster 2097. However, in yet other embodiments, adjuster 2097 is used to apply an adjustable load onto one of the spring sets within flow valve 2060, so as to move the transition point from the low delta-p characteristic to the high delta-p flow characteristic.

FIG. 26C shows a hydraulic damper 2120 that provides an inertial force response that is modified to have regressive characteristics. Therefore, at lower stroking velocities, damper 2120 will move hydraulic fluid in a long tortuous path, such that the effort required to change the inertia of the damping fluid is a significant portion of the reactive loads provided by the damper against the attachment points of the damper within the vehicle suspension system. However, at higher stroking velocities the magnitude of this inertial component is reduced by the action of a regressive valve assembly as previously discussed herein.

FIG. 26C is a cross sectional representation of a damper for a vehicle according to one embodiment of the present invention. Damper 2120 includes a piston V22 coupled to a rod 2124 that extends from one end of the damper.

Piston 2122 includes a sliding seal on its diameter that divides the interior of an inner piston sleeve 2125. Sliding piston 2122 (represented schematically by vertical cross sectional lines) preferably includes an internal flowpath having a regressive flow characteristic. This internal flowpath can be accomplished with any of the regressive valve designs shown herein as examples. Various embodiments contemplate regressive characteristics in which the transition from the more restrictive, low delta-p flowpath to the less restrictive, high delta-p flowpath can be established in any range of stroking velocities as compared to the regressive transitional portion of valve 2160. For example, the regressive characteristics of sliding piston 2122 can transition at a lower range of stroking velocities than valve 2160, at about the same stroking velocities as valve 2160, or at higher stroking velocities than valve 2160. Further, the present invention contemplates those embodiments in which the structure of the regressive internal flowpath of piston 2122 is different than the structure of valve 2160, and further those embodiments in which the structures are generally the same. For example, one of the regressive valves within piston 2122 or valve assembly 2160 can be unidirectional, and the other can be bidirectional.

As piston 2122 moves within cylinder 2125 hydraulic fluid displaced from cylinder 2125 is provided through a plurality of orifices 2125.2 into a tortuous flowpath 2129, through which it flows to another set of orifices 2125.1 at the other end of damper 2120. Fluid path 2129 is formed between an outermost cylindrical body 2126 and a sleeve 2127. Preferably, sleeve 2127 includes a helical pathway that wraps around the inner diameter of cylinder 2126, and extends generally from one end of damper 2120 to the other end of damper 2120. However, it is appreciated that a helical flowpath is provided as an example, and various embodiments of the present invention include other tortuous flowpaths, especially those flowpaths adapted and configured to provide a fluid path in which viscous flow losses are of lesser importance than inertial effects as the fluid is transferred.

Damper 2120 includes a pair of internal fluid pathways 2151.1 and 2151.2 that provide damper hydraulic fluid into a flow valve 1660 having regressive flow characteristics. Fluid pathway 2151.2 provides hydraulic fluid between helical flowpath 2129 and a fluid port of valve 2160. Fluid pathway 2151.1 provides hydraulic fluid between an internal chamber of cylinder 2125 and the other port of valve 2160. Valve 2160 is contained within an external housing 2150. Housing 2150 further includes an accumulator that includes a piston 2138 that separates a reservoir of hydraulic fluid from a nitrogen chamber 2140.

Flow valve 2160 (represented by a series of horizontal cross sectional lines) is provided in the flowpath between the helical chamber 2129 and the chamber defined within inner sleeve 2125 between piston 2122 and valve 2160. Valve 2160 provides a regressive nature to the overall forcing characteristic provided by damper 2120. Valve 2160 provides a first hydraulic flowpath and flow characteristic within a first, lower range of pressure difference across valve 2160, and a second flow characteristic at a higher pressure drop across valve 2160. The low delta-p flow characteristics are generally more restrictive than the higher delta-p flow characteristics, as described previously herein. It is appreciated that valve 2160 can be any of the various configurations shown herein that provide regressive flow characteristics.

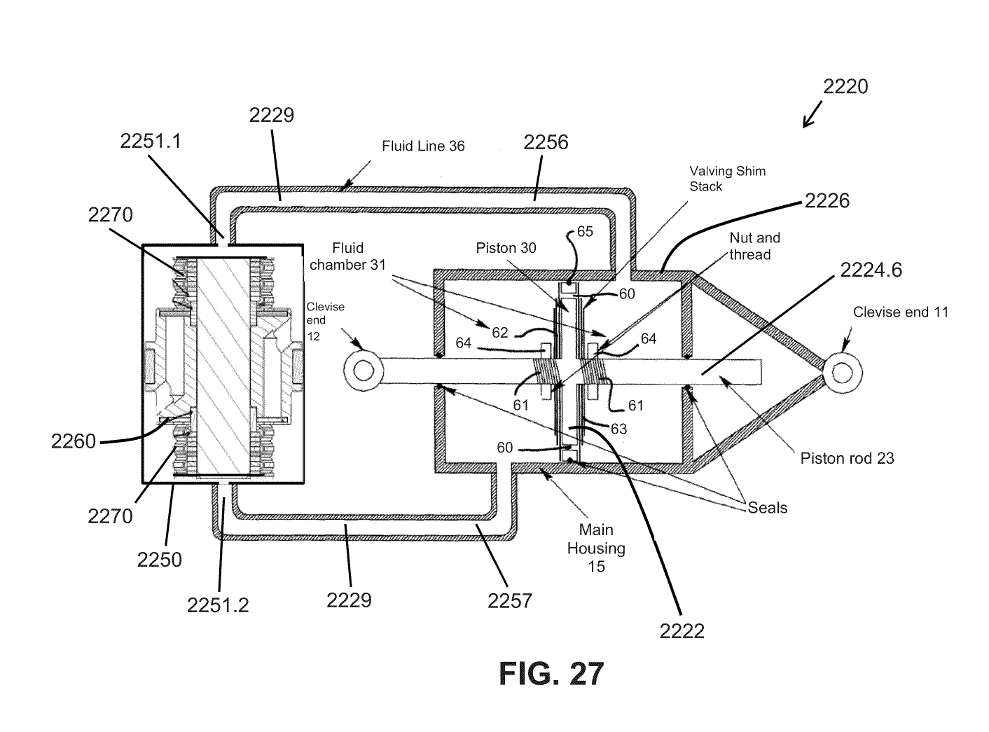

Damper 2120 includes an external adjustment 2197 that modifies the regressive characteristics of flow valve 2160. In one embodiment, and as shown, external adjustment 2197 varies the viscous loss characteristics of either the low delta-p flow characteristics or the high delta-p flow characteristics. Adjustment 2197 moves a tapered needle within an orifice to provide a flow area based on the position of adjuster 2197. However, in yet other embodiments, adjuster 2197 is used to apply an adjustable load onto one of the spring sets within flow valve 2160, so as to move the transition point from the low delta-p characteristic to the high delta-p flow characteristic. FIG. 27 shows a hydraulic damper 2220 that provides an inertial force response that is modified to have regressive characteristics. Therefore, at lower stroking velocities, damper 2220 will move hydraulic fluid in a long tortuous path, such that the effort required to change the inertia of the damping fluid is a significant portion of the reactive loads provided by the damper against the attachment points of the damper within the vehicle suspension system. However, at higher stroking velocities the magnitude of this inertial component is reduced by the action of a regressive valve assembly as previously discussed herein.

FIG. 27 is a cross sectional representation of a damper for a vehicle according to one embodiment of the present invention. Damper 2220 includes a piston 2222 coupled to a rod 2224 that extends from one end of the damper. Rod 2224 includes an extension 2224.6 that extends from the opposite end of the damper and compensates for the change in fluid volume on opposite sides of piston 2222 without the need for a nitrogen-filled accumulator.

Damper 2220 in one embodiment includes a regressive valve 2260 contained within a housing 2250 that is generally external to the main, sliding piston 2222 and corresponding cylinder 2226. Piston 2222 can be of any type as previously described. In one embodiment, piston 2222 includes a sliding seal on its diameter that divides the interior of an inner piston sleeve 2225. Sliding piston 2222 preferably includes an internal flowpath having a regressive flow characteristic. This internal flowpath can be accomplished with any of the regressive valve designs shown herein as examples. Various embodiments contemplate regressive characteristics in which the transition from the more restrictive, low delta-p flowpath to the less restrictive, high delta-p flowpath can be established in any range of stroking velocities as compared to the regressive transitional portion of valve 2260. For example, the regressive characteristics of sliding piston 2222 can transition at a lower range of stroking velocities than valve 2260, at about the same stroking velocities as valve 2260, or at higher stroking velocities than valve 2260. Further, the present invention contemplates those embodiments in which the structure of the regressive internal flowpath of piston 2222 is different than the structure of valve 2260, and further those embodiments in which the structures are generally the same. For example, one of the regressive valves within piston 2222 or valve assembly 2260 can be unidirectional, and the other can be bidirectional.

In yet another embodiment, piston 2222 is preferably a solid piston without any interior flowpath, such that movement of piston 2222 within cylinder 2226 results in a displacement of hydraulic fluid in a single direction, such as the direction of movement.

In yet another embodiment, piston 2222 includes one or more interior flowpaths, such that as piston 2222 moves within cylinder 2225, the higher pressure hydraulic fluid in contact with a face of the piston can move either through the piston internal flowpath, or back through the regressive and inertia flowpaths. The flow valve within piston 2222 can be of any type, including one or more shims that bend and allow flow as result of the bending, check valves, or any other type of valving, especially those providing viscous force characteristics. It is further understood that the internal flowpath within the sliding piston can be unidirectional or bidirectional.

As piston 2222 moves within cylinder 2225 hydraulic fluid displaced from cylinder 2225 is provided through a plurality of orifices 2225.2 into a tortuous flowpath 2229, through which it flows to another set of orifices 2225.1 at the other end of damper 2220.

Damper 2220 includes a tortuous path 2229 that is provided in external fluid connections 2256 and 2257 to an external housing 2250. Fluid is received at port 2251.1 and 2251.2 of housing 2250 and therein provided to a flow valve 2260 having regressive flow characteristics. As shown in FIG. 27, flow valve 2260 is substantially the same as the apparatus shown in FIG. 20B, except modified to operate within a housing instead of being attached to a rod. It is understood that any of the regressive valve designs shown herein can housed within housing 2250.

In yet other embodiments, the tortuous flowpath 2229 of damper 2220 is a fluid path 2229 formed in cylindrical body 2226. Preferably, body 2226 includes a helical pathway that wraps around the outer diameter of cylinder 2226, and extends generally from one end of damper 2220 to the other end of damper 2220. However, it is appreciated that a helical flowpath is provided as an example, and various embodiments of the present invention include other tortuous flowpaths, especially those flowpaths adapted and configured to provide a fluid path in which viscous flow losses are of lesser importance than inertial effects as the fluid is transferred.

Various aspects of different embodiments of the present invention are expressed in paragraphs X1, X2, and X3 as follows:

X1. One aspect of the present invention pertains to a method for hydraulically damping a suspension of a vehicle. The method preferably includes providing a shock absorber including a piston attached to a rod and slidable within a chamber and sealingly dividing the chamber into first and second internal compartments, the rod being attached to one of the vehicle or the suspension. The method preferably includes providing an inertial flowpath for hydraulic fluid adapted and configured to have substantial pressure drop required to overcome the inertia of accelerating a flow of hydraulic fluid through the flowpath. The method preferably includes providing a valve capable of switching from a first more restrictive flowpath for hydraulic fluid to a second less restrictive flowpath for hydraulic fluid. The method preferably includes pumping one flowrate of hydraulic fluid by the piston from one of the internal compartments through the inertial flowpath, and pumping another flowrate of hydraulic fluid by the piston from the one internal compartment through the first restrictive flowpath of the valve if the fluid pressure at the valve inlet is less than a predetermined value or through the second restrictive flowpath if the fluid pressure is greater than the predetermined value. The one flowrate and the other flowrate can be the same or different.

X2. Another aspect of the present invention pertains to a method for hydraulically damping a vehicle suspension. The method preferably includes providing a shock absorber operable in compression and rebound including a piston attached to a rod and slidable within a cylinder, the cylinder being located within an enclosed housing. The method preferably includes providing a first hydraulic flowpath between the housing and the cylinder, the first hydraulic flowpath being adapted and configured to provide substantially more inertial resistance to a flowrate of hydraulic fluid than the viscous resistance to the same flowrate of hydraulic fluid. The method preferably includes providing a second hydraulic flowpath with the piston that provides fluid communication across the piston. The method preferably includes flowing first hydraulic fluid through the first flowpath and not through the second flowpath when the piston stroking velocity is less than a predetermined value. The method preferably includes applying a first corresponding reactive load by the shock absorber on the suspension during said first flowing. The method preferably includes flowing second hydraulic fluid through the first flowpath and through the second flowpath in parallel when the piston stroking velocity is greater than the predetermined value; and applying a second corresponding reactive load by the shock absorber on the suspension during said second flowing, the second load being less than the first load.

X3. Yet another aspect of the present invention pertains to a method for hydraulically damping a vehicle suspension. The method preferably includes providing a shock absorber operable in compression and rebound including a piston attached to a rod and slidable within a cylinder from one end of the cylinder to the other end of the cylinder, a housing having a pair of fluid ports and an internal flowpath therebetween, one end of the cylinder being in fluid communication with one port; a valve providing fluid communication from the other end of the cylinder to the other port of the housing with either of a first more restrictive valve flowpath or a second less restrictive valve flowpath. The method preferably includes flowing first hydraulic fluid through the first valve flowpath and the internal flowpath when the piston stroking velocity is less than a predetermined velocity value, or alternatively when the fluid pressure presented to the inlet of the valve exceeds a predetermined pressure value. The method preferably includes applying a first corresponding reactive load by the shock absorber on the suspension during said first flowing. The method preferably includes flowing second hydraulic fluid through the second valve flowpath and the internal flowpath when the piston stroking velocity is greater than the predetermined value, and applying a second corresponding reactive load by the shock absorber on the suspension during said second flowing, the second load being less than the first load.

Yet other embodiments pertain to any of the previous statements X1, X2, or X3, which are combined with one or more of the following other aspects. It is also understood that any of the aforementioned X paragraphs include listings of individual features that can be combined with individual features of other X paragraphs.

Wherein the valve includes a valve member movable between a first position that establishes the first flowpath and a second position that establishes the second flowpath, and a spring that biases the valve member to the first position.

Wherein the first restrictive flowpath and the second restrictive flowpath share a flow orifice.

Wherein the shock absorber includes a gas reservoir and the valve is located in the gas reservoir.

Wherein one of the valve ports is in fluid communication with the inertial flowpath and the other of the valve ports is in fluid communication with an internal compartment.

Wherein the valve includes an adjuster for changing the predetermined value of fluid pressure.

Wherein the valve includes an adjuster for changing the flow characteristics of one of the first flowpath or the second flowpath.

Wherein the inertial flowpath is in series with the first restrictive flowpath and in series with the second restrictive flowpath.

Wherein the valve is located in one of the first or second internal compartments.

Wherein the inertial flowpath is in parallel with the first restrictive flowpath and in parallel with the second restrictive flowpath.

Wherein the piston includes the valve.

Wherein the first flowpath includes a plurality of bends that change the direction of the hydraulic fluid.

Wherein at least a portion of the first flowpath includes a helically-shaped passageway.

Wherein the helically shaped passageway wraps around the cylinder.

Wherein the first flowpath curves circumferentially around the cylinder a plurality of revolutions, the first flowpath being adapted and configured to substantially increase the angular momentum of hydraulic fluid flowing therethrough.

Wherein the piston is slidable along a travel distance from one end of the cylinder to the other end of the cylinder, and the first flowpath extends substantially the length of the travel distance.

Wherein the first flowpath is adapted and configured such that during said first flowing and said second flowing the viscous pressure drop in the first flowpath is less than the corresponding pressure difference needed in the first flowpath to overcome the inertia of the hydraulic fluid.

Wherein during said first flowing a first flow rate of hydraulic fluid flows through the first flowpath, during said second flowing a second flow rate of hydraulic fluid flows through the first flowpath and the second flowpath, and the second quantity is greater than the first quantity.

Wherein said first flowing is by stroking the piston in a direction, and said second flowing is by stroking the piston in the same direction.

Wherein the direction is in compression of the shock absorber.

Wherein the direction is in rebound of the shock absorber.

Wherein the rod is a first rod and said providing includes a second rod attached to the piston and extending out of the cylinder.

Wherein the valve is annular in shape and receives the rod through a central aperture.

Wherein the valve is located within the cylinder.

Wherein the valve is located outside of the cylinder.

Wherein the valve is located within the housing.

Wherein during said first flowing there is a first valve flowpath viscous pressure drop, during said second flowing there is a second valve flowpath viscous pressure drop, and the first drop is greater than the second drop.

Wherein during said first flowing there is a first inertial pressure drop across the internal flowpath, during said second flowing there is a second inertial pressure drop across the internal flowpath, and the first drop is less than the second drop.

Wherein during said first flowing there is first flow rate of hydraulic fluid through the first valve flowpath and the internal flowpath, during said second flowing there is a second flow rate of hydraulic fluid through the second valve flowpath and the internal flowpath, and the second flow rate is greater than the first flow rate.

Wherein the internal flowpath is adapted and configured such that during said first flowing and said second flowing the viscous pressure drop across the internal flowpath is less than the corresponding pressure difference needed across the internal flowpath to overcome the inertia of the hydraulic fluid flowing in the internal flowpath.

Wherein the piston substantially blocks the flow of hydraulic fluid from one end of the cylinder to the other end of the cylinder.

Wherein the piston includes at least one check valve permitting fluid flow across the piston.

Wherein the valve includes an orifice and both the first flowpath and the second flowpath permit flow through the orifice.

Wherein said first flowing is by stroking the piston in a direction, and said second flowing is by stroking the piston in the same direction.

While the inventions have been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for hydraulically damping a suspension of a vehicle, comprising:
providing a shock absorber including a piston attached to a rod and slidable within a chamber and sealingly dividing the chamber into first and second internal compartments, the rod being attached to one of the vehicle or the suspension;
providing an inertial flowpath for hydraulic fluid adapted and configured to have substantially more pressure drop required to overcome the inertia of accelerating a flow of hydraulic fluid through the flowpath than the pressure drop required to overcome the viscous drag of flowing the same flow of hydraulic fluid through the flowpath;
providing a valve with a first fluid port and a second fluid port and capable of switching from a first more viscously restrictive flowpath for hydraulic fluid between the first port and second port and to a second less viscously restrictive flowpath for hydraulic fluid between the first port and second port;
pumping hydraulic fluid by the piston from one of the internal compartments through the inertial flowpath;
pumping hydraulic fluid by the piston from the one internal compartment through the first restrictive flowpath of the valve if the fluid pressure at the valve first fluid port is less than a predetermined value or through the second restrictive flowpath if the fluid pressure at the valve first fluid port is greater than the predetermined value; and
returning the pumped hydraulic fluid to the other internal compartment.

2. The method of claim 1 wherein the valve includes a valve member movable between a first position that establishes the first flowpath and a second position that establishes the second flowpath, and a spring that biases the valve member to the first position.

3. The method of claim 1 wherein the first restrictive flowpath and the second restrictive flowpath share a flow orifice.

4. The method of claim 1 wherein the shock absorber includes a gas reservoir and the valve is located in the gas reservoir.

5. The method of claim 4 wherein one of the valve ports is in fluid communication with the inertial flowpath and the other of the valve ports is in fluid communication with an internal compartment.

6. The method of claim 4 wherein the valve includes an adjuster for changing the predetermined value of fluid pressure.

7. The method of claim 4 wherein the valve includes an adjuster for changing the flow characteristics of one of the first flowpath or the second flowpath.

8. The method of claim 1 wherein the inertial flowpath is in series with the first restrictive flowpath and in series with the second restrictive flowpath.

9. The method of claim 8 wherein the valve is located in one of the first or second internal compartments.

10. The method of claim 1 wherein the inertial flowpath is in parallel with the first restrictive flowpath and in parallel with the second restrictive flowpath.

11. The method of claim 10 wherein the piston includes the valve.

12. A method for hydraulically damping a vehicle suspension, comprising:
providing a shock absorber operable in compression and rebound and including a piston attached to a rod and slidable within a cylinder, the cylinder being located within an enclosed housing, the rod being attached to one of the vehicle or the suspension and the housing being attached to the other of the vehicle or the suspension;
providing a first hydraulic flowpath between the housing and the cylinder, one end of the first flowpath being in fluid communication with the one end of the cylinder and the other end of the first flowpath being in fluid communication with the other end of the cylinder, the first hydraulic flowpath being adapted and configured to provide substantially more inertial resistance to a flow of hydraulic fluid than the viscous resistance to the same flow of hydraulic fluid;
providing a second hydraulic flowpath with the piston that provides fluid communication across the piston from the one end of the cylinder to the other end of the cylinder;
flowing first hydraulic fluid through the first flowpath and not through the second flowpath when the piston stroking velocity is less than a predetermined value;
applying a first corresponding reactive load by the shock absorber on the suspension during said first flowing;
flowing second hydraulic fluid through the first flowpath and through the second flowpath in parallel when the piston stroking velocity is greater than the predetermined value; and
applying a second corresponding reactive load by the shock absorber on the suspension during said second flowing, the second load being less than the first load.

13. The method of claim 12 wherein the first flowpath includes a plurality of bends that change the direction of the hydraulic fluid.

14. The method of claim 13 wherein at least a portion of the first flowpath includes a helically-shaped passageway.

15. The method of claim 14 wherein the helically shaped passageway wraps around the cylinder.

16. The method of claim 12 wherein the first flowpath curves circumferentially around the cylinder a plurality of revolutions, the first flowpath being adapted and configured to substantially increase the angular momentum of hydraulic fluid flowing therethrough.

17. The method of claim 12 wherein the piston is slidable along a travel distance from one end of the cylinder to the other end of the cylinder, and the first flowpath extends substantially the length of the travel distance.

18. The method of claim 12 wherein the first flowpath is adapted and configured such that during said first flowing and said second flowing the viscous pressure drop in the first flowpath is less than the corresponding pressure difference needed in the first flowpath to overcome the inertia of the hydraulic fluid.

19. The method of claim 12 wherein said first flowing is by stroking the piston in a direction, and said second flowing is by stroking the piston in the same direction.

20. The method of claim 19 wherein the direction is in compression of the shock absorber.

21. The method of claim 19 wherein the direction is in rebound of the shock absorber.

22. The method of claim 12 wherein the rod is a first rod and said providing includes a second rod attached to the piston and extending out of the cylinder.

23. A method for hydraulically damping a vehicle suspension, comprising:
providing a shock absorber operable in compression and rebound including a piston attached to a rod and slidable within a cylinder from one end of the cylinder to the other end of the cylinder, a housing having a pair of fluid ports and an internal flowpath therebetween, one end of the cylinder being in fluid communication with one port, a valve providing fluid communication from the other end of the cylinder to the other port of the housing with either of a first more restrictive valve flowpath or a second less restrictive valve flowpath, the rod being attached to one of the vehicle or the suspension;
flowing first hydraulic fluid through the first valve flowpath and the internal flowpath when the piston stroking velocity is less than a predetermined value;
applying a first corresponding reactive load by the shock absorber on the suspension during said first flowing;
flowing second hydraulic fluid through the second valve flowpath and the internal flowpath when the piston stroking velocity is greater than the predetermined value; and
applying a second corresponding reactive load by the shock absorber on the suspension during said second flowing, the second load being less than the first load.

24. The method of claim 23 wherein the valve is annular in shape and receives the rod through a central aperture.

25. The method of claim 24 wherein the valve is located within the cylinder.

26. The method of claim 24 wherein the valve is located outside of the cylinder.

27. The method of claim 24 wherein the valve is located within the housing.

28. The method of claim 23 wherein during said first flowing there is a first valve flowpath viscous pressure drop, during said second flowing there is a second valve flowpath viscous pressure drop, and the first drop is greater than the second drop.

29. The method of claim 28 wherein during said first flowing there is a first inertial pressure drop across the internal flowpath, during said second flowing there is a second inertial pressure drop across the internal flowpath, and the first drop is less than the second drop.

30. The method of claim 23 wherein the internal flowpath is adapted and configured such that during said first flowing and said second flowing the viscous pressure drop across the internal flowpath is less than the corresponding pressure difference needed across the internal flowpath to overcome the inertia of the hydraulic fluid flowing in the internal flowpath.

31. The method of claim 23 wherein the piston substantially blocks the flow of hydraulic fluid from one end of the cylinder to the other end of the cylinder.

32. The method of claim 23 wherein the piston includes at least one check valve permitting fluid flow across the piston.

33. The method of claim 23 wherein the valve includes an orifice and both the first flowpath and the second flowpath permit flow through the orifice.

34. The method of claim 23 wherein said first flowing is by stroking the piston in a direction, and said second flowing is by stroking the piston in the same direction.
